(19) United States
(12) Patent Application Publication
(10) Pub. No.: US 2025/0234893 A1
(43) Pub. Date: Jul. 24, 2025

(54) Device For Making Drinks

(71) Applicant: SharkNinja Operating LLC, Needham, MA (US)

(72) Inventors: Michael Lerman, Providence, RI (US); Macrae Benziger, Dedham, MA (US); Alexander Mularski, Auburn, MA (US); Ryan Michienzi, Cumberland, RI (US); Vipul Mone, Boston, MA (US); Matthew Roberts, Medfield, MA (US); Derek Lessard, Dorchester, MA (US)

(21) Appl. No.: 19/175,924

(22) Filed: Apr. 10, 2025

Related U.S. Application Data
(63) Continuation-in-part of application No. 18/415,817, filed on Jan. 18, 2024.
(63) Continuation-in-part of application No. 18/423,894, filed on Jan. 26, 2024.
Application No. 18/423,894 is a continuation-in-part of application No. 18/415,817, filed on Jan. 18, 2024.
(63) Continuation-in-part of application No. 18/423,899, filed on Jan. 26, 2024, now Pat. No. 12,279,629.
Application No. 18/423,899 is a continuation-in-part of application No. 18/415,817, filed on Jan. 18, 2024.
(63) Continuation-in-part of application No. 18/424,517, filed on Jan. 26, 2024.
Application No. 18/424,517 is a continuation-in-part of application No. 18/415,817, filed on Jan. 18, 2024.
(63) Continuation-in-part of application No. 18/424,530, filed on Jan. 26, 2024.
Application No. 18/424,530 is a continuation-in-part of application No. 18/415,817, filed on Jan. 18, 2024.
(63) Continuation-in-part of application No. 18/817,424, filed on Aug. 28, 2024.
Application No. 18/817,424 is a continuation-in-part of application No. 18/423,894, filed on Jan. 26, 2024.
(63) Continuation-in-part of application No. 18/424,536, filed on Jan. 26, 2024.
Application No. 18/424,536 is a continuation-in-part of application No. 18/415,817, filed on Jan. 18, 2024.
(63) Continuation-in-part of application No. 18/423,906, filed on Jan. 26, 2024.
Application No. 18/423,906 is a continuation-in-part of application No. 18/415,817, filed on Jan. 18, 2024.
(63) Continuation-in-part of application No. 18/423,721, filed on Jan. 26, 2024.
Application No. 18/423,721 is a continuation-in-part of application No. 18/415,817, filed on Jan. 18, 2024.
(63) Continuation-in-part of application No. 18/423,728, filed on Jan. 26, 2024.
Application No. 18/423,728 is a continuation-in-part of application No. 18/415,817, filed on Jan. 18, 2024.
(63) Continuation-in-part of application No. 18/658,434, filed on May 8, 2024.
(63) Continuation-in-part of application No. 19/071,024, filed on Mar. 5, 2025.
Application No. 19/071,024 is a continuation-in-part of application No. 18/816,401, filed on Aug. 27, 2024.
Application No. 18/816,401 is a continuation of application No. 18/423,894, filed on Jan. 26, 2024.
(60) Provisional application No. 63/669,144, filed on Jul. 9, 2024.

(51) Int. Cl. A23G 9/22; A23G 9/04

(52) U.S. Cl. CPC A23G 9/22; A23G 9/045

(57) ABSTRACT

A device for making drinks is provided that includes a housing, a mixing vessel, a drive motor, a dasher, a cooling circuit, and a coupling mechanism. The mixing vessel is configured to receive a drink product. The drive motor is positioned in the housing. The dasher is configured to mix the drink product in the mixing vessel and is driven by the drive motor. The mixing vessel has an opening through which the dasher is received in the mixing vessel when the mixing vessel is engaged with the housing. The cooling circuit is at least partly positioned in the housing and is configured to cool the drink product while the drink product is mixed in the mixing vessel. The coupling mechanism is configured to releasably retain the mixing vessel against the housing in the engaged position. The mixing vessel is configured to engage the housing to seal the opening.

### CROSS REFERENCE TO RELATED APPLICATIONS

This application is a continuation-in-part of U.S. patent application Ser. No. 18/415,817, filed on Jan. 18, 2024, and is a continuation-in-part of U.S. patent application Ser. No. 18/423,894, filed on Jan. 26, 2024, which is a continuation-in-part of U.S. patent application Ser. No. 18/415,817, filed on Jan. 18, 2024. This application is a continuation-in-part of U.S. patent application Ser. No. 18/423,899, filed on Jan. 26, 2024, which is a continuation-in-part of U.S. patent application Ser. No. 18/415,817, filed on Jan. 18, 2024. This application is a continuation-in-part of U.S. patent application Ser. No. 18/424,517, filed Jan. 26, 2024, which is a continuation-in-part of U.S. patent application Ser. No. 18/415,817, filed on Jan. 18, 2024. This application is a continuation-in-part of U.S. patent application Ser. No. 18/424,530, filed Jan. 26, 2024, which is a continuation-in-part of U.S. patent application Ser. No. 18/415,817 filed on Jan. 18, 2024. This application is a continuation-in-part of U.S. patent application Ser. No. 18/817,424, filed Aug. 28, 2024, which claims the benefit of U.S. Provisional Patent Application No. 63/669,144, filed Jul. 9, 2024, and which is a continuation-in-part of U.S. patent application Ser. No. 18/423,894, filed Jan. 26, 2024, which is a continuation-in-part of U.S. patent application Ser. No. 18/415,817, filed Jan. 18, 2024. This application is a continuation-in-part of U.S. patent application Ser. No. 18/424,536, filed Jan. 26, 2024, which is a continuation-in-part of U.S. patent application Ser. No. 18/415,817, filed Jan. 18, 2024. This application is a continuation-in-part of U.S. patent application Ser. No. 18/423,906, filed Jan. 26, 2024, which is a continuation-in-part of U.S. patent application Ser. No. 18/415,817, filed Jan. 18, 2024. This application is a continuation-in-part of U.S. patent application Ser. No. 18/423,721, filed Jan. 26, 2024, which is a continuation-in-part of U.S. patent application Ser. No. 18/415,817, filed Jan. 18, 2024. This application is a continuation-in-part of U.S. patent application Ser. No. 18/423,728, filed Jan. 26, 2024, which is a continuation-in-part of U.S. patent application Ser. No. 18/415,817, filed Jan. 18, 2024. This application is a continuation-in-part of U.S. patent application Ser. No. 18/658,434, filed May 8, 2024. This application is a continuation-in-part of U.S. patent application Ser. No. 19/071,024, filed Mar. 5, 2025, which is a continuation-in-part of U.S. patent application Ser. No. 18/816,401, filed Aug. 27, 2024, which is a continuation of U.S. patent application Ser. No. 18/423,894, filed Jan. 26, 2024, which is a continuation-in-part of U.S. patent application Ser. No. 18/415,817, filed Jan. 18, 2024. The disclosures of each of the foregoing are hereby incorporated by reference in their entireties.

### BACKGROUND

### 1. Technical Field

The disclosure relates generally to drink makers and, in non-limiting embodiments or aspects, to various components, configurations, and methods of operation of drink makers.

### 2. Technical Considerations

Frozen drink makers, which also may be referred to as semi-frozen beverage makers or crushed-ice drink makers, may include a tank or mixing vessel in which a drink product is received and processed, including being cooled, often transforming the drink product from a pure liquid (or a combination of a liquid and portions of ice) to a frozen or semi-frozen product, such as, for example, a granita, slush drink, smoothie, ice cream, or other frozen or semi-frozen product, which is then dispensed. The cooled product may be dispensed through a tap, spigot, or dispenser. Thus, the terms “frozen drink maker”, “device for making drinks”, or “drink maker”, as used herein, are not limited to a device that only makes drinks or frozen drinks, but include devices that cool received drink products to produce cooled outputs in any of a variety of cooled, frozen, and semi-frozen forms. A drink product may consist of a liquid mixture, including water, juice, or milk, and may include additives, such as sugar, spirit, syrup, or flavoring powders, that gives the drink product the desired taste and/or color. Frozen drink makers may include a mixing system within the mixing vessel, and further may include a refrigeration system to cool the drink product in the mixing vessel.

### SUMMARY

Accordingly, provided is a device for making drinks, including by cooling and mixing a drink product.

According to non-limiting embodiments or aspects, provided is a device for making drinks. The device includes a housing. The device also includes a mixing vessel configured to receive a drink product. The device further includes a drive motor positioned in the housing. The device further includes a dasher configured to mix the drink product in the mixing vessel. The dasher is driven by the drive motor. The mixing vessel has an opening through which the dasher is received in the mixing vessel when the mixing vessel is engaged with the housing in an engaged position. The device further includes a cooling circuit at least partly positioned in the housing. The cooling circuit is configured to cool the drink product while the drink product is mixed in the mixing vessel. The coupling mechanism is configured to releasably retain the mixing vessel against the housing in the engaged position. The mixing vessel is configured to engage the housing to seal the opening when in the engaged position.

In some non-limiting embodiments or aspects, the coupling mechanism may include at least one cam. In some non-limiting embodiments or aspects, the device may further include at least one lever moveable between a first position and a second position. The at least one lever may be connected to the at least one cam. In some non-limiting embodiments or aspects, the mixing vessel may include at least one first protrusion configured to engage with the at least one cam. When the at least one lever is moved from the first position to the second position, the at least one cam may cause the mixing vessel to be engaged with the housing by pulling the at least one first protrusion toward the housing.

In some non-limiting embodiments or aspects, the cooling circuit may include an evaporator. The evaporator may be configured to extend through the opening of the housing when the mixing vessel is engaged with the housing in the engaged position. In some non-limiting embodiments or aspects, the device may further include a temperature sensor positioned in or on the evaporator.

In some non-limiting embodiments or aspects, the mixing vessel may further include at least one first protrusion configured to engage with the coupling mechanism. In some non-limiting embodiments or aspects, the mixing vessel may further include at least one second protrusion configured to contact an upper edge of the housing and guide the mixing vessel into alignment with the coupling mechanism. In some non-limiting embodiments or aspects, the mixing vessel may further include at least one third protrusion configured to be received within a slot below the upper edge of the housing.

In some non-limiting embodiments or aspects, the device may further include a tray positioned below at least a portion of the mixing vessel. The tray may be configured to receive liquid runoff from an outer surface of the mixing vessel.

In some non-limiting embodiments or aspects, the device may further include a channel defined between an outer surface of the mixing vessel and an upper edge of the housing. The channel may be configured to allow the liquid runoff to pass through the channel and into the tray.

In some non-limiting embodiments or aspects, the device may include a flexible seal. At least a portion of the flexible seal may be positioned between the mixing vessel and the housing when the mixing vessel is engaged with the housing in an engaged position. In some non-limiting embodiments or aspects, the flexible seal may include a face seal portion configured to interface between a surface of the mixing vessel and a surface of the housing. The flexible seal may further include a radial seal portion configured to extend into and contact a perimeter of the opening.

In some non-limiting embodiments or aspects, the coupling mechanism may be configured to engage with the mixing vessel proximate to a rear end of the mixing vessel. The opening of the mixing vessel may be at the rear end of the mixing vessel.

In some non-limiting embodiments or aspects, the mixing vessel may include at least one internal baffle configured to direct slush flow in the mixing vessel toward the dasher. The at least one internal baffle may include at least one of: a side baffle extending parallel to a primary axis of the dasher, a front baffle extending perpendicular to the primary axis of the dasher, a corner baffle angled with respect to the primary axis of the dasher, or any combination thereof. In some non-limiting embodiments or aspects, the at least one internal baffle may include at least the front baffle. The front baffle may correspond to an indentation on an exterior of the mixing vessel. In some non-limiting embodiments or aspects, the device may further include a vertical protrusion extending from a front surface of the mixing vessel above a front edge of the indentation.

In some non-limiting embodiments or aspects, the device may further include a pour-in opening in a top surface of the mixing vessel. The pour-in opening may include an aperture configured to allow liquid flow into an interior chamber of the mixing vessel. The pour-in opening may further include a surface that inclines with respect to a primary axis of the dasher. In some non-limiting embodiments or aspects, the aperture may be configured as a slot having a width dimensioned to prevent passage of a human finger. In some non-limiting embodiments or aspects, the aperture of the pour-in opening may be positioned proximate to a rear of the mixing vessel.

Further non-limiting embodiments or aspects are set forth in the following numbered clauses:

Clause 1: A device for making drinks, comprising: a housing; a mixing vessel configured to receive a drink product; a drive motor positioned in the housing; a dasher configured to mix the drink product in the mixing vessel, the dasher driven by the drive motor, wherein the mixing vessel has an opening through which the dasher is received in the mixing vessel when the mixing vessel is engaged with the housing in an engaged position; a cooling circuit at least partly positioned in the housing, the cooling circuit configured to cool the drink product while the drink product is mixed in the mixing vessel; and a coupling mechanism configured to releasably retain the mixing vessel against the housing in the engaged position, wherein the mixing vessel is configured to engage the housing to seal the opening when in the engaged position.

Clause 2: The device of clause 1, wherein the coupling mechanism comprises at least one cam.

Clause 3: The device of clause 1 or 2, further comprising at least one lever moveable between a first position and a second position, the at least one lever connected to the at least one cam.

Clause 4: The device of any of clauses 1-3, wherein the mixing vessel comprises at least one first protrusion configured to engage with the at least one cam, and wherein when the at least one lever is moved from the first position to the second position, the at least one cam causes the mixing vessel to be engaged with the housing by pulling the at least one first protrusion toward the housing.

Clause 5: The device of any of clauses 1-4, wherein the cooling circuit comprises an evaporator, the evaporator configured to extend through the opening of the housing when the mixing vessel is engaged with the housing in the engaged position.

Clause 6: The device of any of clauses 1-5, further comprising a temperature sensor positioned in or on the evaporator.

Clause 7: The device of any of clauses 1-6, wherein the mixing vessel further comprises at least one first protrusion configured to engage with the coupling mechanism.

Clause 8: The device of any of clauses 1-7, wherein the mixing vessel further comprises at least one second protrusion configured to contact an upper edge of the housing and guide the mixing vessel into alignment with the coupling mechanism.

Clause 9: The device of any of clauses 1-8, wherein the mixing vessel further comprises at least one third protrusion configured to be received within a slot below the upper edge of the housing.

Clause 10: The device of any of clauses 1-9, further comprising a tray positioned below at least a portion of the mixing vessel and configured to receive liquid runoff from an outer surface of the mixing vessel.

Clause 11: The device of any of clauses 1-10, further comprising a channel defined between an outer surface of the mixing vessel and an upper edge of the housing, wherein the channel is configured to allow the liquid runoff to pass through the channel and into the tray.

Clause 12: The device of any of clauses 1-11, further comprising a flexible seal, wherein at least a portion of the flexible seal is positioned between the mixing vessel and the housing when the mixing vessel is engaged with the housing in an engaged position.

Clause 13: The device of any of clauses 1-12, wherein the flexible seal comprises a face seal portion configured to interface between a surface of the mixing vessel and a surface of the housing, and wherein the flexible seal further comprises a radial seal portion configured to extend into and contact a perimeter of the opening.

Clause 14: The device of any of clauses 1-13, wherein the coupling mechanism is configured to engage with the mixing vessel proximate to a rear end of the mixing vessel, and wherein the opening of the mixing vessel is at the rear end of the mixing vessel.

Clause 15: The device of any of clauses 1-14, wherein the mixing vessel comprises at least one internal baffle configured to direct slush flow in the mixing vessel toward the dasher, and wherein the at least one internal baffle comprises at least one of: a side baffle extending parallel to a primary axis of the dasher, a front baffle extending perpendicular to the primary axis of the dasher, a corner baffle angled with respect to the primary axis of the dasher, or any combination thereof.

Clause 16: The device of clause 1-15, wherein the at least one internal baffle comprises at least the front baffle, wherein the front baffle corresponds to an indentation on an exterior of the mixing vessel.

Clause 17: The device of clauses 1-16, further comprising a vertical protrusion extending from a front surface of the mixing vessel above a front edge of the indentation.

Clause 18: The device of any of clauses 1-17, further comprising a pour-in opening in a top surface of the mixing vessel, the pour-in opening comprising an aperture configured to allow liquid flow into an interior chamber of the mixing vessel, and the pour-in opening further comprising a surface that inclines with respect to a primary axis of the dasher.

Clause 19: The device of any of clauses 1-18, wherein the aperture is configured as a slot having a width dimensioned to prevent passage of a human finger.

Clause 20: The device of clauses 1-19, wherein the aperture of the pour-in opening is positioned proximate to a rear of the mixing vessel.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a perspective view of a drink maker, according to some non-limiting embodiments or aspects;

FIG. 2 is a view of various internal components within the housing and mixing vessel of the drink maker of FIG. 1, according to some non-limiting embodiments or aspects;

FIG. 3 is a front view of the drink maker of FIG. 1, according to some non-limiting embodiments or aspects;

FIG. 4 is a schematic diagram of a control system of the drink maker of FIG. 1, according to some non-limiting embodiments or aspects;

FIG. 5A is a side view of the drink maker of FIG. 1 with the mixing vessel in a coupled position relative to the upper housing section, according to some non-limiting embodiments or aspects;

FIG. 5B is a side view of the drink maker illustrated in FIG. 5A with some features of the housing and the lever shown in partial cross-section, according to some non-limiting embodiments or aspects;

FIG. 6 is a detailed view of a lever with cams for coupling a mixing vessel to the housing of a drink maker, according to some non-limiting embodiments or aspects;

FIG. 7A is a rear view of a mixing vessel, according to some non-limiting embodiments or aspects;

FIG. 7B is a perspective view of the rear of a mixing vessel, according to some non-limiting embodiments or aspects;

FIG. 8 is a perspective view of a flexible seal, according to some non-limiting embodiments or aspects;

FIG. 9 is a cross-sectional view of a flexible seal, according to some non-limiting embodiments or aspects;

FIG. 10 is a flow diagram for a method of using the disclosed drink maker, according to some non-limiting embodiments or aspects;

FIG. 11A is a perspective view of a collection tray of the drink maker of FIG. 1, according to some non-limiting embodiments or aspects;

FIG. 11B is a perspective view of a collection tray of the drink maker of FIG. 1, according to some non-limiting embodiments or aspects;

FIG. 11C is a view of the collection tray of FIGS. 11A and 11B inserted into the drink maker of FIG. 1, according to some non-limiting embodiments or aspects;

FIG. 11D is a view of the drink maker of FIG. 1 with the collection tray removed, according to some non-limiting embodiments or aspects;

FIG. 12 is a flow diagram illustrating a method of removing the collection tray of FIGS. 11A and 11B from the drink maker of FIG. 1, according to some non-limiting embodiments or aspects;

FIG. 13A is an isometric view of the drink maker with a mixing vessel having at least one internal baffle, according to some non-limiting embodiments or aspects;

FIG. 13B is a cross-sectional view of the drink maker shown in FIG. 13A, taken along line B-B, according to some non-limiting embodiments or aspects;

FIG. 13C is a cross-sectional view of the drink maker shown in FIG. 13A, taken along line C-C, according to some non-limiting embodiments or aspects;

FIG. 14A is a rear isometric view of a mixing vessel for a drink maker with three internal baffles, according to some non-limiting embodiments or aspects;

FIG. 14B is a rear view of the mixing vessel shown in FIG. 14A, according to some non-limiting embodiments or aspects;

FIG. 14C is a front isometric view of the mixing vessel shown in FIG. 14A, according to some non-limiting embodiments or aspects;

FIG. 15 is a close-up view of a user interface, according to some non-limiting embodiments or aspects;

FIG. 16 is a graph of coarse and fine temperature settings, according to some non-limiting embodiments or aspects;

FIG. 17 is a close-up view of another user interface, according to some non-limiting embodiments or aspects;

FIG. 18 is a graph of temperature values associated with automatic recipe temperature target temperatures and manual temperature adjustments, according to some non-limiting embodiments or aspects;

FIG. 19 is a graph of drive motor current and temperature vs. time as a drink product being processing by the drink maker of FIG. 1, according to some non-limiting embodiments or aspects;

FIG. 20 is a flow diagram of a process for making a cooled drink product using a food type for initial or coarse temperature and/or texture control and then using a user input to subsequently fine tune the temperature and/or texture of the drink product, according to some non-limiting embodiments or aspects;

FIG. 21 is a flow diagram of a process for automatically detecting when drive motor current is too high and/or a drink product is too thick and, in response, adjusting the temperature of the drink product to reduce drive motor current and/or to increase the temperature of the drink product to reduce a thickness of the drink product, according to some non-limiting embodiments or aspects;

FIG. 22A is a view of a dual-use cooling fan within the housing of a drink maker, according to some non-limiting embodiments or aspects;

FIG. 22B is a view of a dual-use cooling fan within the housing of a drink maker, according to some non-limiting embodiments or aspects;

FIG. 22C is a perspective view of the dual-use cooling fan of FIG. 22B, according to some non-limiting embodiments or aspects;

FIG. 23 is a flow diagram of a process for operating the dual-use fan, according to some non-limiting embodiments or aspects;

FIG. 24A is a perspective view of a sample pour-in opening for a drink maker, according to some non-limiting embodiments or aspects;

FIG. 24B is a front view of the pour-in opening shown in FIG. 24A, according to some non-limiting embodiments or aspects;

FIG. 24C is a left perspective view of the pour-in opening shown in FIG. 24A, according to some non-limiting embodiments or aspects;

FIG. 25 is a perspective view of a cover for a pour-in opening, according to some non-limiting embodiments or aspects;

FIG. 26 is a perspective view of a pour-in opening, according to some non-limiting embodiments or aspects;

FIG. 27A is a perspective view of a pour-in opening, according to some non-limiting embodiments or aspects;

FIG. 27B is an isometric view of the pour-in opening of FIG. 27A, according to some non-limiting embodiments or aspects;

FIG. 27C is a side view of the pour-in opening of in FIG. 27B, according to some non-limiting embodiments or aspects;

FIG. 27D is a view of the pour-in opening shown in FIG. 27B affixed to a mixing vessel, according to some non-limiting embodiments or aspects;

FIG. 28 is a flow diagram of a method of using a pour-in opening, according to some non-limiting embodiments or aspects;

FIG. 29A is a view of a dispenser assembly for dispensing a drink product from the drink maker, according to some non-limiting embodiments or aspects;

FIG. 29B is a view of a dispenser assembly for dispensing a drink product from the drink maker, according to some non-limiting embodiments or aspects;

FIG. 29C is a view of a dispenser assembly for dispensing a drink product from the drink maker, according to some non-limiting embodiments or aspects;

FIG. 29D is a view of a dispenser assembly for dispensing a drink product from the drink maker, according to some non-limiting embodiments or aspects;

FIG. 30A is a view of a dispenser assembly for dispensing a drink product from the drink maker, according to some non-limiting embodiments or aspects;

FIG. 30B is a view of a dispenser assembly for dispensing a drink product from the drink maker, according to some non-limiting embodiments or aspects;

FIG. 31A is a view of a shroud for covering the dispenser assembly of FIGS. 29A-29D and FIGS. 30A-30B, according to some non-limiting embodiments or aspects;

FIG. 31B is a view of a shroud for covering the dispenser assembly of FIGS. 29A-29D and FIGS. 30A-30B, according to some non-limiting embodiments or aspects;

FIG. 32A is a flow diagram of a method for processing a drink product in a drink maker, according to some non-limiting embodiments or aspects;

FIG. 32B is a flow diagram of a method for processing a drink product in a drink maker, according to some non-limiting embodiments or aspects;

FIG. 33 is a graph of drink product temperature over time that illustrates how a controller may determine the phase change of the drink product when the rate of temperature change decreases from a first rate of change to a second rate of change, according to some non-limiting embodiments or aspects;

FIG. 34 is a graph of the linear relationship between the temperature at a phase change to a drink type temperature, according to some non-limiting embodiments or aspects;

FIG. 35 is a flow diagram of a method for processing a drink product in a drink maker, according to some non-limiting embodiments or aspects;

FIG. 36 is a flow diagram of a method for processing a drink product in a drink maker, according to some non-limiting embodiments or aspects;

FIG. 37 is a flow diagram of a method for processing a drink product in a drink maker, according to some non-limiting embodiments or aspects;

FIG. 38 is a flow diagram of a method for processing a drink product in a drink maker, according to some non-limiting embodiments or aspects;

FIG. 39 is a flow diagram of a method for processing a drink product in a drink maker, according to some non-limiting embodiments or aspects;

FIG. 40 is a flow diagram of a method for processing a drink product in a drink maker, according to some non-limiting embodiments or aspects;

FIG. 41 is a schematic diagram of example components of one or more devices of FIG. 1, according to some non-limiting embodiments or aspects;

FIG. 42 is an external, side view of a ventilation panel of a drink maker, according to some non-limiting embodiments or aspects;

FIG. 43 is an external, close-up, side view of a ventilation panel of a drink maker, according to some non-limiting embodiments or aspects;

FIG. 44 is an internal, side view of a ventilation panel of a drink maker, according to some non-limiting embodiments or aspects;

FIG. 45 is an internal, close-up, side view of a ventilation panel of a drink maker, according to some non-limiting embodiments or aspects;

FIGS. 46A-46L are views of a dispensing funnel for the dispenser assembly of FIGS. 30A and 30B, according to some non-limiting embodiments or aspects; and

FIG. 47 is a flow diagram of a process for operating a drink maker with regard to an undesirable condition, according to some implementations of the disclosure.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, a controller, and/or the like).

To illustrate implementations clearly and concisely, the drawings may not necessarily reflect appropriate scale and may have certain structures shown in somewhat schematic form. The disclosure may describe and/or illustrate structures in one implementation, and in the same way or in a similar way in one or more other implementations, and/or combined with or instead of the structures of the other implementations.

In the specification and claims, for the purposes of describing and defining the present disclosure, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “comprise,” “include,” and/or plural forms of each, include the listed parts and can include additional parts not listed, while terms such as “and/or” include one or more of the listed parts and combinations of the listed parts.

The present disclosure, in various implementations, addresses deficiencies associated with requiring a connecting hose from the evaporator down to a drip tray to collect and discard condensation from the evaporator. Unfortunately, such connecting hoses typically consist of a narrow tube that may become clogged or dirty and may be hard to clean. Accordingly, there is a need for a way for users to remove condensation and other spilled liquids from the vessel that reduces cleaning concerns and increases case of use.

The present disclosure, in various implementations, addresses deficiencies associated with prior commercial slush machines. Unfortunately, the architecture of prior commercial slush machines usually requires a significant amount of force to seat the vessel over a large radial seal, making it challenging for a user to install and uninstall the vessel from the device. In many prior commercial slush machines, the vessel is installed by engaging a catch to retain the vessel, which strains the plastic to properly position the vessel and requires significant user effort. Accordingly, there is a need for a more user-friendly architecture to install and uninstall the vessel of a frozen drink maker, such as, for example, a lock mechanism for the vessel that can be engaged and unengaged with minimal force and/or that only requires one hand to use.

The present disclosure, in various implementations, addresses deficiencies associated with automatically controlling drink product processing by sensing conditions, such as temperature and/or motor conditions (e.g., current, power, etc.), and controlling the operation of one or more components of the drink maker more efficiently in response to such sensed conditions. The present disclosure describes a number of systems, methods, and devices that enable a drink maker to automatically control a temperature of a drink product based on a target temperature value, which may be predetermined (e.g., stored in memory on the drink maker) or determined during processing the drink product, while further enabling the drink maker to automatically detect conditions of a drink product and/or the drink maker (e.g., the dasher drive motor) to mitigate possible adverse conditions (e.g., excessive ice buildup on the dasher), which could result in damage to the dasher, dasher drive motor, or other components of a drink maker. The present disclosure includes systems, methods, and devices that address a need for more adaptable and user-specific processing of drink products to ensure user-expected and more satisfying product outcomes, such as desired user-specific textures and temperatures of the drink product being processed.

The present disclosure, in various implementations, addresses deficiencies associated with controlling how liquids are added to a vessel for a frozen drink maker. Previously known frozen drink makers are sized for commercial applications. As such, commercial frozen drink makers can be very tall, with significant headspace in the vessel. When slush rises within the vessel, there is some space for it to rise before contacting the top of the vessel and/or the vessel's lid. However, even in commercial frozen drink makers, the slush can still expand too rapidly if liquid ingredients are forcefully added to the vessel, resulting in slush spilling out of the vessel. Accordingly, there is a need for a pour-in opening for a frozen drink maker to ensure fluids can be added to the vessel of the device in a more controlled manner to minimize or prevent slush overflow. This is especially important for residential frozen drink makers that have smaller vessel capacities and less available headspace than commercial units. Also, since dairy recipes can expand up to three times in volume, controlling slush expansion and preventing overflow is critical for these types of recipes. Additionally, the pour-in opening advantageously avoids external splatter and spillage of liquid ingredients as they are added to the vessel and prevents finger insertion to protect users from the dasher as it rotates within the mixing vessel.

The present disclosure, in various implementations, addresses deficiencies associated with plunger seals, including known issues of failing seals caused by rubbing of the elastomeric seal in typical dispenser designs. These issues include the need to replace the seals and to continually apply lubricant to the seals, both of which are unacceptable for in-home users. Accordingly, there is a need for a dispensing system that eliminates the rubbing of the elastomeric seal.

The present disclosure, in various implementations, addresses deficiencies associated with a length and shape of a dispenser shroud being insufficient to direct a dispensed liquid downwards toward a beverage cup. Accordingly, there is a need for a shroud that aids in dispensing the beverage downward while being removable for easy cleaning.

The present disclosure, in various implementations, addresses deficiencies associated with dispensing a drink product from a home-use machine. Unlike commercial machines, where the thickness and flow rate of a drink product being dispensed is generally constant, in a home machine where the consumer can change the ingredients and processing temperatures of the drink product, the thickness and flow rate of the drink product may vary. In a machine where the drink product is initially dispensed in a horizontal direction, the location and flow rate of the subsequent downward trajectory of the dispensed product can thus vary based on the variable thickness and flow rate of the drink product. As a result, a user cannot always predict the proper placement of a drink cup underneath the dispensing assembly, which may result in inadvertent spills from the machine. An additional complication of home use machines is that the flow of the drink product of the machine depends on how much drink product is in the machine. When the machine is full, the drink product will dispense faster and more continuously. However, when the machine has a smaller volume (e.g., a single serving), the drink product will dispense much slower, making the dispense of the drink product less predictable. Finally, a non-uniform thickness of the product as it is driven towards the dispenser by a rotating dasher may be less visually appealing to the user.

The present disclosure, in various implementations, addresses deficiencies associated with prior commercial slush machines. Unfortunately, the architecture of prior commercial slush machines usually requires a significant amount of force to seat the vessel over a large radial seal, making it challenging for a user to install and uninstall the vessel from the device. In many prior commercial slush machines, the vessel is installed by engaging a catch to retain the vessel, which strains the plastic to properly position the vessel and requires significant user effort. Accordingly, there is a need for a more user-friendly architecture to install and uninstall the vessel of a frozen drink maker, such as, for example, a lever that can be used to couple and decouple the vessel to a housing of the frozen drink maker with minimal force and/or that only requires one hand to use.

The present disclosure, in various implementations, addresses deficiencies associated with automatically controlling drink product processing by sensing conditions, such as temperature and/or motor conditions (e.g., current, power, etc.), and controlling the operation of one or more components of the drink maker more efficiently in response to such sensed conditions. The present disclosure describes a number of systems, methods, and devices that enable a drink maker to automatically control a temperature of a drink product based on a target temperature value, which may be predetermined (e.g., stored in memory on the drink maker) or determined during processing the drink product, while further enabling the drink maker to automatically detect conditions of a drink product and/or the drink maker (e.g., the dasher drive motor) to mitigate possible adverse conditions (e.g., excessive ice buildup on the dasher, insufficient chilling, over-chilling, etc.), which could result in damage to the dasher, dasher drive motor, or other components of a drink maker, or which may result in a substandard drink product. The present disclosure includes systems, methods, and devices that address a need for more adaptable and user-specific processing of drink products to ensure user-expected and more satisfying product outcomes, such as desired user-specific textures and temperatures of the drink product being processed.

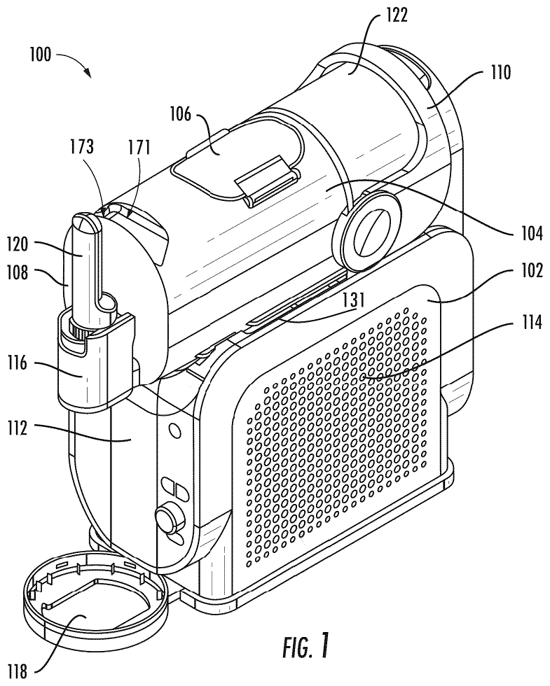

Referring now to FIG. 1, shown is a perspective view of a drink maker 100, according to some non-limiting embodiments or aspects. The drink maker 100 includes a housing 102 and mixing vessel 104. Housing 102 may include user interface 112 for receiving user inputs to control drink maker 100 and/or to output or display information. User interface 112 may include one or more buttons, dials, switches, touchscreens, indicators, LEDs, and the like. User interface 112 may display status information including, for example, a temperature of a drink product within mixing vessel 104, an indicator of a recipe and/or program currently being implemented, a timer associated with the progress of a recipe and/or program in progress and/or currently being implemented. User interface 112 may provide indicators and/or warnings to users regarding, for example, when a recipe is complete or when a user is expected to perform an action associated with processing a drink product. User interface 112 may include a selectable menu of drink types (e.g., recipes) and/or programs for different types of drink products such as, without limitation, granita, smoothie, margarita, daiquiri, piña colada, slush, cocktail, frappé, juice, diary, milkshake, cool drink, semi-frozen drink, frozen drink, and the like.

Housing 102 may include ventilation panel (e.g., a removable panel) 114 along a side of housing 102. Ventilation panel 114 may include a plurality of openings that facilitate air flow to aid in cooling components within housing 102. Housing 102 may include upper housing section 122 that is arranged to couple with a rear end of mixing vessel 104 when mixing vessel 104 is attached to housing 102. Mixing vessel 104 may include walls, or a portion thereof, that are transparent to enable a viewer to see a drink product within mixing vessel 104 during processing. Mixing vessel 104 may include pour-in opening 106 whereby mixing vessel 104 may receive ingredients for processing a drink product within mixing vessel 104. FIG. 1 shows pour-in opening 106 in a closed configuration with a cover sealing opening 106. The cover may be detachably removable or moveable to open or close opening 106. Pour-in opening 106 may include a grate to inhibit a user from reaching into mixing vessel 104 when pour-in opening 106 is open, e.g., the cover is not installed. Mixing vessel 104 may include dispenser assembly 108 having user handle 120, a spout (not shown), and spout shroud and/or cover 116. Dispenser assembly 108 enables a user, by pulling down on handle 120, to open a spout, connected to a wall of mixing vessel 104, to dispense a processed (e.g., cooled) drink product from mixing vessel 104. The user may close the spout by pushing handle 120 back to its upright position (shown in FIG. 1) and, thereby, stop the dispensing of the processed drink product.

Drink maker 100 may include a coupling mechanism that enables a secure coupling of mixing vessel 104 to housing 102, including upper housing section 122. In some non-limiting embodiments or aspects, the coupling mechanism may be a lever 110 rotatably coupled to upper housing section 122. FIG. 1 shows lever 110 in the coupled, locked, and/or closed position whereby mixing vessel 104 is coupled to (e.g., attached to, latched to, and/or locked to) housing 102 and upper housing section 122. In the coupled position, lever 110 ensures that there is a water-tight seal to prevent leakage of drink product from mixing vessel 104. Lever 110 may be placed in the coupled position by sliding mixing vessel 104 against upper housing section 122 and then rotating lever 110 in a clockwise direction until its handle rests on or about the top surface of upper housing section 122. Mixing vessel 104 may be disengaged and/or decoupled from housing 102 and upper housing section 122 by pulling and/or rotating lever 110 in a counter-clockwise direction (from the perspective of FIG. 1) toward the front of mixing vessel 104, which may cause lever 110 to release mixing vessel 104. Once released and/or decoupled, mixing vessel 104 may slide in a forward direction (away from upper housing section 122) to be fully detached and/or removed from housing 102.

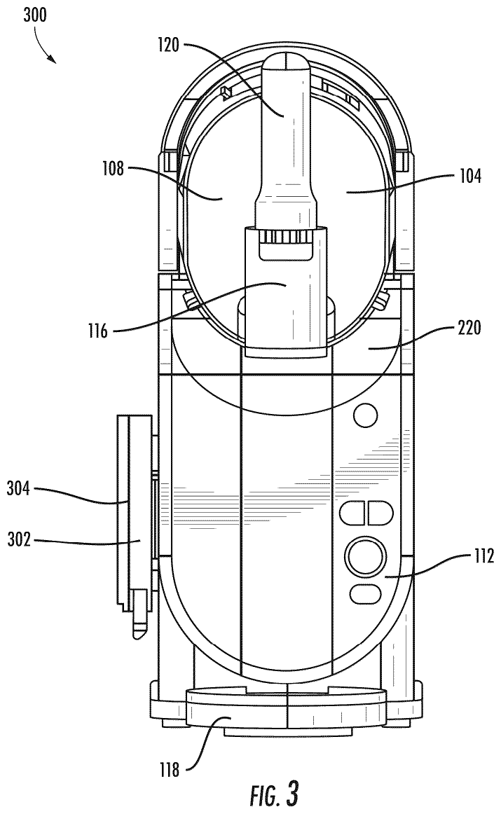

A flexible seal (illustrated in FIG. 8) may be positioned between mixing vessel 104 and upper housing section 122. The flexible seal may include a face seal portion and/or a radial seal portion. If present, the face seal portion may provide an improved seal based on compression provided by lever 110 pushing mixing vessel 104 laterally against a wall of upper housing section 122. Mixing vessel 104 may have a substantially cylindrical shape with a base having an opening formed therein, and the opening is sealed by the flexible seal when lever 110 is in the coupled position. An interlock switch may be implemented at upper housing section 122 that is activated when mixing vessel 104 is coupled to upper housing section 122 that prevents activation of drive motor 208 unless mixing vessel 104 is coupled to upper housing section 122. This ensures that a user is not exposed to a moving dasher 204. Drink maker 100 may also include drip tray 118 being positioned below dispenser assembly 108 and arranged to collect any drink product that is not properly dispensed from mixing vessel 104 to, for example, a user cup. Drip tray 118 may be attachably removable from its operational position shown in FIG. 1. For example, drip tray 118 may be mounted and/or stored on a side panel of housing 102, as illustrated in FIG. 3 as drip tray 304.

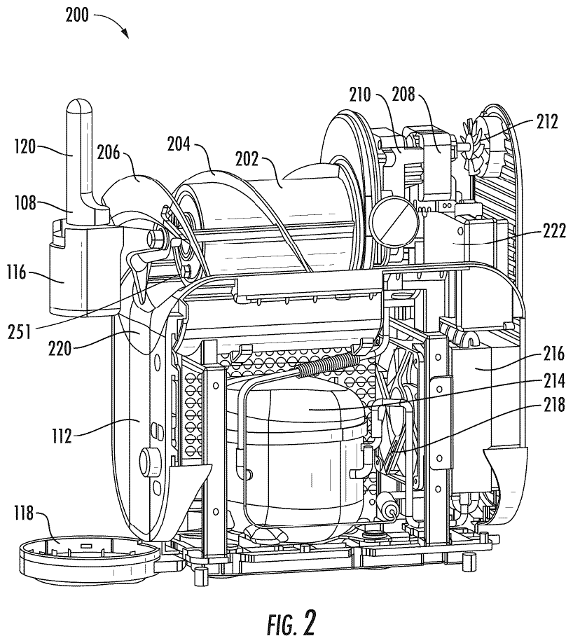

Referring now to FIG. 2, shown is a view 200 of various internal components within housing 102 and mixing vessel 104 of drink maker 100 of FIG. 1, according to some non-limiting embodiments or aspects. Drink maker 100 includes cylindrical evaporator 202 that is surrounded by an auger and/or dasher 204. Dasher 204 may include one or more mixing blades and/or protrusions that extend helically around evaporator and/or chiller 202. Dasher 204 may be driven to rotate by a central drive shaft (not shown) within mixing vessel 104. The drive shaft may be surrounded by evaporator 202. In some non-limiting embodiments or aspects, evaporator 202 may not rotate. The drive shaft may be coupled via gear assembly 210 to drive motor 208. In some non-limiting embodiments or aspects, drive motor 208 may be an alternating current (AC) motor, but another type of motor may be used such as, without limitation, a direct current (DC) motor. Drive motor 208 may include motor fan 212 arranged to provide air cooling for drive motor 208. While FIG. 2 shows an implementation where drive motor 208 is not coaxially aligned with the drive shaft used to rotate dasher 204, in other non-limiting embodiments or aspects, drive motor 208 may be aligned coaxially with the drive shaft. During processing of a drink product, drive motor 208 may be continuously operated at one or more speeds to drive continuous rotation of dasher 204 and, thereby, provide continuous mixing of the drink product within mixing vessel 104. In some non-limiting embodiments or aspects, the rotation of dasher 204 may cause the helically arranged blades to push the cooling drink product to the front of mixing vessel 104. During the processing, portions of the drink product may freeze against the surface of evaporator 202 as a result of being cooled by evaporator 202. In some non-limiting embodiments or aspects, the blades of rotating dasher 204 may scrape frozen portions of the drink product from the surface of evaporator 202 while concurrently mixing and pushing the cooling drink product towards the front of mixing vessel 104.

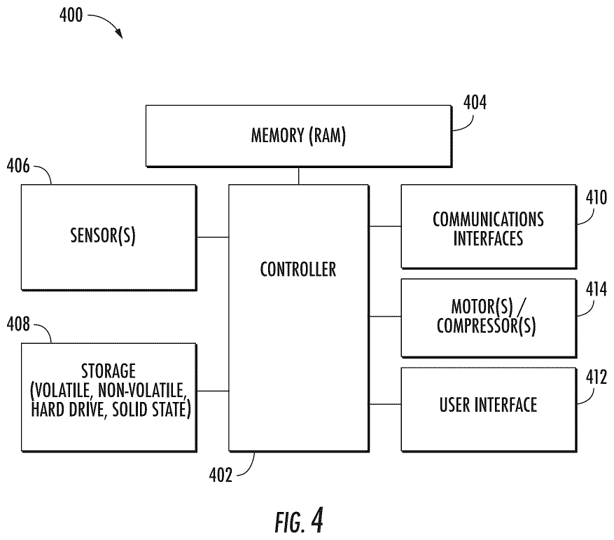

Drink maker 100 may include a refrigeration circuit and/or system to provide cooling of a drink product and/or to control the temperature of a drink product within mixing vessel 104. The refrigeration circuit may include compressor 214, evaporator 202, condenser 216, condenser fan 218, a bypass valve, and conduit that carries refrigerant in a closed loop among the refrigeration circuit components to facilitate cooling and/or temperature control of a drink product in mixing vessel 104. Operations of the refrigeration circuit may be controlled by a controller, such as controller 402, as described further with respect to FIG. 4 later herein. Drink maker 100 may also include collection tray 220 arranged to collect any liquid runoff, e.g., liquid condensation caused by cooling from evaporator 202. Liquid runoff may include any liquid on or adjacent an exterior surface of mixing vessel 104, including, but not limited to, spilled drink product or water, which may fall onto mixing vessel 104 when a user is pouring the drink product or the water into mixing vessel 104. FIG. 2 shows collection tray 220 in an inserted position, within housing 102. Collection tray 220 may be insertably removable from a slot within housing 102 to enable collection of condensed liquid when inserted into the slot, and then efficient removal to empty collection tray 220, and then re-inserted into the slot for subsequent liquid collection.

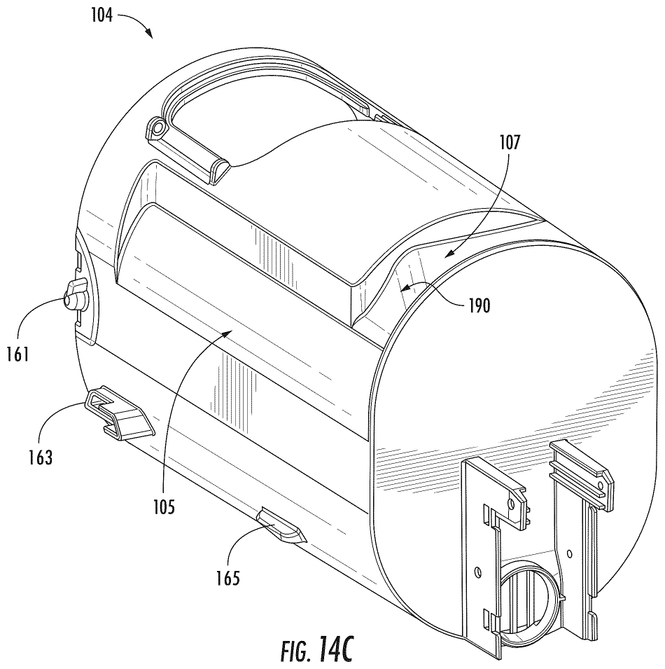

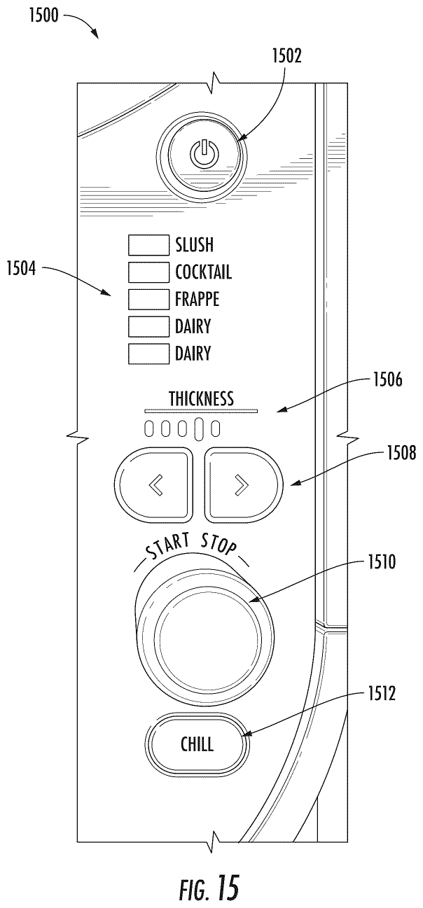

Referring now to FIG. 3, shown is a front view 300 of drink maker 100 of FIG. 1, according to some non-limiting embodiments or aspects. Drink maker 100 may include user interface 112 on a front surface of housing 102. In some non-limiting embodiments or aspects, user interface 112 may be located on a side, top, or back of housing 102. See, e.g., FIGS. 15 and 17 for further non-limiting examples of user interface 112. Drink maker 100 may include a mount 302 on a side of housing 102 where drip tray 118 may be mounted when not in use (shown as drip tray 304 in FIG. 3) such as during transport of drink maker 100. Drink maker 100 may include a power interface arranged to receive AC power from a power outlet (not shown). In some non-limiting embodiments or aspects, drink maker 100 may include one or more batteries housed within housing 102 that are arranged to provide power to various components of drink maker 100. Drink maker 100 may also include a printed circuit board assembly (PCBA) 222 within housing 102. As will be explained with respect to FIG. 4, PCBA 222 may include control system 400 arranged to automatically control certain operations of drink maker 100.

Referring now to FIG. 4, shown is a block diagram illustrating an example of a control system 400 of drink maker 100, according to some non-limiting embodiments or aspects. Control system 400 may include a microcontroller, a processor, a system-on-a-chip (SoC), a client device, and/or a physical computing device and may include hardware and/or virtual processor(s). In some non-limiting embodiments or aspects, control system 400 and its elements as shown in FIG. 4 may each relate to physical hardware. In some non-limiting embodiments or aspects, one, more than one, or all of the elements may be implemented using emulators or virtual machines. Regardless, electronic control system 400 may be implemented at least partly on physical hardware, such as in drink maker 100.

As also shown in FIG. 4, control system 400 may include user interface 412 (e.g., user interface 112), having, for example, one or more input components, such as a keyboard, keypad, one or more buttons, dials, touchpad, or sensor readout (e.g., biometric scanner) and one or more output components, such as displays, speakers for audio, light emitting diode (LED) indicators, and/or light indicators. Control system 400 may also include communications interfaces 410, such as a network communication unit that may include a wired communication component and/or a wireless communications component, which may be communicatively coupled to controller 402, which may include one or more hardware processors. The network communication unit may utilize any of a variety of proprietary or standardized network protocols, such as Ethernet, transfer control protocol (TCP)/internet protocol (IP), to name a few of many protocols, to effect communications between controller 402 and another device, network, or system. Network communication units may also include one or more transceivers that utilize the Ethernet, power line communication (PLC), Wi-Fi®, cellular, and/or other communication methods. For example, control system 400 may send one or more communications associated with a status of drink maker 100 to a mobile device of a user, e.g., send an alert to the mobile device when a recipe is complete and/or a drink product is ready for dispensing, or to indicate that the mixing vessel is low or out of a drink product.

Control system 400 may include a processing element, such as controller 402, which may contain one or more hardware processors, where each hardware processor may have a single or multiple processor cores. In some non-limiting embodiments or aspects, controller 402 may include at least one shared cache that stores data (e.g., computing instructions) that may be utilized by one or more other components of controller 402. For example, the shared cache may be a locally cached data stored in a memory for faster access by components of the processing elements that make up controller 402. Examples of processors include, but are not limited to, a central processing unit (CPU) and/or microprocessor. Controller 402 may utilize a computer architecture based on, without limitation, the Intel® 8051 architecture, Motorola® 68HCX, Intel® 80X86, and/or the like. Controller 402 may include, without limitation, an 8-bit, 12-bit, 16-bit, 32-bit, or 64-bit architecture. Although not illustrated in FIG. 4, the processing elements that make up controller 402 may also include one or more other types of hardware processing components, such as graphics processing units (GPUs), application specific integrated circuits (ASICs), field-programmable gate arrays (FPGAs), and/or digital signal processors (DSPs).

FIG. 4 also illustrates that memory 404 may be operatively and communicatively coupled to controller 402. Memory 404 may be a non-transitory medium configured to store various types of data. For example, memory 404 may include one or more storage devices 408 that include a non-volatile storage device and/or volatile memory. Volatile memory, such as random-access memory (RAM), may be any suitable non-permanent storage device. Non-volatile storage device 408 may include one or more disk drives, optical drives, solid-state drives (SSDs), tape drives, flash memory, read-only memory (ROM), and/or any other type of memory designed to maintain data for a duration time after a power loss or shut down operation. In certain configurations, non-volatile storage device 408 may be used to store overflow data if allocated RAM is not large enough to hold all working data. Non-volatile storage device 408 may also be used to store programs that are loaded into the RAM when such programs are selected for execution. Storage device 408 may be arranged to store a plurality of drink product making and/or processing instruction programs associated with a plurality of drink product processing sequences, e.g., recipes, program instructions, and/or the like. Such drink product making and/or processing instruction programs may include instructions for controller 402 to: start or stop one or motors and/or compressors 414 (e.g., such as drive motor 208 and/or compressor 214), start or stop compressor 214 to regulate a temperature of a drink product being processed within mixing vessel 104, operate the one or more motors and/or compressors 414 (e.g., drive motor 208 and/or compressor 214) at certain periods during a particular drink product processing sequence, operate drive motor 208 at certain speeds during certain periods of time of a recipe, issue one or more cue instructions to user interface 412 that are output to a user to illicit a response, action, and/or input from the user, and/or the like.

Persons of ordinary skill in the art are aware that software programs may be developed, encoded, and compiled in a variety of computing languages for a variety of software platforms and/or operating systems and subsequently loaded and executed by controller 402. In some non-limiting embodiments or aspects, the compiling process of the software program may transform program code written in a programming language to another computer language such that controller 402 is able to execute the programming code. For example, the compiling process of the software program may generate an executable program that provides encoded instructions (e.g., machine code instructions) for controller 402 to accomplish specific, non-generic, particular computing functions.

After the compiling process, the encoded instructions may be loaded as computer executable instructions or process steps to controller 402 from storage device 408, from memory 404, and/or embedded within controller 402 (e.g., via a cache or on-board ROM). Controller 402 may be configured to execute the stored instructions or process steps in order to perform instructions or process steps to transform electronic control system 400 into a non-generic, particular, specially programmed machine or apparatus. Stored data, e.g., data stored by a data store and/or storage device 408, may be accessed by controller 402 during the execution of computer executable instructions or process steps to instruct one or more components within control system 400 and/or other components or devices external to control system 400. For example, the recipes may be arranged in a lookup table and/or database within storage device 408 and be accessed by controller 402 when executing a particular recipe selected by a user via user interface 412.

User interface 412 (e.g., user interface 112) may include a display, positional input device (e.g., a mouse, touchpad, touchscreen, or the like), keyboard, keypad, one or more buttons, one or more dials, a microphone, speaker, or other forms of user input and output components. User interface 412 components may be communicatively coupled to controller 402. When an output component of user interface 412 is or includes a display, the display may be implemented in various ways, including by a liquid crystal display (LCD), a cathode-ray tube (CRT) display, a light emitting diode (LED) display, such as an OLED display, and/or the like.

Sensors 406 may include one or more sensors that detect and/or monitor conditions of a drink product within mixing vessel 104, conditions associated with a component of drink maker 100, and/or conditions of a refrigerant within the refrigeration system. Conditions may include, without limitation, rotation, speed of rotation, and/or movement of a device or component (e.g., a motor, such as drive motor 208), rate of such movement, frequency of such movement, direction of such movements, motor current, motor voltage, motor power, motor torque, temperature, pressure, fluid level in mixing vessel 104, position of a device or component (e.g., whether pour-in opening 106 is open or closed), and/or the presence of a device or component (e.g., whether shroud 116 is installed or not). Types of sensors 406 may include, for example, electrical metering chips, Hall sensors, pressure sensors, temperature sensors, optical sensors, current sensors, torque sensors, voltage sensors, cameras, other types of sensors, or any suitable combination of the foregoing. Drink maker 100 may include one or more temperature sensors positioned in various locations within mixing vessel 104 such as, for example, on or about the lower front area within mixing vessel 104, on or about the upper front area within mixing vessel 104, on or about the upper rear area within mixing vessel 104, within one or more coils of evaporator 202, in or on a metal drum of evaporator 202, and/or within housing 102.

Sensors 406 may also include one or more safety and/or interlock switches that prevent or enable operation of certain components, e.g., a motor, when certain conditions are met (e.g., enabling activation of drive motor 208 and/or compressor 214 when a lid or cover for pour-in opening 106 is attached or closed and/or when a sufficient level of drink product is in mixing vessel 104). Persons of ordinary skill in the art are aware that electronic control system 400 may include other components well known in the art, such as power sources and/or analog-to-digital converters, not explicitly shown in FIG. 4.

In some non-limiting embodiments or aspects, control system 400 and/or controller 402 may include a system-on-a-chip (SoC) having multiple hardware components, including but not limited to: a microcontroller, microprocessor or digital signal processor (DSP) core and/or multiprocessor SoCs (MPSoC) having more than one processor cores; memory blocks including a selection of read-only memory (ROM), random access memory (RAM), electronically erasable programmable read-only memory (EEPROM), and flash memory; timing sources including oscillators and phase-docked loops; peripherals including counter-timers, real-time timers and power-on reset generators; external interfaces, including industry standards such as universal serial bus (USB), FireWire®, Ethernet, universal synchronous/asynchronous receiver/transmitter (USART), serial peripheral interface (SPI); analog interfaces including analog-to-digital converters (ADCs) and digital-to-analog converters (DACs); and voltage regulators and power management circuits.

A SoC may include both the hardware, described above, and software controlling the microcontroller, microprocessor and/or DSP cores, peripherals, and interfaces. SoCs may be developed from pre-qualified hardware blocks for the hardware elements (e.g., referred to as modules or components which represent an IP core or IP block), together with software drivers that control their operation. The above listing of hardware elements is not exhaustive. A SoC may include protocol stacks that drive industry-standard interfaces like a universal serial bus (USB).

Once the overall architecture of the SoC has been defined, individual hardware elements may be described in a register-transfer level (RTL). RTL may be used to define the circuit behavior. Hardware elements may be connected together in the same RTL language to create the full SoC design. RTL may be a design abstraction which models a synchronous digital circuit in terms of the flow of digital signals (data) between hardware registers, and the logical operations performed on those signals. RTL abstraction may be used in hardware description languages (HDLs) like Verilog and very high-speed integrated circuit (VHSIC) hardware description language (VHDL) to create high-level representations of a circuit, from which lower-level representations and ultimately actual wiring may be derived. Verilog is standardized as Institute of Electrical and Electronic Engineers (IEEE) 1364 and is an HDL used to model electronic systems. Verilog may be used in the design and verification of digital circuits at the RTL level of abstraction. Verilog may also be used in the verification of analog circuits and mixed-signal circuits, as well as in the design of genetic circuits. In some non-limiting embodiments or aspects, various components of control system 400 may be implemented on a printed circuit board (PCB) such as PCBA 222.

In some non-limiting embodiments or aspects, a user may fill mixing vessel 104 via pour-in opening 106 with ingredients associated with a drink product. The user may select the type of drink product to be processed via user interface 112, e.g., the user may select the recipe for “margarita.” In some non-limiting embodiments or aspects, the user may select the product type and/or recipe before filling mixing vessel 104 and user interface 112 provides one or more indicators or queues (visible and/or audible) that instruct the user to add ingredients to mixing vessel 104. Mixing vessel 104 may include one or more fill sensors that detect when a sufficient amount or level of ingredients and/or fluid is within mixing vessel 104. The one or more fill sensors may provide a signal to controller 402 that indicates when mixing vessel 104 is sufficiently filled or not filled. Controller 402 may prevent operations of the drink maker 100 (e.g., prevent activation of motor 208 and/or other components) if the fill sensor(s) 406 indicate that mixing vessel 104 is not sufficiently filled. A lid sensor may be associated with pour-in opening 106 whereby the lid sensor sends an open and/or closed signal to controller 402 that indicates whether pour-in opening 106 is open or closed. Controller 402 may prevent operations of drink maker 100 if the lid sensor indicates that pour-in opening 106 is open and/or not closed. Depending on the sensed condition, user interface 112 may provide an indication regarding the condition, e.g., that mixing vessel 104 is sufficiently filled or not sufficiently filled and/or that pour-in opening 106 is not closed, to enable a user to take appropriate action(s).

Once mixing vessel 104 is filled with ingredients, the user may provide an input, e.g., a button press, to start processing of the drink product based on the selected recipe. Processing may include activation of drive motor 208 to drive rotation of dasher 204 and/or blade 206 to effect mixing of the ingredients of the drink product. Processing may also include activation of the refrigeration system including activation of compressor 214 and condenser fan 218. Compressor 214 may facilitate refrigerant flow through one or more coils of evaporator 202 and through condenser 216 to provide cooling and/or temperature control of the drink product within mixing vessel 104. Controller 402 may control operations of various components such as drive motor 208 and/or compressor 214. To regulate temperature at a particular setting associated with a recipe, controller 402 may activate/start and/or de-activate/stop compressor 214, to start and/or stop refrigerant flow through the coil(s) of evaporator 202 and, thereby, start or stop cooling of the drink product within mixing vessel 104.

By cooling a drink product to a particular temperature, slush and/or ice particles may be formed within the drink product. A presence of ice particles, forming a slush, may directly affect a texture of the drink product. The amount of particles and/or texture of a drink product may correspond to a temperature of the drink product, e.g., the cooler the temperature, the larger the amount of ice particles (and/or the larger the size of ice particles) and/or the higher proportion of slush in the drink product. User interface 112 may enable a user to fine tune and/or adjust a preset temperature associated with a recipe to enable a user to adjust the temperature and/or texture of a drink product to a more desirable temperature and/or texture.

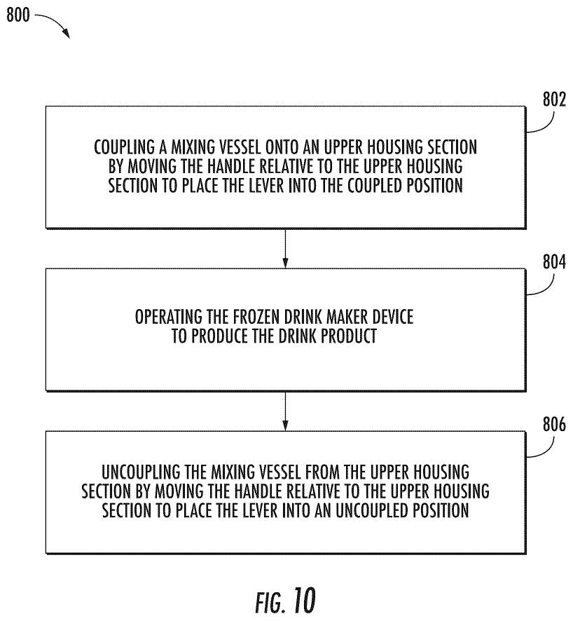

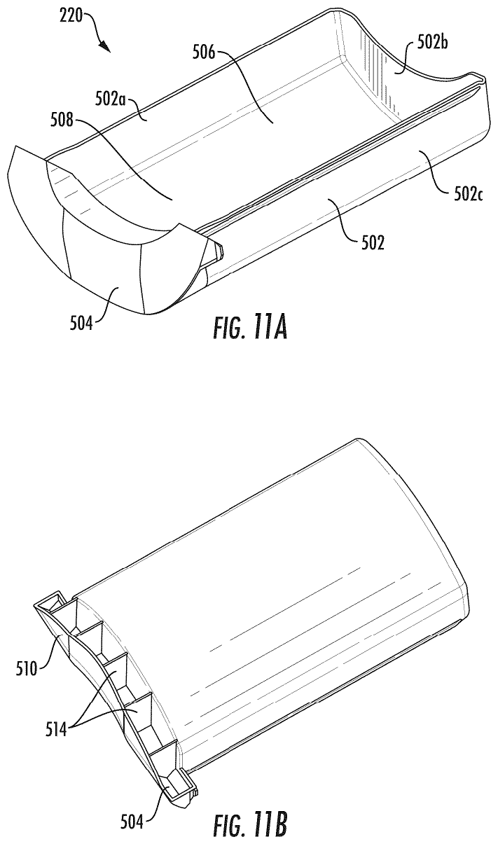

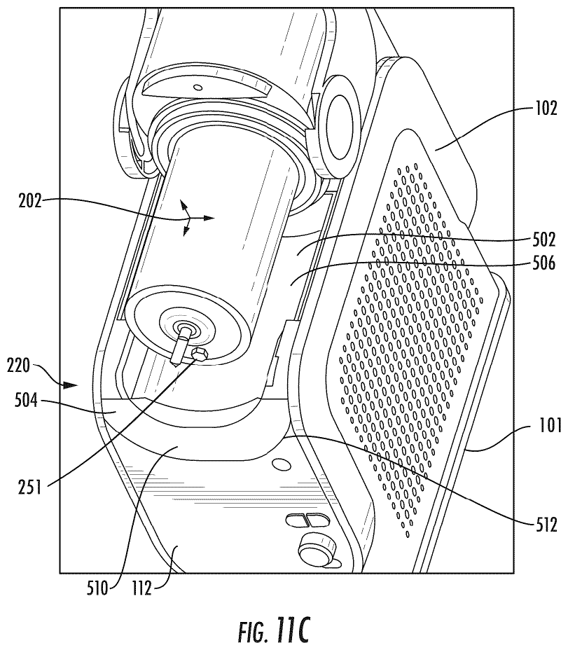

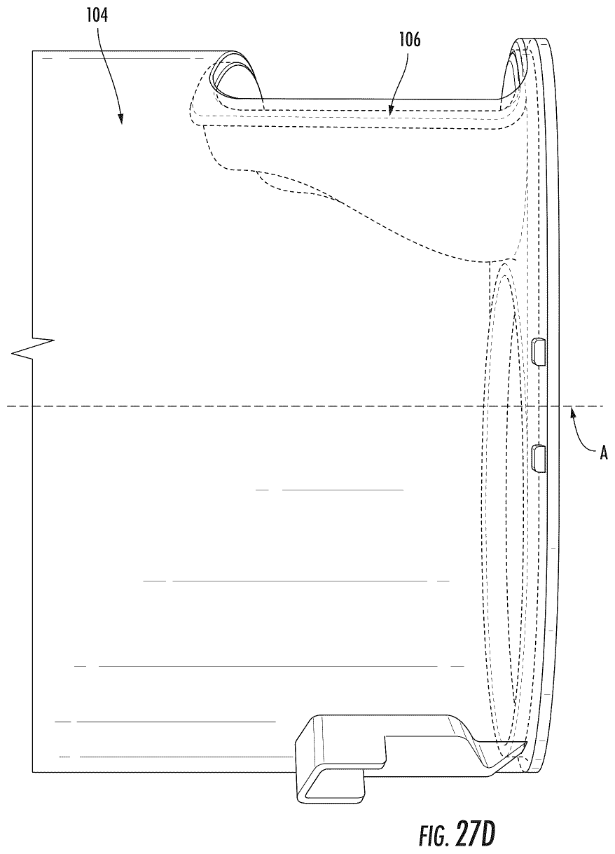

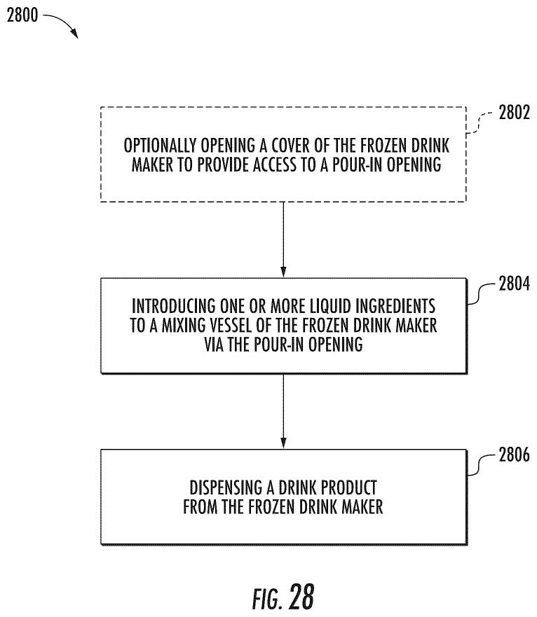

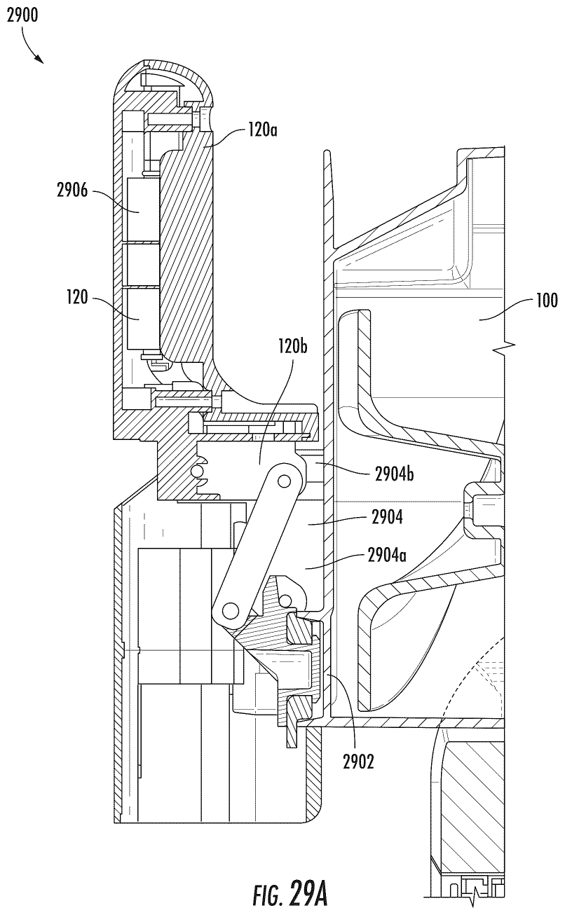

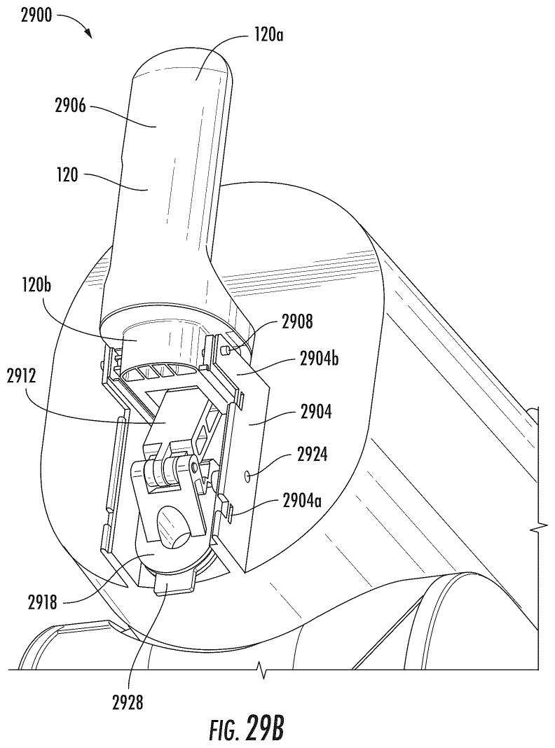

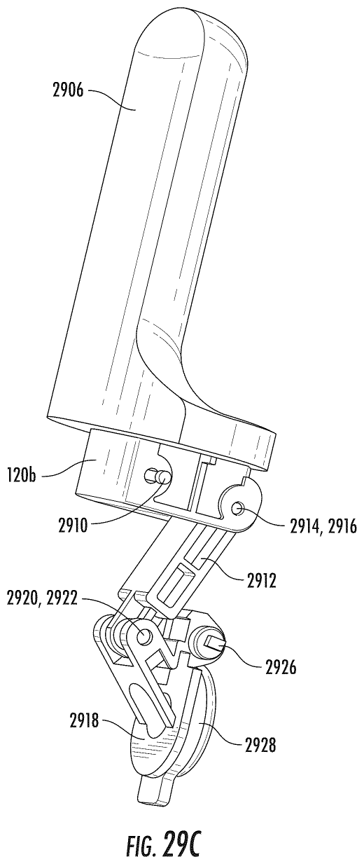

Controller 402 may perform processing of the drink product for a set period of time in one or more phases and/or until a desired temperature and/or texture is determined. Controller 402 may receive one or more temperature signals from one or more temperature sensors 406 (e.g., temperature sensor 251, shown in FIGS. 2, 11C, and 11D) within mixing vessel 104 to determine the temperature of the drink product. Controller 402 may determine the temperature of the drink product by determining an average temperature among temperatures detected by multiple temperature sensors 406. Controller 402 may determine the temperature of the drink product based on the detected temperature from one sensor 406 within mixing vessel 104 and/or based on a temperature of the refrigerant detected by a refrigerant temperature sensor 406. Once a phase and/or sequence of a recipe is determined to be completed by controller 402, controller 402 may, via user interface 112, provide a visual and/or audio indication that the recipe is complete and ready for dispensing. In response, a user may place a cup or container below dispenser assembly 108 and pull handle 120 rotationally downward towards the user to open a spout (e.g., spout 2902, as shown in FIG. 29A) located at the lower front wall of mixing vessel 104, resulting in dispensing of the drink product into the cup or container. Once filled, the user may close the spout by pushing handle 120 back rotationally upward away from the user to its upright position shown in FIG. 2. In non-limiting embodiments or aspects where handle 120 is spring-biased to the closed position, the user may release their hold of handle 120 and, thereby, allow a spring force to move handle 120 back rotationally upward away from the user to the upright and closed position.

In some non-limiting embodiments or aspects, actions associated with configuring or controlling drink maker 100 and processes described herein (see, e.g., FIG. 4) may be performed by one or more programmable processors executing one or more computer programs to control or to perform all or some of the operations described herein. All or part of drink maker 100 systems and processes may be configured or controlled by special purpose logic circuitry, such as, a field-programmable gate array (FPGA) and/or an application-specific integrated circuit (ASIC) or embedded microprocessor(s) localized to the instrument hardware.

Non-transitory machine-readable storage media suitable for embodying computer program instructions and data may include all forms of non-volatile storage area, including by way of example, semiconductor storage area devices, such as EPROM (erasable programmable read-only memory), EEPROM (electrically erasable programmable read-only memory), and flash storage area devices; magnetic disks, such as internal hard disks or removable disks; magneto-optical disks; and CD-ROM (compact disc read-only memory) and DVD-ROM (digital versatile disc read-only memory).

Elements of different implementations described may be combined to form other implementations not specifically set forth previously. Elements may be left out of the systems described previously without adversely affecting their operation or the operation of the system in general. Furthermore, various separate elements may be combined into one or more individual elements to perform the functions described in this specification.

In some non-limiting embodiments or aspects, controller 402, in communication with memory 404, may be arranged to: (i) receive the temperature signal, and (ii) control the temperature associated with the drink product by controlling the cooling circuit based on the received temperature signal, the first temperature value, and/or a manual temperature adjustment and/or temperature offset. The temperature associated with the drink product may include a temperature of the drink product, a temperature of a cooling element used to cool the drink product, and/or a temperature of a refrigerant used to cool the drink product. The controller may adjust the first target temperature by adding the manual temperature adjustment to the first target temperature. The manual temperature adjustment may include positive or negative temperature value. The manual temperature adjustment may include a range of temperatures at, above, and below the first target temperature. The manual temperature adjustment may be adjustable in increments of greater than or equal to 0.1, 0.2, 0.3, 0.4, 0.5, 1, and/or 2 degrees Celsius. In some non-limiting embodiments or aspects, the cooling circuit may include a thermal energy cooling (TEC) system implementing, for example, the Peltier effect. Controller 402, in communication with memory 404, may be arranged to: (i) receive a temperature signal, (ii) receive a motor condition signal, and (iii) control the temperature associated with the drink product by controlling the cooling circuit based at least on the received temperature signal, the received motor condition signal, the first temperature value, and the motor condition limit.

In some non-limiting embodiments or aspects, controller 402 may deactivate the cooling circuit when a magnitude (e.g., a current or power level) of the received motor condition signal is equal to or greater than the motor condition limit. Controller 402 may determine a second temperature value corresponding to a second target temperature, where the magnitude of the received motor condition signal is lower than the motor condition limit. Controller 402 may control the temperature associated with the drink product by controlling the cooling circuit based on the second temperature value. In some non-limiting embodiments or aspects, controller 402 may deactivate the cooling circuit until when the temperature associated with the drink product is about equal to the second target temperature.

The motor condition may include current, power, torque, speed of rotation, acceleration of rotation, noise, and/or thermal output. The motor condition sensor may include a motor current sensor, motor voltage sensor, motor torque sensor, motor rotation sensor, acoustic sensor, and/or temperature sensor. User interface 412 may be arranged to receive a user input to adjust a manual temperature adjustment. Controller 402 may control the temperature associated with the drink product by controlling the cooling circuit based on the received temperature signal, the received motor condition signal, the first temperature value, the motor condition limit, and/or the manual temperature adjustment. Controller 402 may adjust the first target temperature by adding the manual temperature adjustment to the first target temperature.

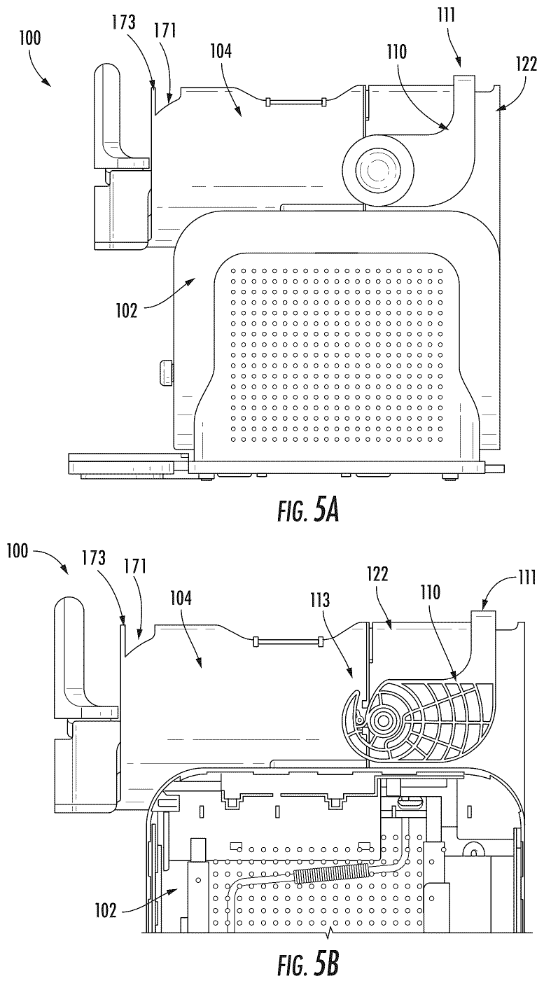

Referring now to FIGS. 5A and 5B, shown is a side view of drink maker 100, according to some non-limiting embodiments or aspects. As previously mentioned, drink maker 100 may include upper housing section 122 arranged to couple with a rear end of mixing vessel 104 when mixing vessel 104 is attached to housing 102. Drink maker 100 may also include lever 110 that may enable mixing vessel 104 to be coupled (e.g., locked, attached to, and/or affixed to) to housing 102 (e.g., upper housing section 122). Lever 110 may also enable mixing vessel 104 to be unlocked and decoupled from housing 102 (e.g., upper housing section 122). Features of lever 110 are shown in FIGS. 5A and 5B. FIG. 5A illustrates a side view of drink maker 100, with mixing vessel 104 in a coupled position relative to upper housing section 122. FIG. 5B illustrates a side view of drink maker 100 illustrated in FIG. 5A, with some features of housing 102 and lever 110 shown in partial cross-section.

As shown in FIGS. 5A and 5B, lever 110 may include handle 111 that may be gripped by a user and moved relative to upper housing section 122. Handle 111 may be moved into the position shown in FIGS. 5A and 5B to couple mixing vessel 104 into place on drink maker 100 and may be moved away from upper housing section 122 and/or toward a front of housing 102 to decouple mixing vessel 104 from drink maker 100. When handle 111 is moved relative to upper housing section 122, it may activate cam 113, which may engage mating features on mixing vessel 104 to either couple or uncouple mixing vessel 104 relative to upper housing section 122. In some non-limiting embodiments or aspects, handle 111 may move less than 90° relative to upper housing section 122 when moving between the coupled position and the uncoupled position.

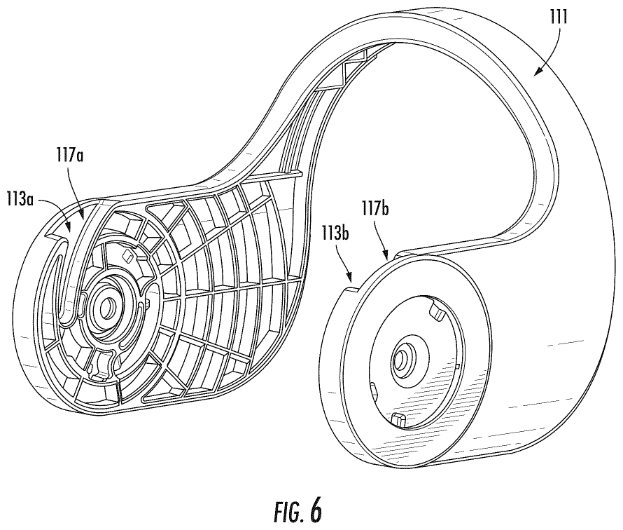

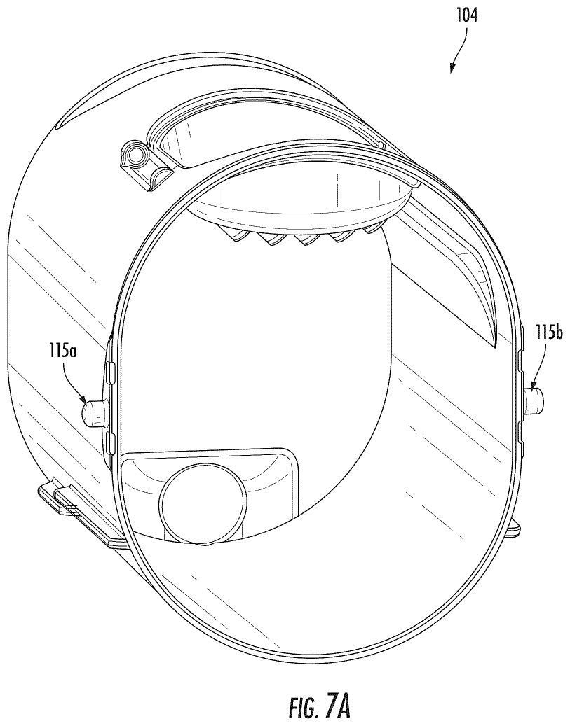

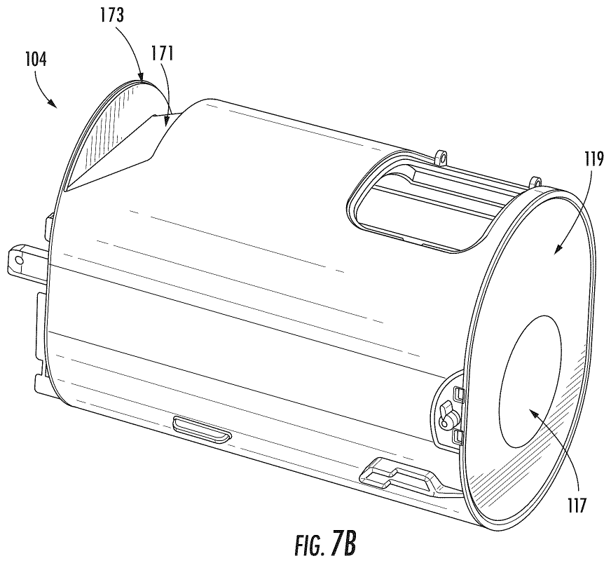

Referring now to FIG. 6, shown is a detailed view of handle 111 with two cams 113a, 113b positioned on opposing sides, according to some non-limiting embodiments or aspects. Handle 111 may include one, two, three, four, or more cams 113, if desired. As handle 111 is moved, cams 113a, 113b may rotate with respect to upper housing section 122. FIG. 7A shows a rear view of mixing vessel 104. Mixing vessel 104 may include protrusions 115a, 115b on opposing outer sides, near the rear bottom of mixing vessel 104. Protrusions 115a, 115b may be shaped and/or positioned to engage with cams 113a, 113b on handle 111. In particular, cams 113a, 113b may have channels and/or cam paths 109a, 109b through which protrusions 115a, 115b slide, respectively. As cams 113a, 113b rotate toward the back of housing 102, protrusions 115a, 115b may slide along cam paths 109a, 109b and may be pulled toward upper housing section 122 and the rear of housing 102, causing mixing vessel 104 to press against upper housing section 122 and form a water-tight seal with housing 102. When cams 113a, 113b are rotated toward the front of drink maker 100, protrusions 115a, 115b may be pushed away from upper housing section 122, causing mixing vessel 104 to be decoupled from contact with upper housing section 122.

Cam 113 may be an over-center cam, as shown in FIG. 5B and FIG. 6, or cam 113 may have alternative geometry. In the disclosed drink maker 100, cam 113 may retain mixing vessel 104 on housing 102 when lever 110 is in the coupled position. As previously discussed, mixing vessel 104 may have an overall cylindrical or approximately cylindrical shape (e.g., ovoid, stadium, partially rounded, etc.) and may include opening 117 (shown in FIG. 7B) at a rear end of mixing vessel 104 that couples to upper housing section 122. As shown in FIG. 7B, opening 117 may be in rear panel 119 of mixing vessel 104. Opening 117 may be positioned to face along a horizontal axis when mixing vessel 104 is in the coupled position on upper housing section 122.

With specific reference to FIGS. 5A and 5B, to move lever 110 into a coupled position, handle 111 may be moved toward upper housing section 122. When mixing vessel 104 is in a coupled position on upper housing section 122, lever 110, in cooperation with flexible seal 121, may seal opening 117. With specific reference to FIG. 8, shown is flexible seal 121, according to some non-limiting embodiments or aspects. Flexible seal 121 may be formed of an elastomeric material, such as natural or synthetic rubber, silicone, neoprene, chloroprene, polyisoprene, polybutadiene, or combinations thereof. Flexible seal 121 may be independent of housing 102. Additionally, or alternatively, flexible seal 121 may be affixed to upper housing section 122. Flexible seal 121 may be a single member including face seal portion 123 and/or radial seal portion 125, as shown in FIG. 8. In some non-limiting embodiments or aspects, face seal portion 123 and radial seal portion 125 may be implemented with distinct flexible seals of flexible seal 121.

Face seal portion 123 may have an annular shape with a primary dimension that is vertically aligned to form a vertically aligned seal between a horizontal face of upper housing section 122 and a horizontal edge of mixing vessel 104. When in the coupled position, face seal portion 123 may interface a vertically aligned surface of upper housing section 122 to a vertically aligned side of mixing vessel 104. Radial seal portion 125 may include multiple flexible annular ribs, as shown in FIG. 8. Radial seal portion 125 may form a radial seal relative to the horizontal axis of mixing vessel 104, sealing against an inside (e.g., at least partly cylindrical) surface of mixing vessel 104. Flexible seal 121 may include at least one of radial seal portion 125 and face seal portion 123.

Previously known drink makers do not include both a face seal and a radial seal for a mixing vessel. If present, face seal portion 123 of flexible seal 121 may provide an improved seal based on compression provided by handle 111 pushing mixing vessel 104 laterally against a wall of upper housing section 122. Cam 113 also may allow high force on face seal portion 123 to be easily achieved and maintained. Since face seal portion 123 may serve as the primary seal in some implementations, a size of radial seal portion 125 may be reduced, thereby lowering a resistance of mixing vessel 104 to seating and improving case of use.

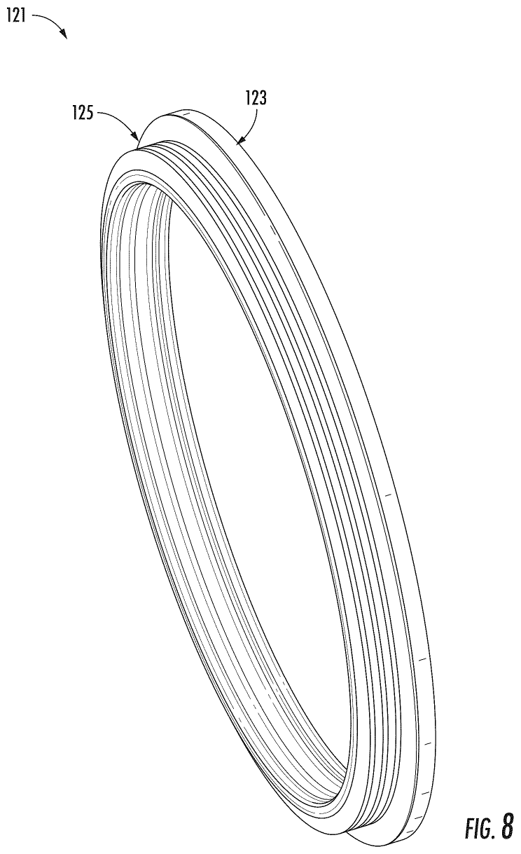

In some non-limiting embodiments or aspects, flexible seal 121 may serve as the seal for mixing vessel 104 and/or evaporator 202. For example, FIG. 9 shows a cross-sectional view of sample flexible seal 121 having vessel seal portion 127 and evaporator seal portion 129. Vessel seal portion 127 of flexible seal 121 may create a watertight seal between mixing vessel 104 and upper housing section 122. Evaporator seal portion 129 of flexible seal 121 may seal evaporator 202 within mixing vessel 104.

To move lever 110 from a coupled position to an uncoupled position, handle 111 may be moved away from upper housing section 122 and/or toward a front of housing 102, which may cause mixing vessel 104 to slide in a forward direction (away from upper housing section 122) to be fully detached and/or removed from housing 102. If desired, cam 113 may include an ejection feature to apply an ejection force to mixing vessel 104 to eject past radial seal portion 125.

With specific reference to FIGS. 1, 5A, 5B, and 7B, mixing vessel 104 may be configured to permit and promote a user to grab onto a front of mixing vessel 104, to assist with positioning, engagement, and/or movement of mixing vessel 104. For example, mixing vessel 104 may include an indentation 171 on an exterior of mixing vessel 104. Indentation 171 may correspond to an internal baffle (e.g., front baffle 107) of mixing vessel 104. Additionally, or alternatively, mixing vessel 104 may include a vertical protrusion 173 extending from a front surface of mixing vessel 104, e.g., above a front edge of indentation 171. In this manner, indentation 171 and/or vertical protrusion 173 may act, or co-act, to provide a grip point for user to manually interact with mixing vessel 104.

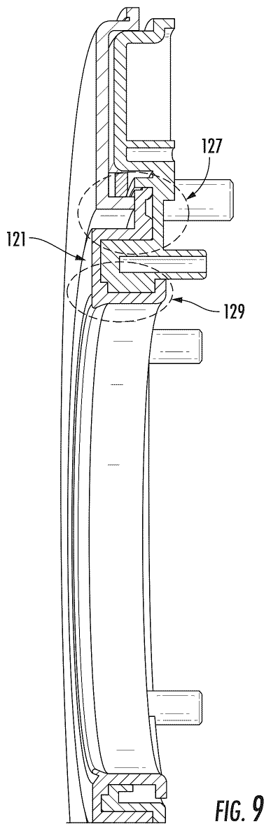

Referring now to FIG. 10, shown is a flow diagram of method 800 for operating drink maker 100, according to some non-limiting embodiments or aspects. FIG. 10 illustrates method 800 of producing a frozen drink using drink maker 100. Drink maker 100 may include housing 102 having upper housing section 122 and lever 110 configured to move relative to upper housing section 122, between a coupled position and an uncoupled position, and mixing vessel 104 arranged to couple to upper housing section 122. Lever 110 may include handle 111 that is moveable to place lever 110 into the coupled position and/or the uncoupled position. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 10, method 800 may include, at step 802, coupling mixing vessel 104 onto upper housing section 122 by moving handle 111 relative to upper housing section 122 to place lever 110 into the coupled position. When in the coupled position, at least one of a face seal and a radial seal may be formed between mixing vessel 104 and upper housing section 122.

As shown in FIG. 10, method 800 may include, at step 804, operating drink maker 100 to produce the drink product.

As shown in FIG. 10, method 800 may include, at step 806, uncoupling mixing vessel 104 from upper housing section 122 by moving handle 111 relative to upper housing section 122 to place lever 110 into an uncoupled position.

In some non-limiting embodiments or aspects, coupling mixing vessel 104 onto upper housing section 122 may involve moving handle 111 toward upper housing section 122. In some non-limiting embodiments or aspects, uncoupling mixing vessel 104 from upper housing section 122 may involve moving handle 111 away from upper housing section 122 and/or toward a front of housing 102. Moving handle 111 relative to upper housing section 122 to place lever 110 into the coupled position and/or the uncoupled position may be accomplished by a user using only one hand. In some non-limiting embodiments or aspects, moving handle 111 relative to upper housing section 122 to position lever 110 from and between the coupled position to the uncoupled position may require moving handle 111 less than 90° relative to upper housing section 122.

Referring now to FIGS. 11A and 11B, shown are perspective views of collection tray 220, according to some non-limiting embodiments or aspects. Collection tray 220 may generally include collection portion 502 and handle 504 that may be used to insert collection tray 220 into and remove collection tray 220 from housing 102. Collection portion 502 may include three walls 502a, 502b, 502c extending generally upwards from evaporator-facing surface 506. Together with handle 504, walls 502a, 502b, 502c and evaporator-facing surface 506 may define chamber 508 for collecting liquid runoff, including condensation falling from evaporator 202, spills, and water poured into mixing vessel 104 to clean the inside of mixing vessel 104. A shape of collection portion 502, including evaporator-facing surface 506, may correspond to an outer shape of evaporator 202. For example, the shape of evaporator-facing surface 506 may be semi-cylindrical to correspond to the cylindrical shape of evaporator 202, as shown in FIG. 11A. However, the disclosure contemplates other suitable shapes, such as rectangular, of collection portion 502. In some non-limiting embodiments or aspects, chamber 508 may have a liquid volume capacity of about 16 ounces. However, the disclosure contemplates a liquid volume capacity of more or fewer than 16 ounces. As shown in FIG. 11B, an underside of handle 504 may define one or more ribs 514 for adding structural integrity between user-facing surface 510 of handle 504 and the main body of collection tray 220. Collection tray 220 may be made from dishwasher-safe materials for easy cleaning.

Referring now to FIG. 11C, shown is a view of collection tray 220 inserted into housing 102 of drink maker 100, according to some non-limiting embodiments or aspects. For case of illustration, housing 102 is shown with mixing vessel 104 and attached dispenser assembly 108 removed. When fully inserted, user-facing surface 510 of handle 504 may sit flush with user interface 112 of housing 102. In the inserted position, collection tray 220 may be spaced vertically above bottom side 101 of housing 102. Once liquid is collected in chamber 508, the user may remove collection tray 220 for disposal of the collected liquid and cleaning of collection tray 220.

Referring now to FIG. 11D, shown is a view of housing 102 with collection tray 220 removed, according to some non-limiting embodiments or aspects. As shown in FIG. 11D, housing 102 may include top surface 520 for supporting collection tray 220 when collection tray 220 is inserted into housing 102. A shape of top surface 520 may be semi-cylindrical to correspond to the semi-cylindrical shape of evaporator-facing surface 506. Housing 102 may also include one or more rails 522 defining one or more slots 512 between rails 522 and top surface 520. Rails 522 may help guide the user in inserting collection tray 220 into slots 512 when installing collection tray 220 to housing 102.

In some non-limiting embodiments or aspects, to remove collection tray 220 (e.g., for emptying and/or cleaning collection tray 220), the user may first remove mixing vessel 104 and attached dispenser assembly 108 (see FIG. 1). The user may then remove collection tray 220 by pulling collection tray 220 toward the user. This movement may cause collection tray 220 to slide along slots 512 until it is completely disengaged from housing 102. Conversely, to insert collection tray 220 into housing 102, the user may insert collection tray 220 into housing 102 by inserting collection portion 502 into slots 512 underneath evaporator 202 (see FIG. 2), such that evaporator-facing surface 506 faces evaporator 202. In some non-limiting embodiments or aspects, after collection tray 220 has been inserted into housing 102, mixing vessel 104 with the attached dispenser assembly 108 may be inserted onto housing 102 and fastened and sealed against housing 102.

With specific reference to FIGS. 2, 11C, and 11D, drink maker 100 may include at least one temperature sensor 251 configured to be positioned in mixing vessel 104 when mixing vessel 104 is engaged with housing 102. For example, temperature sensor 251 may be positioned on or in evaporator 202 (e.g., a metal drum thereof), such that when mixing vessel 104 is engaged with housing 102 and evaporator 202 is inside mixing vessel 104, temperature sensor 251 may contact and/or be proximate to drink product in mixing vessel 104 and produce temperature signals corresponding to a temperature of the drink product.

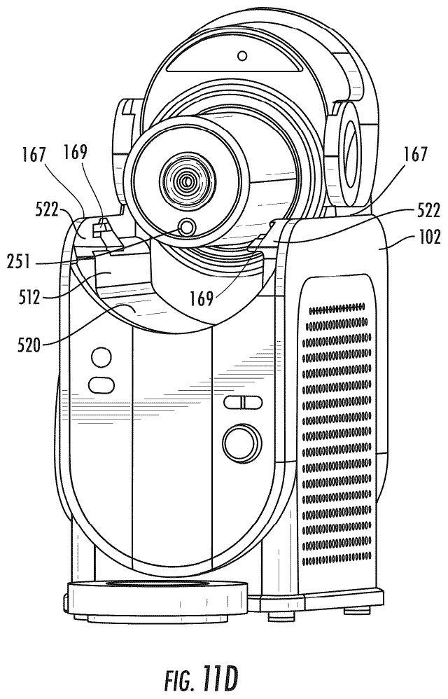

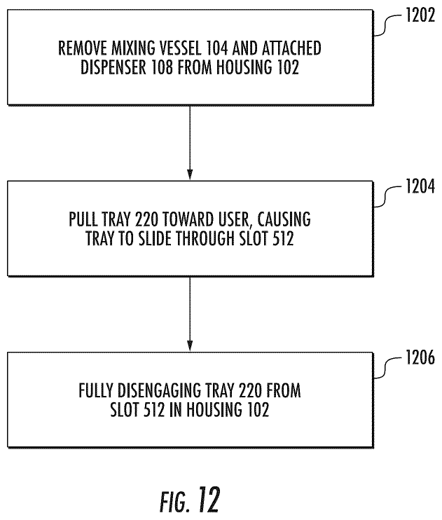

Referring now to FIG. 12, shown is a flow diagram illustrating a method of removing collection tray 220 from housing 102, according to some non-limiting embodiments or aspects.

As shown in FIG. 12, the method may include, at step 1202, removing mixing vessel 104 and attached dispenser assembly 108 from housing 102.

As shown in FIG. 12, the method may include, at step 1204, pulling collection tray 220 toward the user, causing collection tray 220 to slide through slot 512.

As shown in FIG. 12, the method may include, at step 1206, fully disengaging collection tray 220 from slot 512 in housing 102.

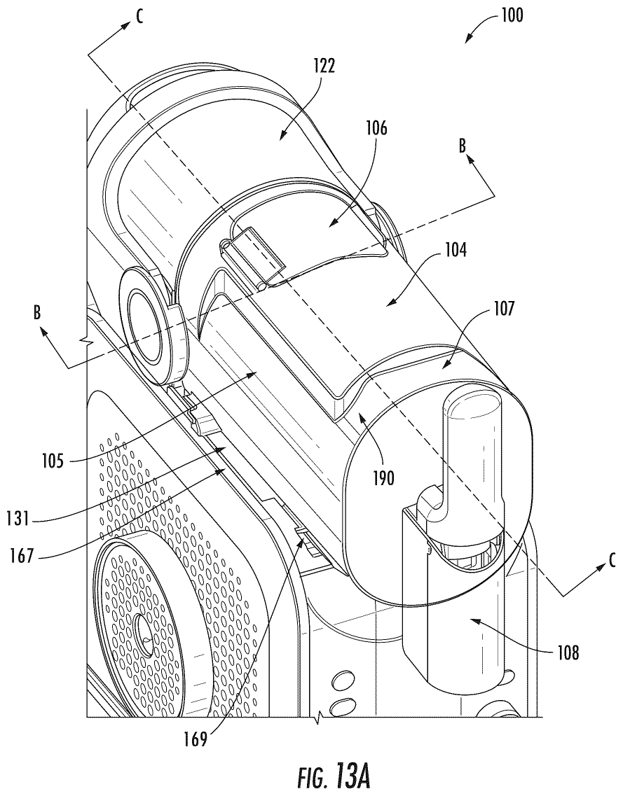

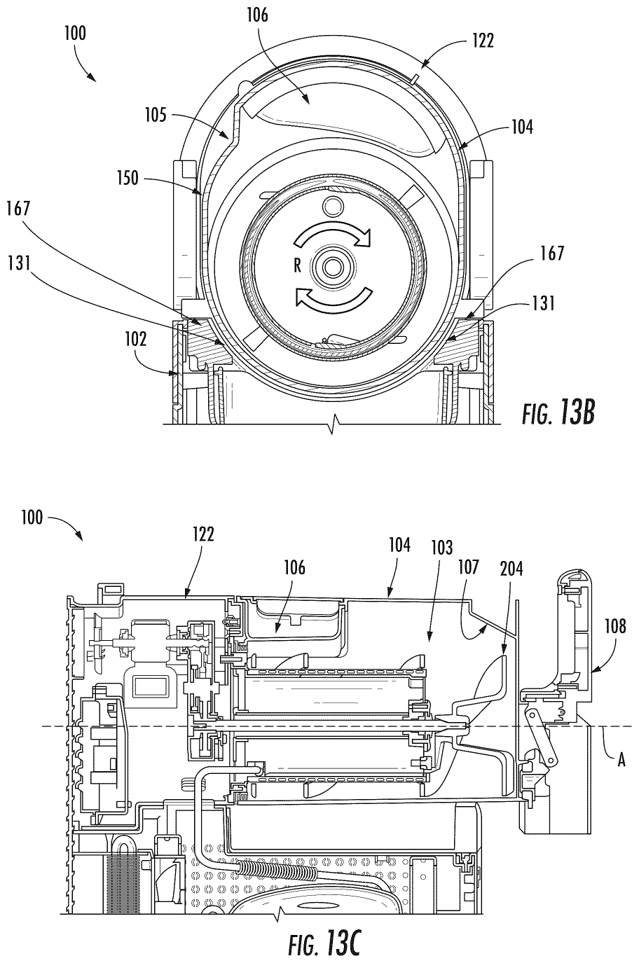

Referring now to FIGS. 13A-13C, shown are views of drink maker 100 with mixing vessel 104 coupled to housing 102 (e.g., to upper housing section 122) and dispenser assembly 108, according to some non-limiting embodiments or aspects. Mixing vessel 104 may have a curved sidewall defining an at least partly cylindrical chamber within. In some non-limiting embodiments or aspects, mixing vessel 104 may be shaped as an ovoid or approximately as an ovoid (e.g., a cylinder with an ovular cross-section), as a stadium (e.g., an elongated chamber with a stadium cross-section), as an elliptic cylinder (e.g., a cylinder with an elliptic cross-section), as an approximate elliptic cylinder, and/or the like. When coupled to housing 102, the front of mixing vessel 104 may be connected to dispenser assembly 108 and the rear of mixing vessel 104 may abut upper housing section 122. Within mixing vessel 104, the front face of the chamber may have a substantially ovular shape or an at least partly circular shape. The rear of mixing vessel 104 chamber may include an opening configured to form a seal with upper housing section 122. The opening at the rear of mixing vessel 104 may have a substantially circular shape or a substantially ovular shape. Mixing vessel 104 may be sized to accommodate dasher 204, which rotates about a center axis (shown as center axis “A” in FIG. 13C). FIG. 13B shows a possible direction of dasher 204 rotation (“R”). Mixing vessel 104 may be shaped such that a distance from an axis (A) (e.g., a center axis, a primary axis, a major axis) of dasher 204 to the top of vessel chamber 103 (shown in FIG. 13C) of mixing vessel 104 is less than 6 inches, less than 8 inches, less than 10 inches, less than 12 inches, less than 14 inches, or less than 16 inches.

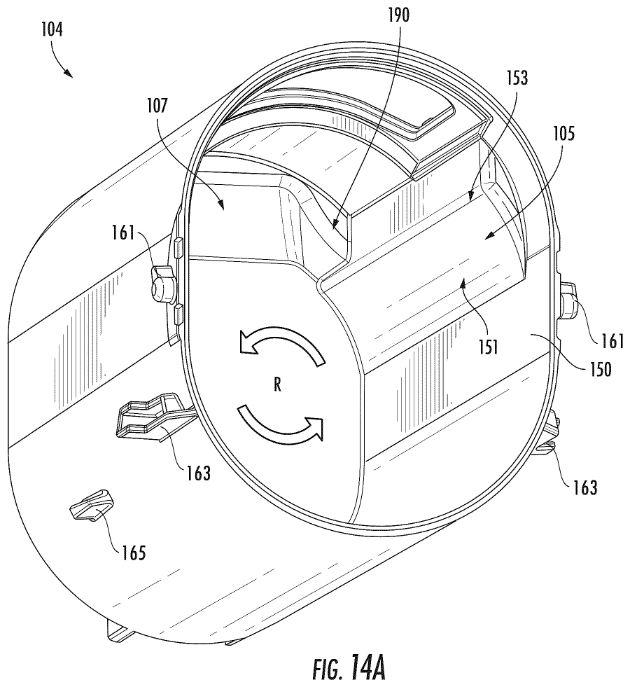

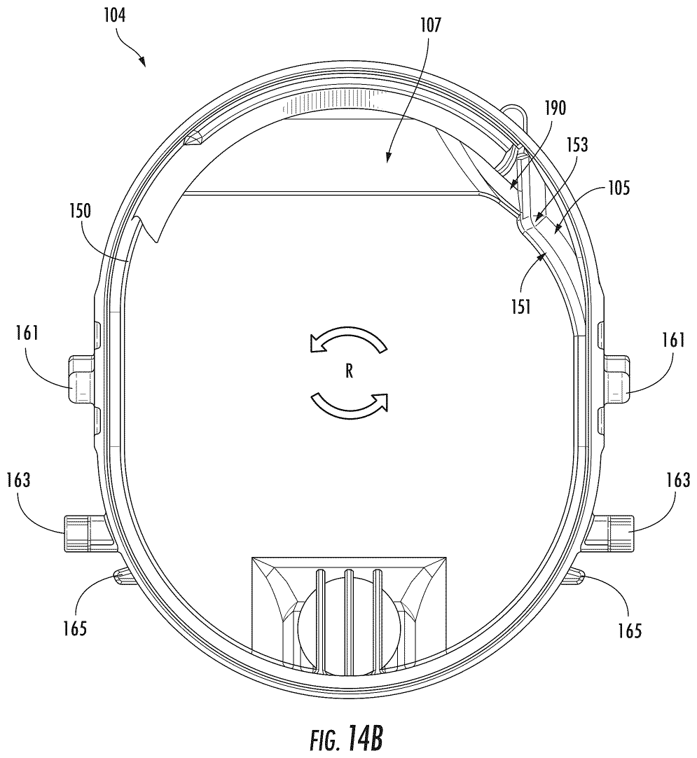

With specific reference to FIGS. 11D, 13A, and 13B, housing 102 may be configured to interact with mixing vessel 104 to guide alignment of mixing vessel 104 and further secure mixing vessel 104 on drink maker 100. For example, housing 102 may include upper edge 167, on which a protrusion of mixing vessel 104 (see, e.g., second protrusion 163 in FIGS. 14A-14C) may rest and/or slide, to assist with the alignment of mixing vessel 104 as mixing vessel 104 is engaging with housing 102 to be secured in an engaged position. By way of further example, housing 102 may include slot 169 (shown in FIGS. 11D and 13A), into which a protrusion of mixing vessel 104 (see, e.g., third protrusion 165 in FIGS. 14A-14C) may be inserted, to further secure mixing vessel 104 to housing 102.

With specific reference to FIGS. 1, 13A, and 13B, liquid runoff from mixing vessel 104 may pass through a channel (e.g., a gap) created by the arrangement of mixing vessel 104 resting on housing 102. For example, drink maker 100 may include a channel 131 defined between an outer surface of mixing vessel 104 and upper edge 167 of housing 102, wherein channel 131 is configured to allow the liquid runoff to pass through channel 131 and into collection tray 220. By spacing an outer surface of mixing vessel 104 apart from upper edge 167 of housing 102, liquid runoff from mixing vessel 104 may pass easily along the outer surface of mixing vessel 104, through channel 131, and collect below mixing vessel 104 to drip into collection tray 220.

Referring now to FIGS. 14A-14C, shown are views of mixing vessel 104 with at least one internal baffle configured to control (e.g., promote, encourage, improve) slush flow within mixing vessel 104. As shown in FIGS. 14A and 14B (as well as FIGS. 13A and 13B), mixing vessel 104 may include side baffle 105 extending laterally along sidewall 150 of vessel chamber 103. In some non-limiting embodiments or aspects, side baffle 105 may extend from the front of vessel chamber 103 (or approximate thereto) to and/or toward the rear of vessel chamber 103 (or approximate thereto). In some non-limiting embodiments or aspects, side baffle 105 may extend along the chamber sidewall in a direction parallel to the axis (A) of dasher 204. In some non-limiting embodiments or aspects, side baffle 105 may be positioned on a left side (when viewed from the front) of the chamber sidewall (e.g., in embodiments in which dasher 204 rotates in a clockwise direction). FIGS. 14A and 14B illustrate a counter-clockwise direction of dasher rotation (R) when viewed from a rear of mixing vessel 104 (e.g., clockwise when viewed from a front of mixing vessel 104). Side baffle 105 may be positioned slightly above the axis (A) of dasher 204, in some non-limiting embodiments or aspects.

Side baffle 105 may include curved surface 151 that conforms to the pathway of dasher 204, as shown in FIGS. 14A and 14B. For example, when viewed along the axis (A) of dasher 204, side baffle 105 may protrude inwardly relative the cross-section (e.g., ovular, elliptical, cylindrical, stadium, rounded) cross-section of chamber sidewall 150, where, starting from a bottom end of side baffle 105 at which curved surface 151 of side baffle 105 is vertical or substantially vertical, curved surface 151 may slope gradually inward until reaching an inflection point 153. After reaching inflection point 153, curved surface 151 may slope more sharply vertically until the top end of side baffle 105 is reached and, thereafter, curved surface 151 of side baffle 105 may return to a curvature in conformance with the cross-section of chamber sidewall 150. The radial direction of curved surface 151 of side baffle 105 from its bottom to inflection point 153 may be generally aligned with the radial movement of dasher 204 and thus the contents of mixing vessel 104. The cross-sectional geometry of side baffle 105 described above may direct the contents of mixing vessel 104 away from a top of vessel chamber 103 (e.g., at a lower radial trajectory than if side baffle 105 was not present, such as the right side of vessel chamber 103 as shown in FIG. 13B). If side baffle 105 was not present, contents of vessel chamber 103 may flow unimpeded up sidewall 150 to a top interior surface of vessel chamber 103, which would leave these contents excluded from mixing and/or allow them to escape from mixing vessel 104. Side baffle 105, thus, may reduce the amount of frozen material that may otherwise form on the top interior surface of mixing vessel 104 as a result of its contents being rotated upwards.

As shown in FIGS. 13B, 13C, and 14A-14C, mixing vessel 104 may include front baffle 107. If present, front baffle 107 may be positioned at a front top portion of vessel chamber 103 (illustrated in FIG. 13B). In some non-limiting embodiments or aspects, front baffle 107 may extend along the front face of vessel chamber 103 between the right sidewall and the left sidewall of vessel chamber 103. The rotation of dasher 204 may push vessel contents towards the front of vessel chamber 103, where, if left unchecked, contents may build up near the top front, perhaps even creating a frozen mass detrimental to the mixing process. Viewed from the cross-section of FIG. 13C, front baffle 107 may form an angle relative the front face of vessel chamber 103 (e.g., 100°-150°, 100°-125°, or 105°-120°), which may redirect vessel contents that have been forced into the top front of mixing vessel 104 towards the rear of vessel chamber 103. In some non-limiting embodiments or aspects, front baffle 107 may include a curved surface extending upwardly from the front face of vessel chamber 103 toward a top of vessel chamber 103. In some non-limiting embodiments or aspects, the angle of front baffle 107 formed relative to the front face of vessel chamber 103 may vary from a lower angle (e.g., 5°-20°) at a section of front baffle 107 proximate to the front face of vessel chamber 103 to a higher angle (e.g., 75°-90°) at a section of front baffle 107 proximate to the top of vessel chamber 103.

Front baffle 107 may be configured to urge contents away from the top surface of vessel chamber 103 to avoid buildup and overflow on the top of mixing vessel 104. Front baffle 107, thus, may reduce the amount of frozen material that may otherwise form on the top front interior surface of mixing vessel 104 as a result of the action of dasher 204.

As shown in FIGS. 13C and 14A-14C, mixing vessel 104 may include a corner baffle 190. Corner baffle 190 may be positioned at a front top side of vessel chamber 103. Corner baffle 190 may join or connect side baffle 105 and front baffle 107. Thus, if side baffle 105, front baffle 107, and corner baffle 190 are each present, corner baffle 190 may physically join side baffle 105 to front baffle 107. As shown in FIGS. 14A and 14B, side baffle 105 and front baffle 107 may be orthogonal to each other, and if these baffles terminate in a hard corner without corner baffle 190, slush may not be optimally directed. Connecting side baffle 105 and front baffle 107 with corner baffle 190 may allow slush to easily flow out of the corner between side baffle 105 and front baffle 107.

Corner baffle 190 may have curved surface 155 that extends from side baffle 105 to front baffle 107. Curved surface 155 may be convex, as shown in FIG. 14A. Along its length, corner baffle 190 may extend into vessel chamber 103 at a relatively constant distance. In other words, the depth of corner baffle 190 may be relatively constant along the length of corner baffle 190. The side of vessel chamber 103 in which corner baffle 190 is positioned (e.g., the left side or the right side) may be selected based on the direction in which dasher 204 rotates within mixing vessel 104. In particular, corner baffle 190 may be positioned such that drink product moved by dasher 204 is directed toward corner baffle 190 while moving upwardly within vessel chamber 103. For example, in some non-limiting embodiments or aspects, corner baffle 190 may be positioned at the left top front of vessel chamber 103 when dasher 204 is arranged to rotate in a clockwise direction (as viewed from a front of mixing vessel 104). This positioning may advantageously force slush downward toward dasher 204 (e.g., away from a top and/or corner of mixing vessel 104) when it contacts corner baffle 190 as the slush moves upwardly with dasher 204, thereby reducing slush buildup on the sidewall and the top of mixing vessel 104.

It will be understood that, in some non-limiting embodiments or aspects, the disclosed mixing vessel 104 may include one, two, three, or more internal baffles positioned within vessel chamber 103. In other words, mixing vessel 104 may include side baffle 105, front baffle 107, and/or corner baffle 190. Side baffle 105, front baffle 107, and/or corner baffle 190 may reduce slush buildup on the sidewalls and top of vessel chamber 103, which is important for commercial drink makers as well as household drink makers with significantly less headspace than commercial units.

The above-described mixing vessel 104 may include at least one internal baffle (e.g., rib) positioned toward a front of the mixing chamber to optimize slush processing and flow within mixing vessel 104. Mixing vessel 104 may include, one, two, three, or more internal baffles to control slush flow. For example, mixing vessel 104 may include a first baffle (e.g., side baffle 105) extending laterally along a sidewall of the vessel chamber, a second baffle (e.g., front baffle 107) positioned along a front surface of the vessel chamber, and/or a third baffle (e.g., corner baffle 190) positioned at a front top side of the vessel chamber, optionally extending between side baffle 107 and corner baffle 190, if present. In non-limiting embodiments or aspects in which corner baffle 190, side baffle 107, and front baffle 105 are each present, corner baffle 190 may physically join side baffle 107 and front baffle 105. The one or more internal baffles may be arranged to keep slush off of the upper sidewalls and top of the mixing vessel chamber. Without wishing to be bound by theory, embodiments in which the mixing vessel includes side baffle 107, front baffle 105, and corner baffle 190 connecting side baffle 107 and front baffle 105, all three baffles may work in tandem to direct contents within mixing vessel 104 away from the top of mixing vessel 104. In contrast to commercial frozen drink makers with a significant amount of headspace in the mixing chamber, the disclosed mixing vessel 104 may have a much shorter chamber, meaning a shorter distance between the axis of dasher 204 and the top of mixing vessel 104, to ensure the device can fit under a cabinet. The reduced chamber height of household frozen drink makers amplifies the need for precise slush control to keep slush from sticking to the upper sidewalls and top of mixing vessel 104, which can result in poor circulation, non-uniform dispensing, and product waste. Furthermore, the one or more baffles present in the vessel chamber may also deflect slush away from the chamber lid so that the lid does not get forced off, as in some commercial units.

With specific reference to FIGS. 14A-14C, mixing vessel 104 may include one or more protrusions 161, 163, 165 configured to guide, support, and/or affix mixing vessel 104 to drink maker 100 and/or housing 102. For example, mixing vessel 104 may include at least one first protrusion 161 (e.g., protrusions 115a, 155b) configured to engage with a coupling mechanism (e.g., cam 103). By way of further example, when at least one lever 110 is moved from a first position to a second position, the coupling mechanism may cause mixing vessel 104 to be engaged with housing 102 by pulling at least one first protrusion 161 toward housing 102 (e.g., upper housing section 122). Additionally, or alternatively, mixing vessel 104 may include at least one second protrusion 163 configured to engage upper edge 167 of housing 102 and guide mixing vessel 104 into alignment with the coupling mechanism. Additionally, or alternatively, mixing vessel 104 may further include at least one third protrusion 165 configured to be received with a 169 of upper edge 167 of housing 102, to further retain mixing vessel 104 on housing 102. In some non-limiting embodiments or aspects, each of first protrusion 161, second protrusion 163, and third protrusion 165 may be arranged on mixing vessel 104 in pairs, such as on opposing lateral sides of mixing vessel.

Referring now to FIG. 15, shown is a close-up view 1500 of a user interface (e.g., user interface 112), according to some non-limiting embodiments or aspects. According to view 1500, user interface 112 may include power button 1502, drink type indicator panel 1504, manual temperature adjustment and/or temperature offset indicator 1506, manual temperature adjustment interface 1508, drink type control dial 1510, and chill button 1512. A user may turn drink maker 100 on or off using power button 1502. A user may select a drink type to process a type of drink product by turning drink type control dial 1510 until a selected drink type is indicated via drink type indicator panel 1504. The user may select, for example, a slush, cocktail, a frappé, a juice, or a dairy/milkshake drink type. Dial 1510 may also include a push button feature that enables a user to start or stop processing of a drink type by pressing dial 1510. Manual temperature adjustment interface 1508 may include left button 1507 and right button 1509 that enable a user to adjust a temperature within a temperature offset band, such as temperature offset band 1602 depicted in FIG. 16 for a milkshake recipe. A user may select chill button 1512 to initiate a chill program and/or recipe whereby drink maker 100 and/or controller 402 maintains the drink product within mixing vessel 104 at a cool temperature without forming a frozen or semi-frozen drink product. In some non-limiting embodiments or aspects, the same cool temperature may be maintained for any drink type. For example, controller 402 may receive a signal indicative of the selection of chill button 1512, and reduce the temperature to, and maintain the temperature at or near, a predefined temperature (e.g., in a range) that should not result in any drink type freezing. Additionally, or alternatively, controller 402 may receive a signal indicative of the selection of chill button 1512 and a selection of a drink type from drink type control dial 1510, and reduce the temperature to, and maintain the temperature at or near, a predefined temperature (e.g., in a range) defined for that particular drink type (e.g., as specified by a drink type object in memory) that should not result in that drink type freezing.

Referring now to FIG. 16, shown is a graph 1600 of coarse and fine temperature settings associated with processing a drink product, where such temperature settings may be stored as temperature values in memory, according to some non-limiting embodiments or aspects. For example, when a user selects a dairy and/or milkshake recipe and starts a frozen drink processing sequence and/or recipe using dial 1510, controller 402 may control processes of the dairy/milkshake recipe to adjust the temperature of the drink product to coarse temperature setting 1604 at −4 degrees Celsius, shown in graph 1600. A user before, during, or after coarse temperature setting 1604 is reached, may fine tune or adjust the coarse target temperature of the drink type by setting a temperature offset using manual temperature adjustment interface 1508. The user may push left button 1507 to decrease the recipe target temperature in increments of about 0.4 degrees Celsius to about −5.2 degrees Celsius. As the temperature decreases, the thickness and/or amount of frozen drink particles may increase. Hence, manual temperature adjustment indicator 1506 may include a “thickness” label. It will be appreciated that different labels may be used, such as “temperature offset” or “temperature adjust”, and the like.

The user may push right button 1509 to increase the recipe target temperature in increments of about 0.4 degrees Celsius to about −2.8 degrees Celsius. As the temperature increases, the thickness and/or amount of frozen drink particles may decrease. Manual temperature adjustment indicator 1508 may include one or more light indicators that are illuminated in a configuration corresponding to the selected temperature offset. For example, manual temperature adjustment indicator 1508 may have a center light indicator that indicates that a 0 degree Celsius offset is selected (e.g., no offset). Offset indicator 1506 may include light indicators corresponding to each increment of offset selected above or below the coarse setting (e.g., the 0 degree Celsius offset point). FIG. 16 also shows temperature offset and/or manual adjustment bands associated with various types of drink products, such as Milkshake, Frappé, Cocktail, Light, and Traditional. Each of the temperature bands may include a center, coarse, and/or target drink type temperature and user-selectable fine tune offset temperatures above and below the drink type target temperature. In some non-limiting embodiments or aspects, the temperature offset band associated with one recipe is different than that temperature offset band of a different recipe, resulting in the temperature offset increments being different between the different recipes.

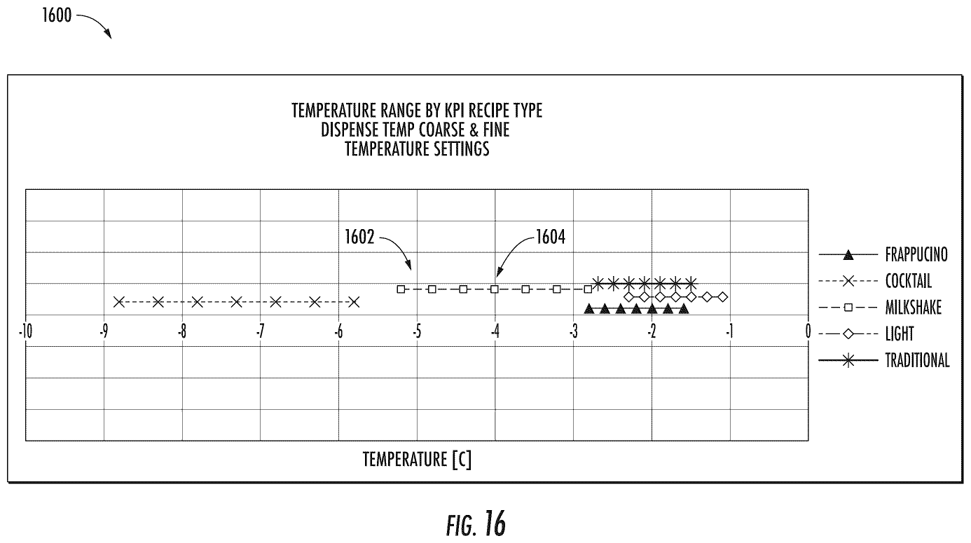

Referring now to FIG. 17, shown is a close-up view 1700 of another user interface (e.g., user interface 112), according to some non-limiting embodiments or aspects. According to view 1700, the user interface may include power button 1708, drink type selector/indicator panel 1702, manual temperature adjustment and/or temperature offset indicator 1706, and manual temperature adjustment dial 1704. A user may turn drink maker 100 on or off using power button 1708. A user may select a drink type to process a type of drink product by pressing a button associated with a selected drink type, e.g., “slush”. The selection of a particular drink type may be indicated by illumination of a light indicator associated with the selected drink type button. For example, FIG. 17 shows that the “slush” drink type has been selected by illumination of the white LED indicator next to the “slush” button. The user may select, for example, a slush drink, spiked slush or cocktail, a frappé, a frozen juice, or a dairy/milkshake drink type. Manual temperature adjustment dial 1704 may be rotated clockwise or counter-clockwise to set the temperature value and/or target temperature setting within a universal range of drink product temperature values. For example, manual temperature adjustment indicator 1706 may include ten temperature values or settings corresponding to target temperatures, such as illustrated in FIG. 18.

Referring now to FIG. 18, shown is a graph 1800 of temperature values associated with automatic recipe temperature target temperatures and manual temperature adjustments, according to some non-limiting embodiments or aspects. Graph 1800 shows temperature values #1 through #10, where setting #1 is at −1.3 degrees Celsius and setting #10 is at −7.2 degree Celsius. The ten temperature settings of graph 1800 may correspond to the ten light indicators of manual temperature adjustment indicator 1706. In operation, when a user selects a drink type, e.g., a “milkshake”, by pressing the corresponding button in drink type selector/indicator panel 1702, the button's adjacent indicator may illuminate. Also, if the coarse or automatic temperature value associated with a milkshake is about −4.0 degrees Celsius, which corresponds the setting #7 in graph 1800, then seven indicators (e.g., light bars) may be illuminated in manual temperature adjustment indicator 1706. The light bars may be dimmed or flash periodically until the target temperature is reached and/or detected by controller 402. The user interface may emit an audible sound, e.g., a beep or beep sequence when a target temperature is reached (e.g., using a speaker thereof). A dimmed or flashing illumination may be changed to a brighter and/or steady illumination when a target temperature is reached. In some non-limiting embodiments or aspects, once a target temperature is reached, controller 402 may cycle compressor 214 on and off to keep a temperature of the drink product within a target temperature range above and/or below the target temperature. For example, the range may be greater than or equal to about 0.2, 0.3, 0.5, or 1.0 degrees Celsius above and below the drink product target temperature. As long as the temperature remains within the target temperature range, controller 402 may not initiate an alert (e.g., audible output) or change in status of any indicators of indicator 1706.

If the user wants to further decrease the target temperature and/or increase the target thickness of the milkshake to setting #10 (shown in FIG. 18), the user may turn dial 1704 until all ten light indicators are illuminated. If the user wants to increase the target temperature to setting #3 of FIG. 18 and/or reduce the target thickness of the milkshake, the user may turn dial 1704 until three indicators bars of indicator 1706 are illuminated, as illustrated in FIG. 17. While FIG. 17 shows an interface using dial 1704 to manually adjust temperature, other types of interfaces may be used, such as, without limitation, up/down buttons, a touch screen, or a slider switch.

FIG. 18 also illustrates how each increment of temperature change between each of the temperature settings #1 to #10 may be nonlinear to account for adequate changes in thickness of a cooled or frozen drink product. As temperature decreases, a larger change in temperature may be required to cause a material or proportional change in the amount of frozen drink particles within, or the thickness of, a drink product. For example, temperature increment 1802 (between settings #4 and #5) may be about 0.6 degrees Celsius, while temperature increment 1804 (between setting #8 and #9), in a lower temperature range, may be about −1.0 degrees Celsius. In some non-limiting embodiments or aspects, the increment of temperature change between settings may be constant, resulting a linear temperature range. While a range including ten temperature values or settings is illustrated in FIGS. 17 and 18, any number of settings and/or temperature ranges may be implemented.

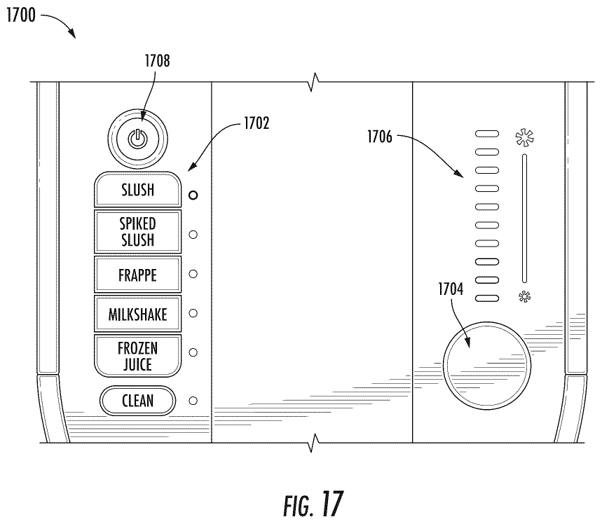

Referring now to FIG. 19, shown is a graph 1900 of drive motor 208 current and temperature of a drink product vs. time as the drink product is being processed by drink maker 100, according to some non-limiting embodiments or aspects. Graph 1900 shows changes in drive motor 208 current 1902 and corresponding drink product temperatures 1904 over time as a drink product is being made. Graph 1900 illustrates how current 1902 applied to drive motor 208 increases as temperature 1904 decreases, causing the thickness of the drink product to increase, which may result in an increased resistance of the drink product to the rotation of dasher 204 which, in turn, may require increased motor power and/or current 1902 to drive dasher 204 against the resistance. When current 1902 (or power, or torque, etc.) reaches or exceeds a threshold or motor condition limit 1906, e.g., about 40 Watts and/or about 0.3 amps current, controller 402 may deactivate the cooling circuit, e.g., stop coolant and/or refrigerant flow to evaporator 202, to allow temperature 1904 to increase and, thereby, reduce the thickness of the drink product to reduce current 1902 of drive motor 208 to below motor condition limit 1906. Controller 402 may automatically adjust the temperature setting associated with a particular drink type, which may have been fine-tuned by a user selection of a manual temperature adjustment and/or temperature offset, to a new temperature setting corresponding to a second target temperature, where the magnitude of current 1902 is lower than motor condition limit 1906. The second target temperature may be set to be, for example, 0.25, 0.5, 0.75, 1, 1.25, 1.5, or 2.0 degrees Celsius above (by a relatively small offset) the initial and/or first target temperature. In this way, controller 402 may prevent an overcurrent condition and possible damage to drive motor 208. This may also enable operation of drink maker 100 and dasher 204 to continue by preventing excessive buildup of ice within mixing vessel 104, e.g., preventing drive motor 208 from stalling. Otherwise, drive motor 208 may stall and drink maker 100 may be jammed up, blocking slush output from mixing vessel 104 and requiring a user to defrost and/or unblock mixing vessel 104 before normal operations can be resumed. Hence, stall prevention may enable drink maker 100 to provide some slush output. Further, an excessive current 1902 or power condition of drive motor 208 caused by an object blocking rotations of dasher 204 may also be prevented. Controller 402 may perform actions in addition to stopping drive motor 208, such as shutting down compressor 214. Graph 1900 also shows how controller 402 may continuously and/or periodically monitor temperature associated with a drink product within mixing vessel 104 via temperature sensor(s) 406 to enable continuous control of components, such as compressor 214, and other components of drink maker 100, to enable automatic control of the temperature of a drink product.

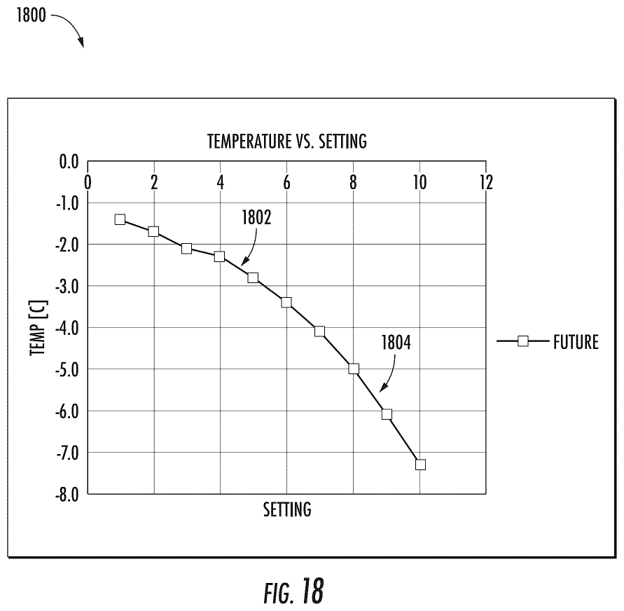

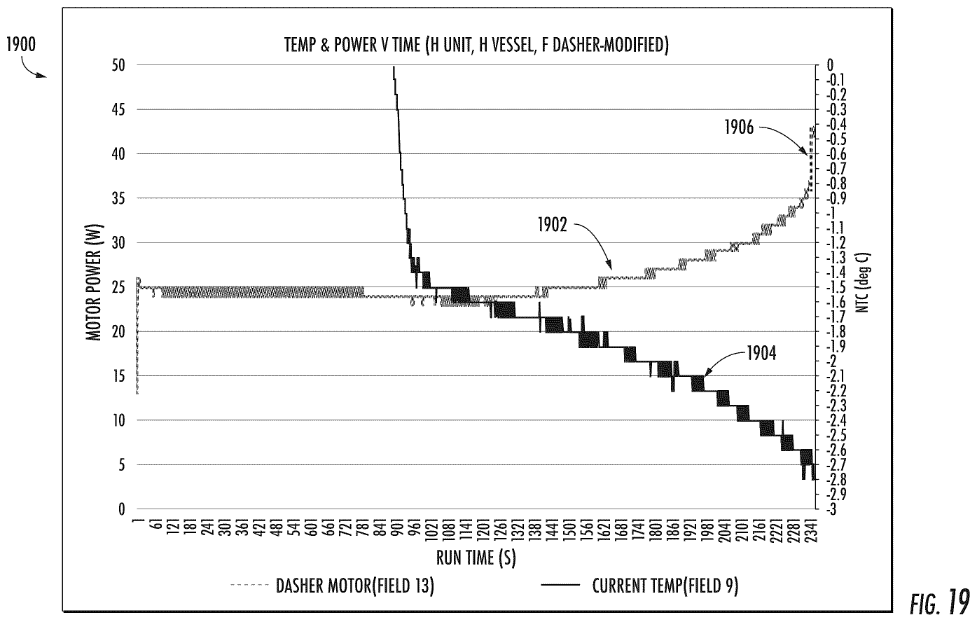

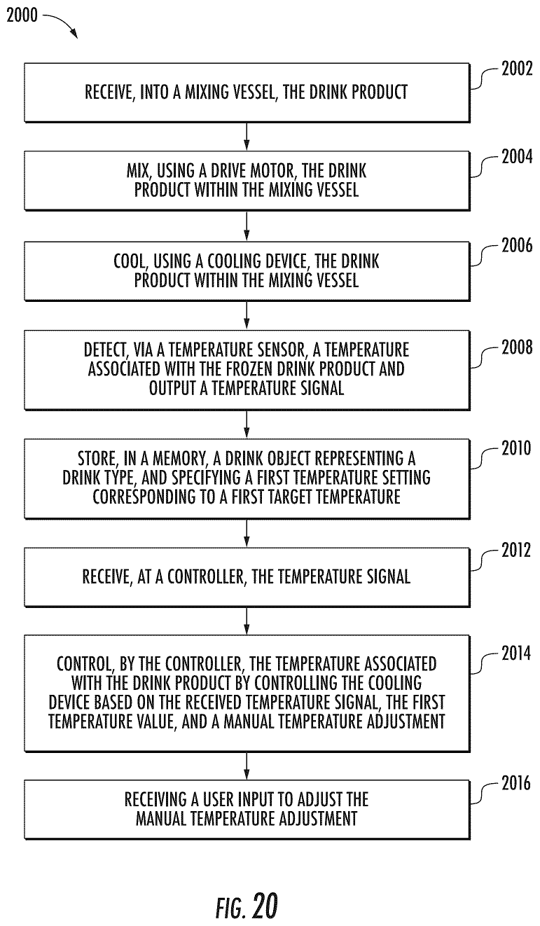

Referring now to FIG. 20, shown is a flow diagram of method 2000 for making a cooled drink product using a recipe for initial or coarse temperature and/or texture control and then using a user input to fine tune the temperature and/or texture of the drink product, according to some non-limiting embodiments or aspects. The steps shown in FIG. 20 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 20, method 2000 may include, at step 2002, receiving, into mixing vessel 104, a drink product.

As shown in FIG. 20, method 2000 may include, at step 2004, mixing, using dasher 204 driven by drive motor 208, the drink product within mixing vessel 104.

As shown in FIG. 20, method 2000 may include, at step 2006, cooling, using a cooling circuit including evaporator 202, the drink product within mixing vessel 104.

As shown in FIG. 20, method 2000 may include, at step 2008, detecting, via temperature sensor(s) 406, a temperature associated with the drink product and outputting a temperature signal.

As shown in FIG. 20, method 2000 may include, at step 2010, storing, in memory 404, a drink object representing a drink type, the drink object specifying a first temperature value and/or setting corresponding to a first target temperature.

As shown in FIG. 20, method 2000 may include, at step 2012, receiving, at controller 402, the temperature signal.

As shown in FIG. 20, method 2000 may include, at step 2014, controlling, by controller 402, the temperature associated with the drink product by controlling the cooling circuit, e.g., by activating or deactivating compressor 214 to initiate or stop refrigerant flow through evaporator 202, based on the received temperature signal, the first temperature value, and/or a manual temperature adjustment.

As shown in FIG. 20, method 2000 may include, at step 2016, receiving a user input to adjust the manual temperature adjustment. In some non-limiting embodiments or aspects, the user input may be indicative of a desired thickness corresponding to the manual temperature adjustment. In some non-limiting embodiments or aspects, the manual adjustment may be customized per drink type. In some non-limiting embodiments or aspects, the manual adjustment is universal for all drink types. In some non-limiting embodiments or aspects, the manual adjustment may be finer and/or for a smaller range specific to a drink type (e.g., corresponding to FIG. 16) and coarser and/or for a larger range not specific to a drink type (e.g., spanning multiple or all drink types, thereby enabling a user greater latitude in adjusting thickness and/or temperature).

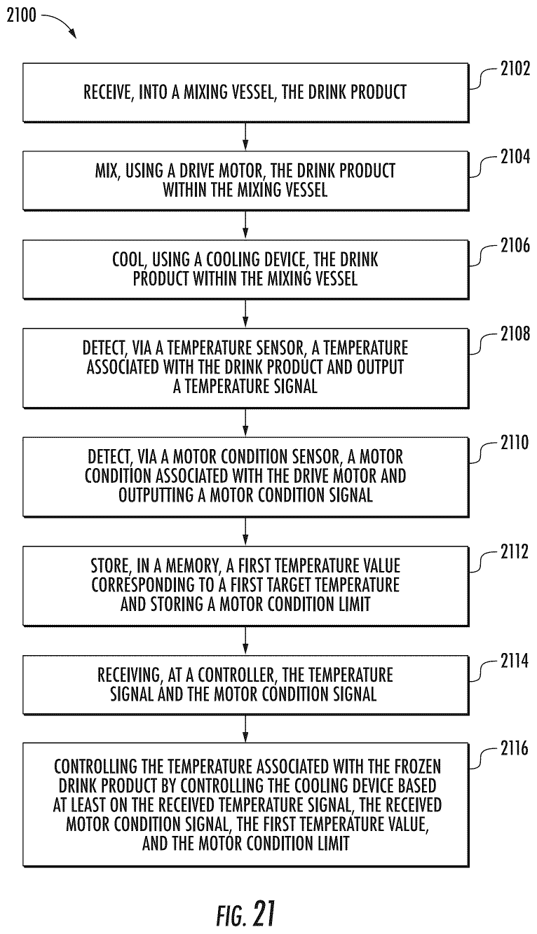

Referring now to FIG. 21, shown is a flow diagram of method 2100 for automatically detecting when drive motor current is too high and/or a drink product is too thick and, in response, adjusting the temperature of the drink product to reduce drive motor current and/or to increase the temperature of the drink product to reduce a thickness of the drink product, according to some non-limiting embodiments or aspects. The steps shown in FIG. 21 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 21, method 2100 may include, at step 2102, receiving, in mixing vessel 104, the drink product.

As shown in FIG. 21, method 2100 may include, at step 2104, mixing, using dasher 204 driven by drive motor 208, the drink product within mixing vessel 104.

As shown in FIG. 21, method 2100 may include, at step 2106, cooling, using a cooling circuit including evaporator 202, the drink product within mixing vessel 104.

As shown in FIG. 21, method 2100 may include, at step 2108, detecting, via temperature sensor(s) 406, a temperature associated with the drink product and outputting a temperature signal.

As shown in FIG. 21, method 2100 may include, at step 2110, detecting, via motor condition sensor(s) 406, a motor condition associated with drive motor 208 and outputting a motor condition signal.

As shown in FIG. 21, method 2100 may include, at step 2112, storing, in memory 404, a first temperature value corresponding to a first target temperature and storing a motor condition limit.

As shown in FIG. 21, method 2100 may include, at step 2114, receiving, at controller 402, the temperature signal and the motor condition signal.

As shown in FIG. 21, method 2100 may include, at step 2116, controlling the temperature associated with the drink product by controlling the cooling circuit, e.g., by activating or deactivating compressor 214 to initiate or stop the refrigerant flow through evaporator 202, based at least on the received temperature signal, the received motor condition signal, the first temperature setting, and the motor condition limit.

In some non-limiting embodiments or aspects, controller 402 may stop and/or deactivate drive motor 208 to stop rotation of dasher 204 when the motor condition signal exceeds a motor knockdown threshold, e.g., the motor current or power is too high and/or high enough to damage drive motor 208, which may be caused by an excessive build-up of ice within mixing vessel 104. Excessive ice build-up may be caused, for example, by filling mixing vessel 104 with only water, a liquid predominantly consisting of water, a liquid with insufficient sugar and/or alcohol content, and/or the like. Shutdown of drive motor 208 may also prevent damage to dasher 204 caused by excessive build-up of hard ice. Additionally, or alternatively, controller 402 may perform actions such as issuing an alert, via user interface 112, to a user to add more ingredients (e.g., ingredients including sugar or alcohol) to the drink product or issuing an alert to the user to turn off drink maker 100. A different motor shutdown threshold for drive motor 208 may be set higher than the motor knockdown threshold limit. In this way, controller 402 may attempt to increase temperature in mixing vessel 104 when a motor knockdown threshold limit is reached, but only shut down and/or stop drive motor 208 when a motor shutdown threshold is reached to prevent damage to drive motor 208. Controller 402 may take action based on determining whether the motor knockdown threshold limit or the motor shutdown limit has been reached or exceeded for a period of time, e.g., 0.5, 1.0, 1.5, 2.0, 5 seconds or more. By observing motor current and/or power for a period of time, a false positive and/or reading of current and/or power may be eliminated.

Referring now to FIG. 22A, shown is dual-use cooling fan 2202 within a housing (e.g., housing 102) of drink maker 2200 (e.g., drink maker 100) including a refrigeration system (e.g., cooling circuit) having condenser 2208 (e.g., condenser 216) and compressor 2210 (e.g., compressor 214). Drink maker 2200 may also include drive motor 2204 (e.g., drive motor 208) configured to drive rotation of dasher 2212 (e.g., dasher 204) during processing of a drink product. Dual-use cooling fan 2202 may draw an air flow through condenser 2208 and directs the air flow, via air channel 2206, toward drive motor 2204. The air flow may pass over and adjacent to condenser coils as it passes through condenser 2208 to cool the refrigerant passing through condenser 2208 within a closed loop refrigeration system. The air flow may also pass along a surface and/or surfaces of drive motor 2204 to effect cooling of drive motor 2204. While FIG. 22A shows a configuration where drive motor 2204 and condenser 2208 are positioned at about right angles with respect to dual-use cooling fan 2202, other configurations, arrangements, or orientations may be implemented such that dual-use cooling fan 2202 may provide a cooling air flow to condenser 2208 and drive motor 2204.

In some non-limiting embodiments or aspects, drink maker 2200 may include a mixing vessel (e.g., mixing vessel 104) arranged to receive a drink product. Drink maker 2200 may include a mixing component such as dasher 2212 or another type of mixing component, driven by drive motor 2204, that is arranged to mix the drink product within mixing vessel 104. A refrigeration system may be arranged to cool the drink product within mixing vessel 104 that includes a condenser, such as condenser 2208. Cooling fan 2202, e.g., a dual-use cooling fan, may be configured to concurrently cool drive motor 2204 and condenser 2208. Cooling fan 2202 may provide air flow through condenser 2208 to cool refrigerant flowing through condenser 2208. Cooling fan 2202 may provide air flow along a surface of drive motor 2204 to cool drive motor 2204. Cooling fan 2202, drive motor 2204, and condenser 2208 may be positioned such that air generated by cooling fan 2202 passes serially through condenser 2208 and along a surface of drive motor 2204.

A first portion of air generated by cooling fan 2202 may cool condenser 2208 and a second portion of air generated by cooling fan 2202 may cool drive motor 2204. Condenser 2208 may include a plurality of coils that carry coolant and/or refrigerant within a closed loop of the refrigeration circuit. When cooling fan 2202 provides air flow through condenser 2208 to cool refrigerant flowing through condenser 2208, the air flow may travel adjacent to and/or around the plurality of coils. Cooling channel 2206 may extend between cooling fan 2202 and drive motor 2204 where cooling channel 2206 may provide cooling air flow between cooling fan 2202 and drive motor 2204. Cooling channel 2206 may be at least partially formed by a duct and/or ducting. The ducting may include plastic, metals, composite materials, and the like. A cooling channel may extend between cooling fan 2202 and condenser 2208, where the cooling channel provides cooling air flow between cooling fan 2202 and condenser 2208. The cooling channel may be at least partially formed by a duct. Cooling fan 2202 may include a centrifugal fan, a cross-flow fan, a tangential fan, a volute fan, a backward curved fan, a forward curved fan, a blower fan, a squirrel-cage fan, and/or an axial fan.

In some non-limiting embodiments or aspects, a cooling fan, such as cooling fan 2202, may be configured for cooling a drive motor, such as drive motor 2204, and a condenser, such as condenser 2208, within a housing of drink maker 2200. Cooling fan 2202 may include an air inlet configured to receive an air flow, an impeller configured to generate the air flow, and an air outlet configured to output the air flow through condenser 2208 and along a surface of drive motor 2204. In some non-limiting embodiments or aspects, air flow generated by cooling fan 2202 may pass in parallel through condenser 2208 and along a surface of drive motor 2204 such that a first portion of the air flow passes through condenser 2208, while a second portion of the air flow passes along a surface of drive motor 2204. Condenser 2208 may include one or more coils wound in a serpentine arrangement. Each of the one or more coils may include a plurality of thermal transfer fins. When cooling fan 2202 provides air flow through condenser 2208 to cool refrigerant flowing through condenser 2208, the air flow may travel adjacent to and/or around the plurality of coils. Cooling fan 2202 may include a centrifugal fan, a cross-flow fan, a tangential fan, a volute fan, a backward curved fan, a forward curved fan, a blower fan, a squirrel-cage fan, and/or an axial fan. User selection of a recipe and/or computer program in user interface 112 may cause, by controller 402, automatic activation of drive motor 2204, compressor 2210, and cooling fan 2202.

Referring now to FIG. 22B, shown is a view of dual-use cooling fan 2222, according to some non-limiting embodiments or aspects. Cooling fan 2222 may be positioned within the housing of drink maker 2220 (e.g., drink maker 1000. Drink maker 2220 may further include including drive motor 2224 (e.g., drive motor 208), dasher 2226 (e.g., dasher 204), compressor 2230 (e.g., compressor 214), and condenser 2228 (e.g., condenser 216). Drive motor 2224 may be coupled to and drive rotation of dasher 2226 and may also drive rotation of cooling fan 2222 via gears 2237. Cooling fan 2222 may include air outlet 2238 that directs air flow from cooling fan 2222 through air channel 2232, which may include ducting 2234 that directs air flow through condenser 2228 to cool refrigerant flowing through condenser 2228.

Referring now to FIG. 22C, shown is a perspective view 2240 of dual-use cooling fan 2222 within housing 2242 of drink maker 2220. Cooling fan 2222 may be a centrifugal fan and/or another type of fan as described herein. Cooling fan 2222 may include impeller 2244 that draws air flow into cooling fan 2222 via inlet 2236 and then expels air downward at about a right angle via outlet 2238 with respect to inlet 2236. The air flow exiting outlet 2238 may flow downward past drive motor 2224, including along a surface of drive motor 2224, and through air channel 2232, which may include ducting 2234 that directs the air flow through condenser 2228 (adjacent to and/or around coils of condenser 2228) to effect cooling of refrigerant passing through the coils.

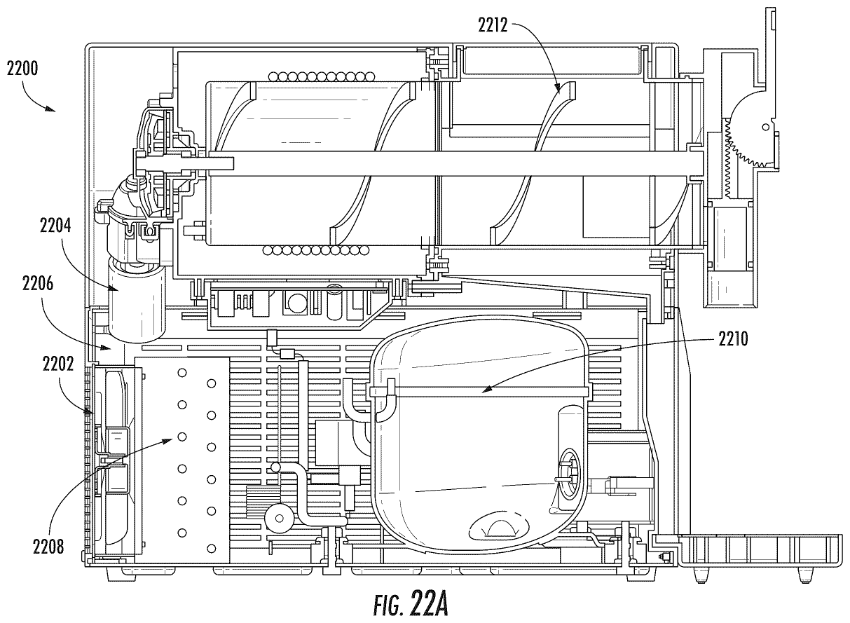

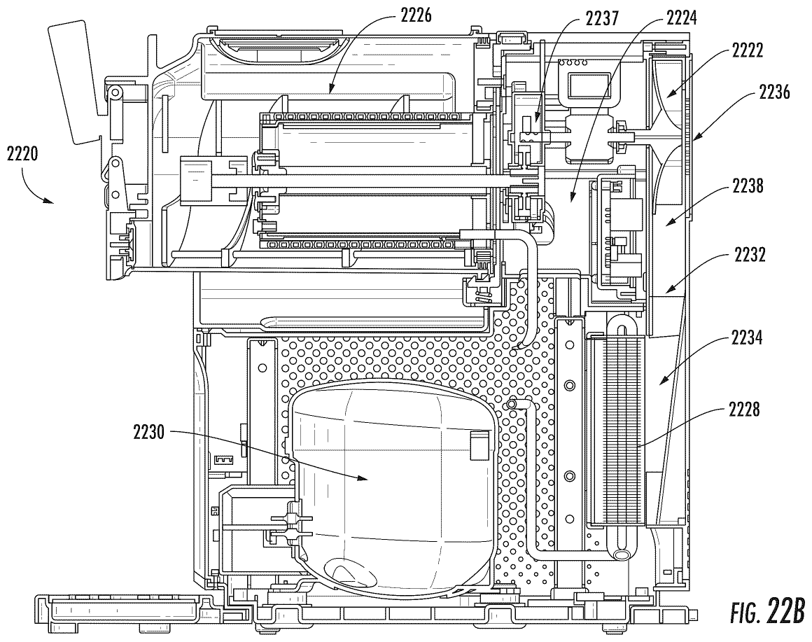

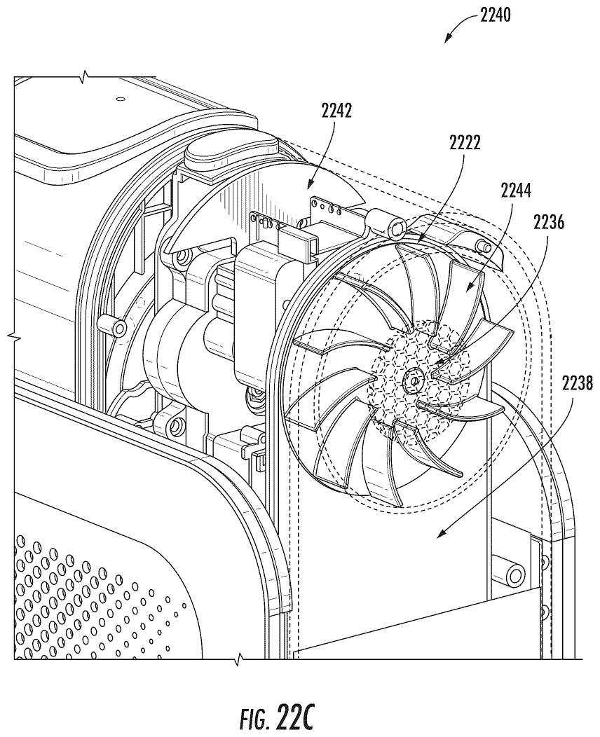

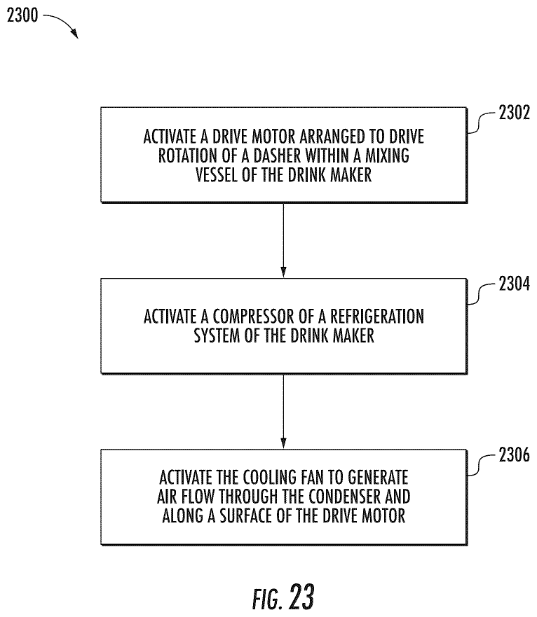

Referring now to FIG. 23, shown is a flow diagram of a method 2300 for operating dual-use cooling fan 2202, 2222 (see FIGS. 22A and 22B, respectively), according to some non-limiting embodiments or aspects. Method 2300 may facilitate concurrently cooling condenser 2208, 2228 and drive motor 2204, 2224 within a housing of a drink maker (e.g., drink maker 100) using cooling fan 2202, 2222. The steps shown in FIG. 23 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 23, method 2300 may include, at step 2302, activating drive motor 2204, 2224 that is arranged to drive rotation of dasher 2212, 2226 within a mixing vessel (e.g., mixing vessel 104) of a drink maker.

As shown in FIG. 23, method 2300 may include, at step 2304, activating compressor 2210, 2230 of a refrigeration circuit of the drink maker.

As shown in FIG. 23, method 2300 may include, at step 2306, activating cooling fan 2202, 2222 to concurrently generate air flow through condenser 2208, 2228 and along a surface of drive motor 2204, 2224.

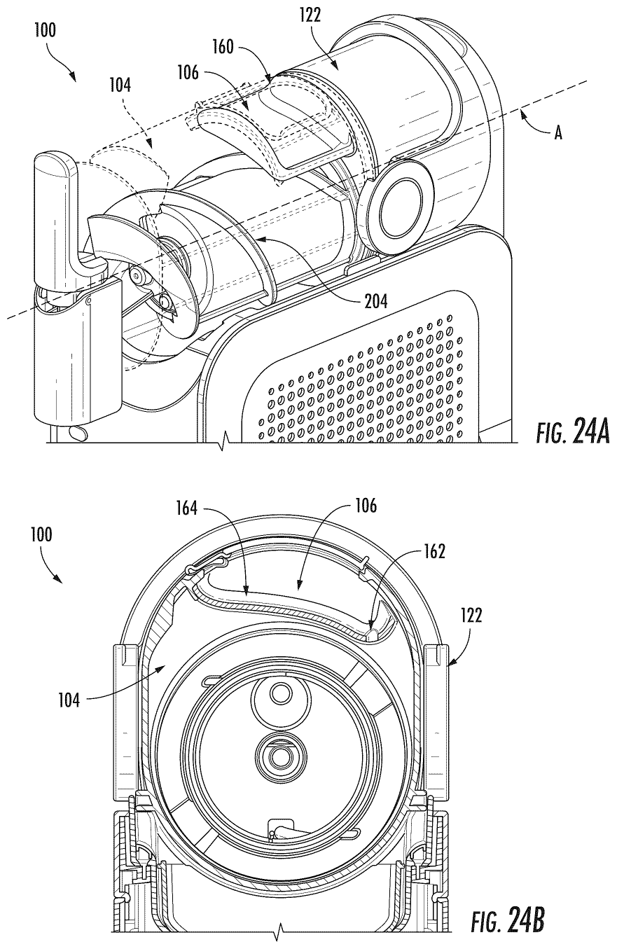

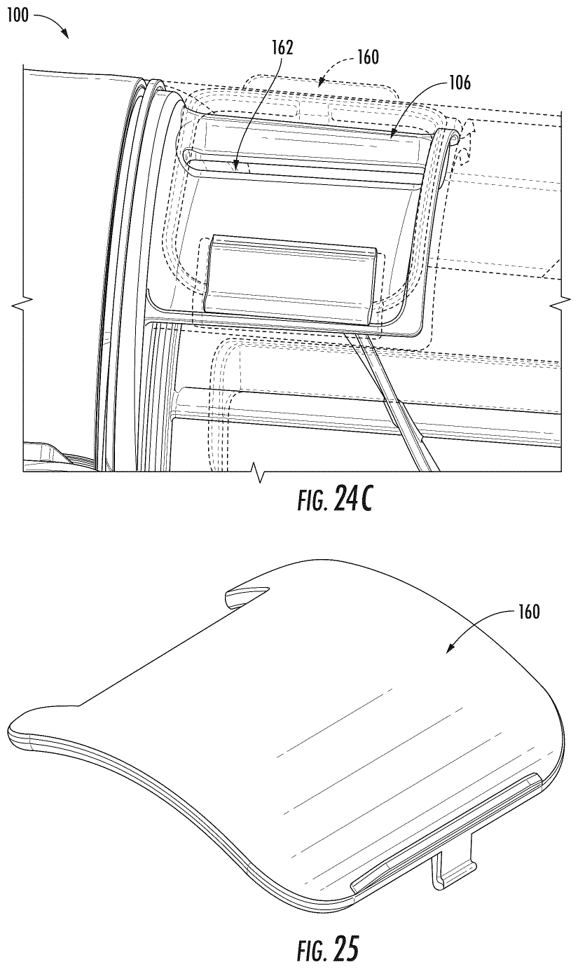

Referring now to FIGS. 24A-24C, shown are views of pour-in-opening 106 for drink maker 100, according to some non-limiting embodiments or aspects. As previously mentioned, drink maker 100 may include pour-in opening 106 through which mixing vessel 104 may receive ingredients to be mixed to produce a drink product. Drink maker 100 may include mixing vessel 104 with an at least partly cylindrical chamber and housing 102 with upper housing section 122. FIG. 24A shows a perspective side view of pour-in opening 106. FIG. 24B shows a front view of pour-in opening 106 of FIG. 24A, and FIG. 24C shows a perspective view of pour-in opening 106 of FIG. 24A from the left side of mixing vessel 104 (when viewed from the front of mixing vessel 104). Pour-in opening 106 may facilitate the addition of fluids, liquids, slush, or other ingredients to mixing vessel 104 while dasher 204 is active as well as minimizing spillage and preventing finger insertion during use.

In some non-limiting embodiments or aspects, pour-in opening 106 may include cover 160 to seal pour-in opening 106, as shown in FIGS. 24A and 24C. A detailed perspective view of an example cover 160 for pour-in opening 106 is shown in FIG. 25. If present, cover 160 may be hingedly connected to an upper section of mixing vessel 104. Cover 160 may be moved between an open position in which pour-in opening 106 is accessible to a user and a closed position in which pour-in opening 106 is not accessible to a user. Although not illustrated in the accompanying figures, pour-in opening 106 may also include a grate to restrict objects from entering aperture 162. If present, a grate may reduce the risk of solids greater than a certain size and/or having one or more certain shapes entering mixing vessel 104, which may cause damage or harm to the user.

It will be appreciated that pour-in opening 106 allows liquid ingredients to be added to mixing vessel 104 in a controlled manner, thereby minimizing or preventing slush overflow. The disclosed pour-in opening 106 may be used with both commercial drink makers or residential drink makers having a smaller vessel capacity and less available headspace than commercial units. Pour-in opening 106 advantageously avoids external splatter and spillage of liquid ingredients as they are added to mixing vessel 104 and prevents finger insertion (to protect users from moving componentry within mixing vessel 104). Pour-in opening 106 also prevents slush contained within mixing vessel 104 from being pushed out of mixing vessel 104.

Referring now to FIG. 26, shown is a perspective view of pour-in opening 106, according to some non-limiting embodiments or aspects. Pour-in opening 106 may include surface 164 that inclines radially with respect to an axis of dasher 204 (e.g., a center axis, shown as axis “A” in FIG. 24A). Surface 164 may reduce possible splashing as mixing vessel 104 is filled. Surface 164 may also prevent drink product (e.g., in slush form) contained within mixing vessel 104 from being pushed out of pour-in opening 106. Surface 164 may have an aperture 162. Although FIG. 26 shows only one aperture 162, additional apertures may also be present. Aperture 162 may be in fluid communication with an interior chamber of mixing vessel 104. In some non-limiting embodiments or aspects, aperture 162 may extend laterally along surface 164 in a direction parallel to axis “A” of dasher 204. Aperture 162 may be shaped as a slot, as shown in FIG. 26, or may have a different shape. If shaped as a slot, aperture 162 may be longer or wider than shown in FIGS. 24A-24C and/or may have a different ratio of length to width than shown. Further, aperture 162, as a slot or another oblong shape, may have its major axis aligned parallel or perpendicular to the axis of mixing vessel 104, or at any other angle relative to the axis of mixing vessel 104. Aperture 162, for example, in the form of a slot, may be sized small enough (at least in width) to not allow passage of a human finger, at least not the entire length of a human finger, to thereby prevent a user from sticking one or more fingers into mixing vessel 104.

Pour-in opening 106 may optionally include one or more lips 166a, 166b extending up from a perimeter of surface 164 to form a well that feeds into aperture 162, as shown in FIG. 26. One or more lips 166a, 166b may reduce overflow spill when a liquid is poured into mixing vessel 104. If desired, pour-in opening 106 may also include a grate (not illustrated) covering at least a portion of aperture 162. For safety concerns, users should not contact dasher 204 while it is rotating. The geometry of pour-in opening 106 (including aperture 162 as described above) may inhibit or prevent a user from reaching into mixing vessel 104 even when cover 160 is in an open position and/or dasher 204 is rotating.

Pour-in opening 106 may be positioned on a top of mixing vessel 104, near its rear end, as shown in FIGS. 24A-24C, opposite dispenser assembly 108. Positioning pour-in opening 106 near the rear of mixing vessel 104 may avoid interference with slush circulation in the front of drink maker 100, which may lead to waste and non-homogeneous texture. With pour-in opening 106 positioned at the rear of mixing vessel 104, the front two-thirds of mixing vessel 104 may have a continuous and smooth internal shape to provide good slush flow and minimize migration of the slush out of the top. By positioning pour-in opening 106 near the rear of mixing vessel 104, pour-in opening 106 may be located in a position where there is less possible buildup of frozen and/or slush materials, enabling less obstructed pouring and reducing possible build-up of ice and/or slush material at pour-in opening 106 during processing.

Surface 164 of pour-in opening 106 may be sloped to direct incoming ingredients to enter mixing vessel 104 in an entry direction, which may be the same as the direction of dasher 204 rotation. This may prevent the rotating frozen mixture from exiting mixing vessel 104 through pour-in opening 106. In some non-limiting embodiments or aspects, when dasher 204 is rotating in a clockwise direction when viewed from the front of drink maker 100, pour-in opening 106 may be positioned on the right side of mixing vessel 104. Aperture 162 may be positioned to extend laterally along surface 164 in a direction parallel to the axis “A” of dasher 204, whereas in other non-limiting embodiments or aspects, when dasher 204 is rotating in a counter-clockwise direction when viewed from the front of drink maker 100, pour-in opening 106 may be positioned on the left side of mixing vessel 104.

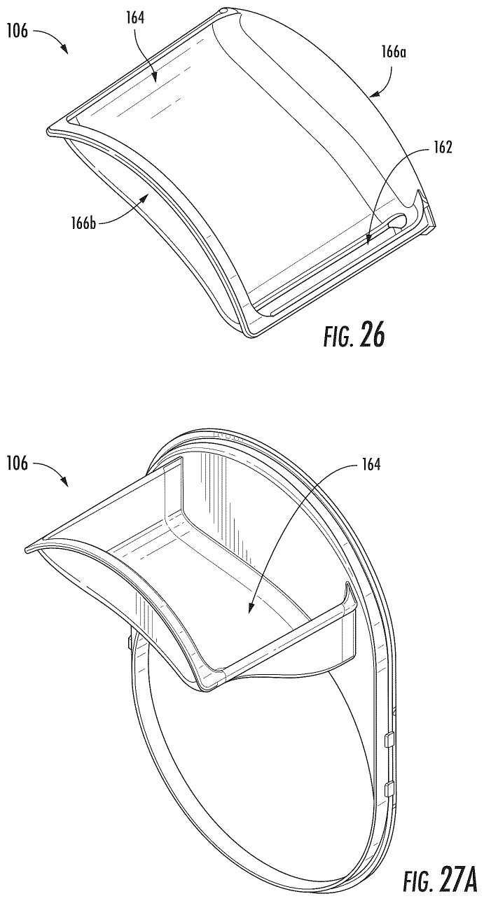

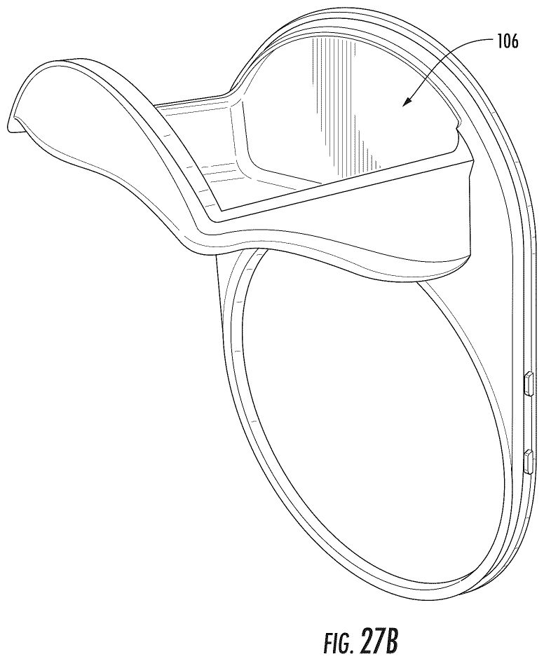

Referring now to FIGS. 27A-27D, shown are views of pour-in opening 106 in which surface 164 of pour-in opening 106 is shaped to slope downwardly toward a rear of mixing vessel 104, according to some non-limiting embodiments or aspects. In some non-limiting embodiments or aspects, one or more apertures 162 may be positioned at a bottom portion of surface 164. Shaping surface 164 may include a rearward slope to increase the volume capacity of pour-in opening 106 and reduce spillage. In some non-limiting embodiments or aspects, in which surface 164 of pour-in opening 106 is sloped relative to the axis “A” of dasher 204, surface 164 may be shaped such that a section of surface 164 closest to a front of mixing vessel 104 is positioned farther away from the axis “A” of dasher 204 than a section of surface 164 closest to a rear of mixing vessel 104.

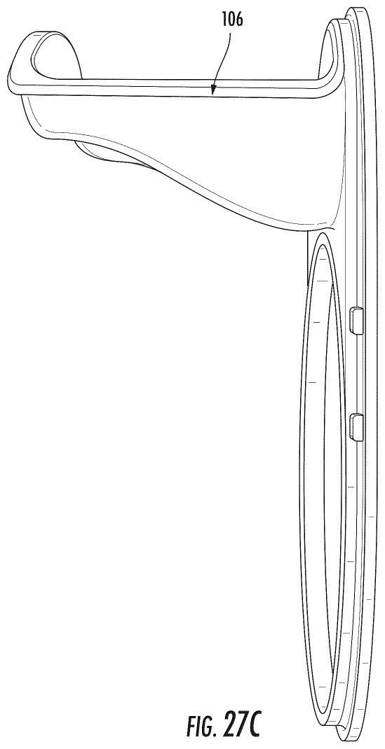

Referring now to FIG. 28, shown is a flow diagram of method 2800 of using pour-in opening 106 for drink maker 100, according to some non-limiting embodiments or aspects. The steps shown in FIG. 28 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 28, method 2800 may include, at step 2802, optionally opening a cover of drink maker 100 to provide access to pour-in opening 106.

As shown in FIG. 28, method 2800 may include, at step 2804, introducing one or more liquid ingredients to mixing vessel 104 of drink maker 100 via pour-in opening 106. In some non-limiting embodiments or aspects, the one or more liquid ingredients may be added to mixing vessel 104 while mixing vessel 104 is actively mixing (e.g., while dasher 204 is rotating).

As shown in FIG. 28, method 2800 may include, at step 2806, dispensing a drink product from drink maker 100. In some non-limiting embodiments or aspects, the drink product may be dispensed while dasher 204 is rotating, which may further encourage movement of drink product toward a front of mixing vessel 104.

Referring now to FIGS. 29A-29D, shown is a view of dispenser assembly 2900 (e.g., dispenser assembly 108) for dispensing a drink product from drink maker 100, according to some non-limiting embodiments or aspects. As shown in FIG. 29A, dispenser assembly 2900 may include dispenser housing 2904 for housing the component parts of dispenser assembly 2900. Housing 2904 may have first portion 2904a attached to an outer surface of drink maker 100 adjacent to spout 2902 and second portion 2904b spaced apart from spout 2902 and extending outward from the outer surface. In some non-limiting embodiments or aspects, housing 2904 may have an inverted L-shape. However, the disclosure contemplates other suitable shapes of housing 2904. Handle 120 of drink maker 100 may have upper portion 120a in the form of user-actuatable lever 2906 and lower portion 120b attached to second portion 2904b of housing 2904.

As shown in FIGS. 29B and 29C, lever 2906 may be rotatable relative to second portion 2904b of housing 2904 about first pivot member 2908. In some non-limiting embodiments or aspects, first pivot member 2908 may be rod or pin 2910 extending through second portion 2904b of housing 2904 and lower portion 120b of handle 120. However, the disclosure contemplates other suitable types of pivot members 2908. Link member 2912 may operatively couple to lower portion 120b of handle 120. In some non-limiting embodiments or aspects, link member 2912 may be insertable into lower portion 120b of handle 120. Link member 2912 may be rotatable relative to lever 2906 about second pivot member 2914. In some non-limiting embodiments or aspects, second pivot member 2914 may be rod or pin 2916 extending through link member 2912 and through lower portion 120b of handle 120. However, the disclosure contemplates other suitable types of pivot members 2916. Bracket member 2918 may operatively couple to link member 2912 and may be attached to first portion 2904a of housing 2904. In some non-limiting embodiments or aspects, link member 2912 may be insertable into a portion of bracket member 2918. Bracket member 2918 may be rotatable relative to link member 2912 about third pivot member 2920. In some non-limiting embodiments or aspects, third pivot member 2920 may be rod or pin 2922 extending through bracket member 2918 and link member 2912. However, the disclosure contemplates other suitable types of pivot members 2920. Bracket member 2918 may also be rotatable relative to first portion 2904a of housing 2904 about fourth pivot member 2924. In some non-limiting embodiments or aspects, fourth pivot member 2924 may be rod or pin 2926 extending through first portion 2904a of housing 2904 and bracket member 2918. However, the disclosure contemplates other suitable types of pivot members 2920. Seal 2928 may attach to bracket member 2918. Seal 2928 may be configured to seal spout 2902 to prevent inadvertent and/or premature dispensing of drink product. In some non-limiting embodiments or aspects, seal 2928 may be a lip seal that covers spout 2902. However, other suitable types of seals 2928 are contemplated by this disclosure. For example, in some non-limiting embodiments or aspects, seal 2928 may be, or may include, a plug that is made out of one or more relatively dense materials having a relatively high durometer and that extends into spout 2902 to seal spout 2902. Spout 2902 may include safety grate 2930 or other mechanism to prevent the user from inadvertently inserting his or her fingers into spout 2902 (FIG. 29D).

To dispense the drink product, in some non-limiting embodiments or aspects, actuation of lever 2906 by the user may cause link member 2912 to move upward relative to housing 2904. Because bracket member 2918 is attached to both link member 2912 and to housing 2904, a portion of bracket member 2918 may move upward with link member 2912 while the remainder of bracket member 2918 is forced to pivot about fourth pivot member 2924. This, in turn, may cause seal 2928 to move into an open position. When seal 2928 moves into the open position, seal 2928 may uncover spout 2902 to dispense the drink product. Advantageously, in the open position, seal 2928 may be angled at about 45-60 degrees with respect to spout 2902 to direct the drink product downward toward the beverage cup. Release of lever 2906 by the user may allow the components to return to their unactuated position, allowing seal 2928 to again close spout 2902.

Referring now to FIGS. 30A and 30B, shown are views of dispenser assembly 3000 (e.g., dispenser assembly 108) for dispensing a drink product from drink maker 100, according to some non-limiting embodiments or aspects. Dispenser assembly 3000 may be substantially similar to dispenser assembly 2900. For example, as shown in FIG. 30A, dispenser assembly 3000 may include dispenser housing 3004 for housing the component parts of dispenser assembly 3000. Housing 3004 may have first portion 3004a attached to an outer surface of drink maker 100 (e.g., mixing vessel 104 thereof) adjacent to spout 3002 and second portion 3004b spaced apart from spout 3002 and extending outward from the outer surface. Handle 120 may have upper portion 120a in the form of user-actuatable lever 3006 and lower portion 120b attached to second portion 3004b of housing 3004. Lever 3006 may be rotatable relative to second portion 3004b of housing 3004 about first pivot member 3008. Link member 3012 may operatively couple to lower portion 120b of handle 120. Link member 3012 may be rotatable relative to lever 3006 about second pivot member 3014.

As shown in FIG. 30B, bracket member 3018 may operatively couple to link member 3012 and may be attached to first portion 3004a of housing 3004. In some non-limiting embodiments or aspects, bracket member 3018 may have an inverted L-shape, as shown. However, the disclosure contemplates other suitable shapes of bracket member 3018. Bracket member 3018 may be rotatable relative to link member 3012 about third pivot member 3020. Bracket member 3018 may also be rotatable relative to first portion 3004a of housing 3004 about fourth pivot member 3024. Seal 3028 may attach to bracket member 3018. Seal 3028 may be configured to seal spout 3002 in a closed position. In some non-limiting embodiments or aspects, seal 3028 may be a lip seal that covers spout 3002. However, in some non-limiting embodiments or aspects, seal 3028 may be, or may include, a plug that is made out of one or more relatively dense materials having a relatively high durometer and that extends into spout 3002 to seal spout 3002.

To dispense the drink product, in some non-limiting embodiments or aspects, actuation of lever 3006 by the user may cause link member 3012 to move upward relative to housing 3004. Because bracket member 3018 may be attached to both link member 3012 and to housing 3004, a portion of bracket member 3018 may move upward with link member 3012 while the remainder of bracket member 3018 is forced to pivot about fourth pivot member 3024. This, in turn, may cause seal 3028 to move into an open position. When seal 3028 moves into the open position, seal 3028 may uncover spout 3002 to dispense the drink product. Advantageously, in the open position, seal 3028 may be angled at about 45-60 degrees with respect to spout 3002 to direct the drink product downward toward the beverage cup. Release of lever 3006 by the user may allow the components to return to their unactuated position, allowing seal 3028 to again close spout 3002.

Advantageously, unlike other dispenser mechanisms, dispenser assemblies 2900, 3000 of this disclosure do not rely on leverage against the outer surface of drink maker 100 to open seal 2928, 3028. This may reduce wear and tear of the component parts of dispenser assemblies 2900, 3000 and on the outer surface of drink maker 100. Furthermore, because seal 2928, 3028 moves both horizontally and vertically with respect to spout 2902, 3002 to unseal spout 2902, 3002, the open position of seal 2928, 3028 may provide less obstruction to the flow of the drink product from spout 2902, 3002.

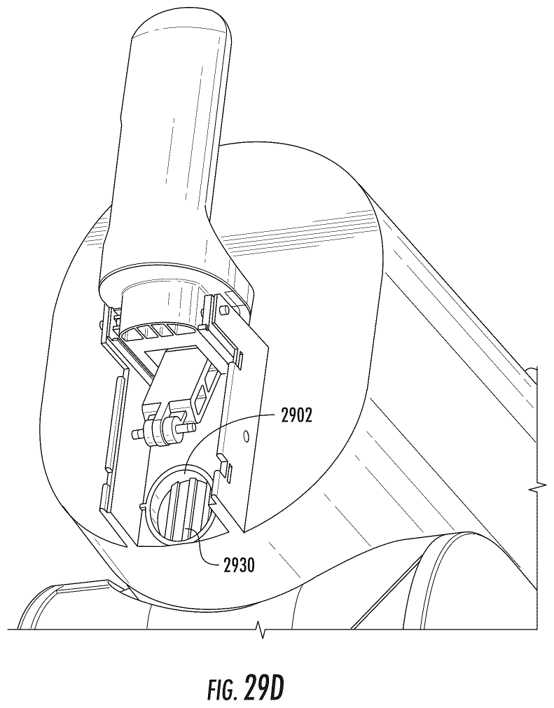

Referring now to FIGS. 31A and 31B, shown are views depicting greater detail of shroud 116 (e.g., spout cover) for covering a portion of dispenser assembly 2900, 3000, according to some non-limiting embodiments or aspects. As shown in FIG. 31A, shroud 116 may include first panel section 3102a and second panel section 3102 extending substantially parallel to one another. Front section 3104 may extend between panel sections 3102a, 3102b. In some non-limiting embodiments or aspects, panel sections 3102a, 3102b may be substantially flat, while front section 3104 may be curved, as shown. In some non-limiting embodiments or aspects, front section 3104 may include arcuate upper edge 3106 configured such that actuation of handle 120 is not impeded. However, the disclosure contemplates other suitable shapes of upper edge 3106, such as the rectilinear shape shown in FIG. 1. As shown in FIG. 31B, panel sections 3102a, 3102b may be configured to form a connectably removable fit (e.g., snap-fit) with dispenser housing 2904, 3004. A length of shroud 116 may be selected to cover the component parts of dispenser assemblies 2900, 3000 other than handle 120 to improve the aesthetic appearance of drink maker 100. Shroud 116 may also aid in directing the drink product downward toward the beverage cup. Shroud 116 may be made of a dishwasher safe material for easy cleaning.

In some non-limiting embodiments or aspects, at least front section 3104 of shroud 116 may be vertically moveable relative to dispenser assembly 2900, 3000. For example, in some non-limiting embodiments or aspects, front section 3104 may be moveable relative to first panel section 3102a and second panel section 3102b. In some non-limiting embodiments or aspects, front section 3104 may be hingedly connected to first and second panel sections 3102a, 3102b or may be vertically slidable relative first and second panel sections 3102a, 3102b. Such movement may be useful when dispensing a non-frozen, water-based beverage to prevent the beverage from dispensing at too lateral of a trajectory from spout 2902, 3002. Such a lateral trajectory may result in at least a portion of the beverage not dispensing into a receiving vessel located below spout 2902, 3002.

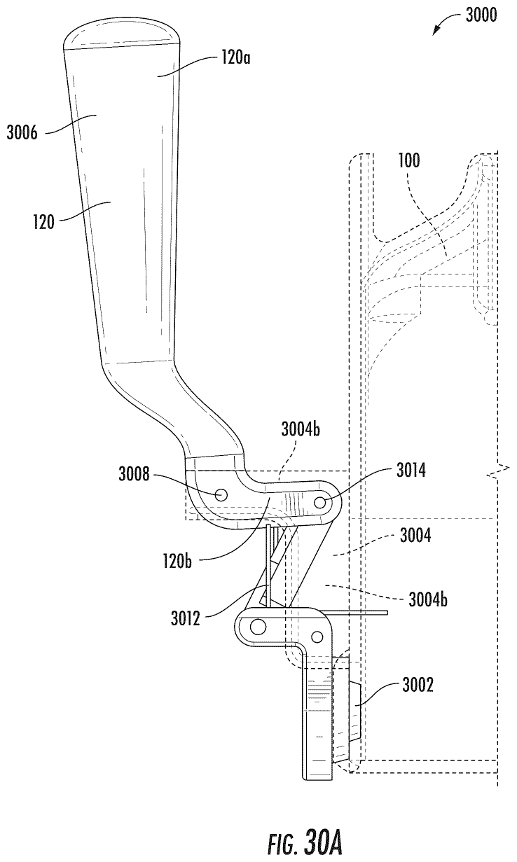

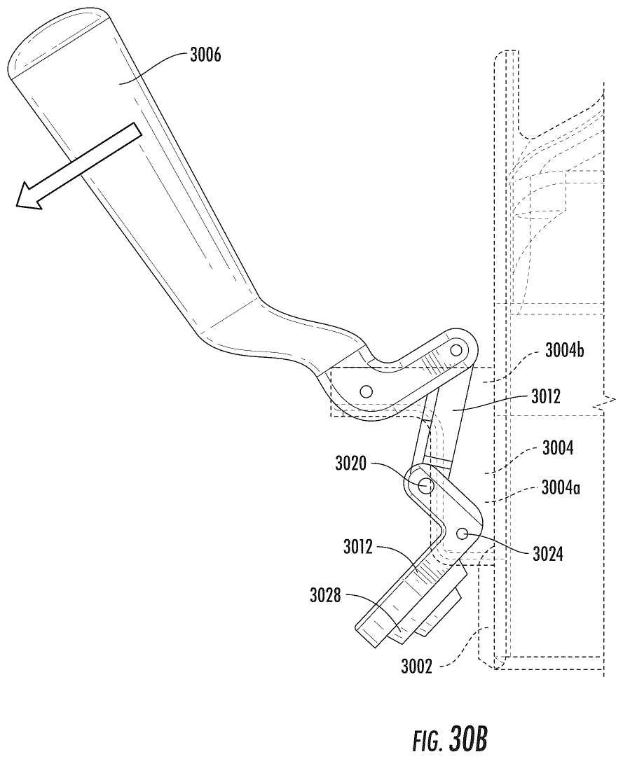

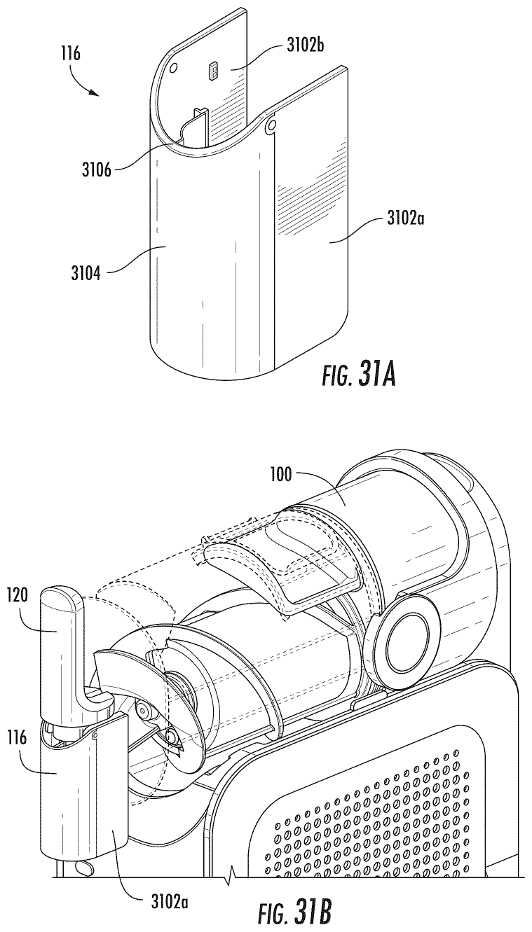

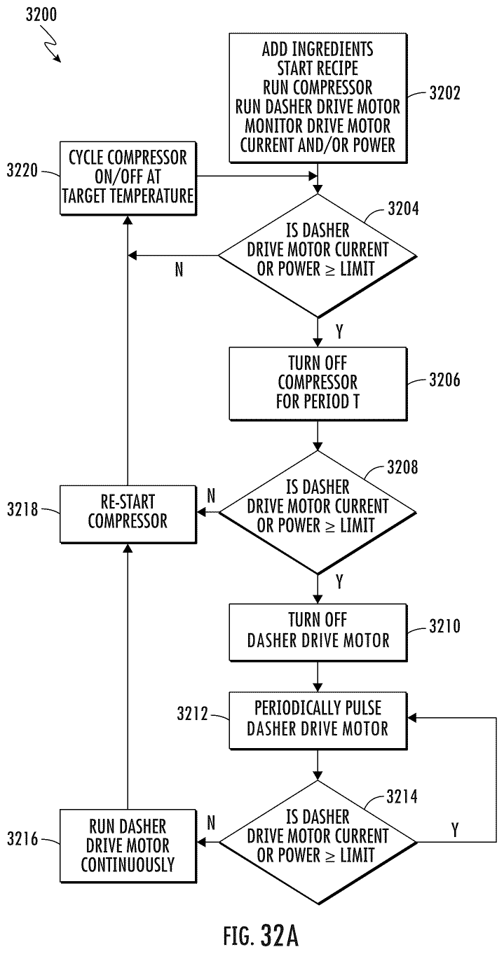

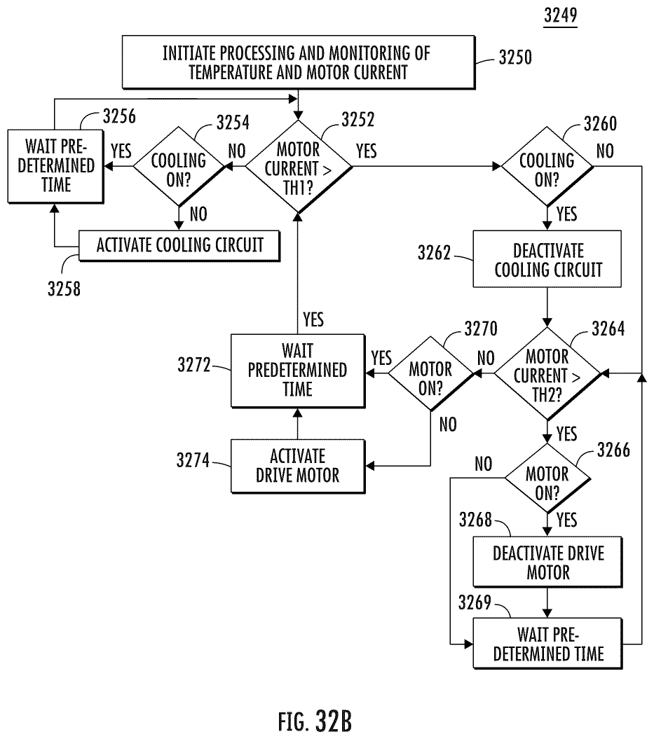

Referring now to FIG. 32A, shown is shown is method 3200 for processing a drink product in a drink maker, according to some non-limiting embodiments or aspects. The steps shown in FIG. 32A are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. As shown, method 3200 may include steps for automatically controlling a drink maker in response to detecting when drive motor current (or power, torque, etc.) exceeds a limit such as, for example, as a result of excessive ice buildup on evaporator 202 which may interfere with operations of or damage dasher 204 and/or drive motor 208. Such a situation may arise when a drink product has an insufficient amount of ingredients, such as a low percentage of sugar, alcohol, or other content, e.g., 4-6% or about 2%, or even lower.

As shown in FIG. 32A, method 3200 may include, at step 3202, adding ingredients of a drink product into mixing vessel 104 and starting a program or processing sequence associated with a drink data object stored in, for example, memory 404. For example, the program may include running a cooling circuit and/or compressor 214, running drive motor 208 to rotate dasher 204, and monitoring drive motor 208 current (or power, torque, etc.).

As shown in FIG. 32A, method 3200 may include, at step 3204, comparing a detected motor current (or power, torque, etc.) to a limit. For example, controller 402 may compare and determine whether the detected current (or power, torque, etc.) is greater than or equal to a current limit (or power limit, torque limit, etc.), such as a 40 watts power limit (see, e.g., FIG. 9). If the detected current (or power, torque, etc.) is less than the limit, method 3200 may proceed to step 3220. In step 3220, controller 402 may cycle the cooling circuit (e.g., turning off and on compressor 214) at a temperature set by the program and/or drink data object for the drink product being processed (e.g., the predefined temperature value defined by the drink data object).

In some non-limiting embodiments or aspects, for a drink product being processed by a drink maker, a predefined temperature value for the drink type selected or determined for the drink product may be predefined in that it was determined (e.g., calculated) and set as the target temperature value for the drink type before the drink maker began processing the drink product, e.g., before the drink maker began executing a program for the drink type. For example, the drink maker may be configured with the predefined temperature value prior to sale, or the predefined temperature value may be downloaded (e.g., via a wireless interface) to the drink maker prior to processing the drink product.

In some non-limiting embodiments or aspects, the predefined temperature value for a drink type may be based on a predetermined phase change temperature value associated with the drink type. A phase change of a drink product may be deemed to have occurred when at least some of a volume of drink product has started nucleating from a liquid state to a solid state (e.g., started to freeze). A phase change temperature value of a drink product or drink type, which may be referred to herein as the freezing point of the drink product or drink type, respectively, may be the temperature at which it is determined that the phase change of the drink product or drink type, respectively, occurs.

In some non-limiting embodiments or aspects, during the cooling of a drink product by a drink maker, at the point in time of the phase change, the drink product may not yet be in a state one would consider a slush (e.g., a particulate frozen or semi-frozen drink, such as a slurry), or at least not a desired slush state. That is, at the time of the phase change, the drink product may be primarily a liquid with some small ice pieces dispersed therein. As the drink product continues to cool, a larger percentage of the volume of the drink product may nucleate (e.g., freeze), such that the amount and size of ice pieces increases. As ice pieces combine into larger masses of ice pieces, the drink product as a whole becomes a slush. In this slush state, there may be a range of slush consistency or thickness as the slush continues to be cooled, becoming slushier (e.g., thicker), until ultimately, if cooling continued unchecked, the drink product may become frozen solid. The target temperature value for a drink product or drink type, respectively, may be a temperature value determined to produce a desirable, ideal, and/or average slush consistency for the drink product or drink type, respectively. Thus, the target temperature value of a drink product or drink type may be a lower temperature value than the phase change temperature value of the drink product or drink type, respectively. In some non-limiting embodiments or aspects, the target temperature value for the drink type selected by a user may be predefined (e.g., before processing the drink product) based on empirical data—e.g., based on experiments/testing with users, based on applying a formula to the predefined phase change temperature value of the drink type (e.g., a temperature offset, a linear equation, or a more complex formula), and/or the like.

In some non-limiting embodiments or aspects, as described herein, the phase change temperature value and target temperature value for a drink product, e.g., a drink type of the drink product, may be predetermined prior to processing of the drink product by the drink maker, or the phase change temperature value and target temperature value for a drink product may be determined by a drink maker while processing the drink product. The drink maker may take actions based on the predetermined and/or in-process-determined phase change temperature value and/or target temperature value.

As shown in FIG. 32A, method 3200 may include, at step 3206, turning off the cooling circuit. For example, if the detected current (or power, torque, etc.) is greater than or equal to the limit, then controller 402 may turn off the cooling circuit (e.g., by turning off compressor 214) for a period of time. The period may be greater than or equal to 5, 10, 15, 20, 30 seconds, or longer.

As shown in FIG. 32A, method 3200 may include, at step 3208, determining whether a motor current (or power, torque, etc.) is greater than or equal to a limit. For example, after the period of time of turning off the cooling circuit, controller 402 may then compare and determine whether the motor current (or power, torque, etc.) is greater than or equal to a limit (e.g., a 40 watt power limit, as shown in FIG. 9). If the detected current (or power, torque, etc.) is less than the limit, controller 402 may proceed to step 3218.

As shown in FIG. 32A, method 3200 may include, at step 3218, restarting the compressor 214. For example, controller 402 may restart the cooling circuit (e.g., compressor 214), and then proceed to step 3220.

As shown in FIG. 32A, method 3200 may include, at step 3220, cycling compressor 214 off and on at the target temperature value. For example, controller 402 may cycle the cooling circuit (e.g., compressor 214) at the target temperature value. An exemplary threshold or current (or power, torque, etc.) limit (e.g., 40 W) may be dynamically set based on at least two different inputs: (i) motor free load power (e.g., set during a calibration process in production), and (ii) input voltage due to power supply variations, as such variations may impact motor power.

In addition to addressing ice build-up that may be caused by inadequate amounts of certain ingredients (e.g., relative to the volume of drink product), the methods and techniques described in relation to FIG. 32, and variations thereof, may be implemented to address user error in controlling the determination of a target temperature value for a drink product being processed. Such user error may occur in selecting a drink type that is not the same or similar enough to the drink product being processed and/or by selecting temperature adjustments that produce a target temperature value that is too low for the drink product. Regarding drink type selection, for example, if a user selects a drink type having relatively high sugar or alcohol concentrations, but the actual drink product being processed has less (e.g., significantly less) sugar and/or alcohol concentrations than the selected drink type, then the predefined temperature value will be too low, such that it is lower (e.g., much lower) than a reasonable target temperature value for the drink product. As a result, left unchecked, the drink maker may continue to cool the drink product significantly past a reasonable target temperature, possibly to a point that the resulting slush gets so thick that drive motor 208 is overworked and dasher 204 stalls.

In some non-limiting embodiments or aspects, the cycling of compressor 214 (e.g., turning compressor 214 off and on) may avoid the above-described complications. In some non-limiting embodiments or aspects, controller 402 may be configured to determine user error and take action accordingly. For example, during processing of a drink product, after satisfying a drive motor threshold multiple times, controller 402 may change the target temperature value to a higher value (e.g., in some cases, changing to a predetermined target temperature for another drink type). In some non-limiting embodiments or aspects, the time that compressor 214 is off may be about 3 minutes due to configuration of the cooling circuit. In some non-limiting embodiments or aspects, different periods of off-time may be used. For example, approximately 30 seconds or less may be optimal. If the detected current (or power, torque, etc.) remains greater than or equal to the limit after the period of time, then controller 402 may proceed to step 3210.

As shown in FIG. 32A, method 3200 may include, at step 3210, turning off the drive motor. For example, controller 402 may turn off drive motor 208 of dasher 204. Controller 402 may then proceed to step 3212.

As shown in FIG. 32A, method 3200 may include, at step 3212, periodically pulsing drive motor 208. For example, controller 402 may periodically pulse drive motor 208 of dasher 204. Pulsing may include running drive motor 208 for a portion of a time period. For example, during a 20 second time period, drive motor 208 may be run or pulsed for 5 seconds (e.g., drive motor 208 is on for 5 seconds and off for 15 seconds). The time period may be varied as well as the pulse period. For example, the pulse may first be for 10 seconds out of a 30 second time period, then the pulse may be for 8 seconds out of a 16 second time period, and/or the like. In some non-limiting embodiments or aspects, drive motor 208 of dasher 204 may be turned off for the same period (e.g., 3 minutes) that compressor 214 is off. And then both drive motor 208 and compressor 214 may be turned back on, which may provide less on and off pulsing/cycling.

As shown in FIG. 32A, method 3200 may include, at step 3214, determining whether the detected current (or power, torque, etc.) is greater than or equal to the limit. For example, during the pulsing process of step 3212, controller 402 may continuously compare and determine whether the detected current (or power, torque, etc.) is greater than or equal to the limit. If the detected current (or power, torque, etc.) is greater than the limit, controller 402 may proceed with step 3212. If controller 402 detects that the current (or power, torque, etc.) is less than the limit, controller 402 may proceed to step 3216.

As shown in FIG. 32A, method 3200 may include, at step 3216, running drive motor 208 continuously. For example, controller 402 may start and run drive motor 208 continuously, proceed to step 3218, where compressor 214 is restarted, and then proceed to step 3220 where controller 402 cycles the cooling circuit (e.g., compressor 214) off and on at the target temperature. Controller 402 may then continuously monitor the current (or power, torque, etc.) of drive motor 208 according to step 3204.

Referring now FIG. 32B, shown is method 3249 for processing a drink product in a drink maker, according to some non-limiting embodiments or aspects. The steps shown in FIG. 32B are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. As shown, method 3249 may include steps for automatically controlling a drink maker in response to detecting when drive motor current (or power, torque, etc.) exceeds one or more limits. It will be appreciated that reference to a motor current in the following description may also refer to a motor power, torque, and/or the like, and motor current is used for ease of reference.

As shown in FIG. 32B, method 3249 may include, at step 3250, initiating processing and monitoring of temperature of a drink product and motor current of a drive motor. For example, controller 402 may initiate processing of the drink product by activating drive motor 208, and controller 402 may further monitor the temperature of the drink product and a motor current of drive motor 208.

As shown in FIG. 32B, method 3249 may include, at step 3252, comparing a motor current to a first threshold. For example, controller 402 may compare a motor current to a first threshold (e.g., a first motor current limit). If the motor current satisfies (e.g., is greater than or equal to) the first threshold, controller 402 may proceed to step 3260. If the motor current does not satisfy the first threshold, controller 402 may proceed to step 3254.

As shown in FIG. 32B, method 3249 may include, at step 3254, determining if the cooling circuit is on. For example, controller 402 may determine if the cooling circuit (e.g., compressor 214) is on. If the cooling circuit is not on, controller 402 may proceed to step 3258. If the cooling circuit is on, controller 402 may proceed to step 3256.

As shown in FIG. 32B, method 3249 may include, at step 3258, activating the cooling circuit. For example, controller 402 may activate the cooling circuit (e.g., compressor 214).

As shown in FIG. 32B, method 3249 may include, at step 3256, waiting a predetermined period of time. For example, controller 402 may wait a predetermined period of time (e.g., 5, 10, 15, 20, 25, 30 seconds, or more) before returning to step 3250 and/or step 3252.

As shown in FIG. 32B, method 3249 may include, at step 3260, determining if the cooling circuit is on. For example, controller 402 may determine if the cooling circuit (e.g., compressor 214) is on. If the cooling circuit is on, controller 402 may proceed to step 3262. If the cooling circuit is not on, controller 402 may proceed to step 3264.

As shown in FIG. 32B, method 3249 may include, at step 3262, deactivating the cooling circuit. For example, controller 402 may deactivate the cooling circuit (e.g., compressor 214). Thereafter, controller 402 may proceed to step 3264.

As shown in FIG. 32B, method 3249 may include, at step 3264, determining whether the motor current satisfies a second threshold. For example, controller 402 may compare the motor current to a second threshold (e.g., second motor current limit) and determine whether the second threshold is satisfied (e.g., met or exceeded). If the second threshold is not satisfied, controller 402 may proceed to step 3270. If the second motor threshold is satisfied, controller 402 may proceed to step 3266.

As shown in FIG. 32B, method 3249 may include, at step 3266, determining whether the drive motor is on. For example, controller 402 may determine whether drive motor 208 is on. If the drive motor 208 is on, controller 402 may proceed to step 3268. If the drive motor 208 is not on, controller 402 may proceed to step 3269.

As shown in FIG. 32B, method 3249 may include, at step 3268, deactivating the drive motor. For example, controller 402 may deactivate drive motor 208. Thereafter, controller 402 may proceed to step 3269.

As shown in FIG. 32B, method 3249 may include, at step 3269, waiting a predetermined period of time. For example, controller 402 may wait a predetermined period of time (e.g., 5, 10, 15, 20, 25, 30 seconds, or more), before proceeding back to step 3264.

As shown in FIG. 32B, method 3249 may include, at step 3270, determining whether the drive motor is on. For example, controller 402 may determine whether drive motor 208 is on. If drive motor 208 is on, controller 402 may proceed to step 3272. If drive motor 208 is not on, controller 402 may proceed to step 3274.

As shown in FIG. 32B, method 3249 may include, at step 3274, activating the drive motor. For example, controller 402 may activate drive motor 208. Thereafter, controller 402 may proceed to step 3272.

As shown in FIG. 32B, method 3249 may include, at step 3272, waiting a predetermined period of time. For example, controller 402 may wait a predetermined period of time (e.g., 5, 10, 15, 20, 25, 30 seconds, or more), before proceeding back to step 3252.

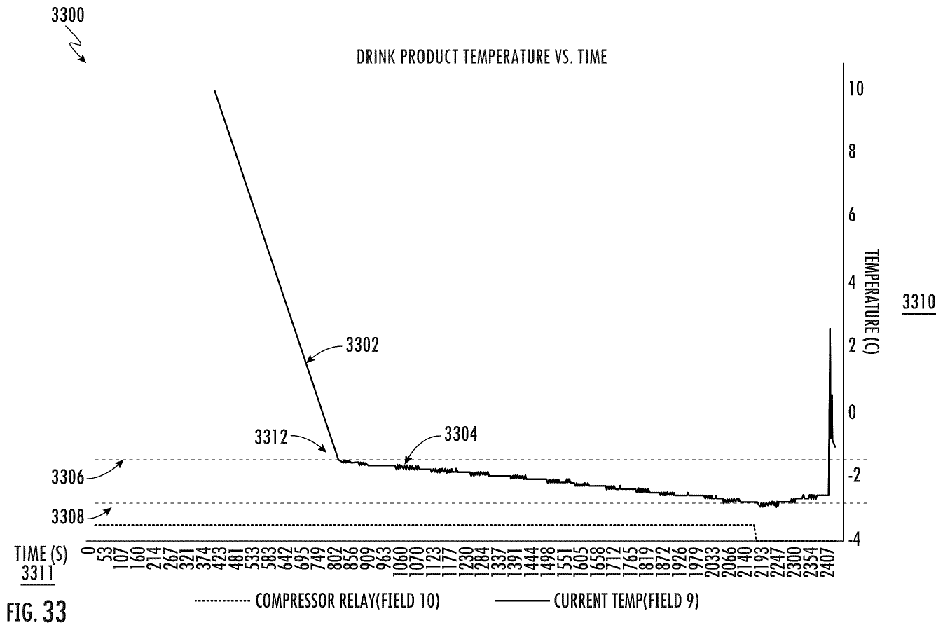

Referring now to FIG. 33, shown is a graph 3300 of drink product temperature 3310 over time 3311 that illustrates an example of how a controller (e.g., controller 402) may determine the phase change of the drink product when the rate of temperature change decreases from a first rate of change to a second rate of change, according to some non-limiting embodiments or aspects. While compressor 214 (and thus the cooling circuit) is on, the cooling circuit may be continuously pulling energy out of the ingredients of a drink product in mixing vessel 104. When the drink product temperature is above the phase change temperature value, the thermal gradient associated with the drink product may be steep, because all the energy removed is going entirely to a thermal change. When the liquid of the drink product starts to freeze, the thermal gradient becomes shallow because the phase change is an isothermic event. Therefore, even as the cooling circuit is pulling energy out of the drink product at the same rate, the thermal gradient dramatically reduces. In some non-limiting embodiments or aspects, the phase change (e.g., at point 3312) may be determined to occur when the thermal gradient transitions from steep (e.g., a higher rate of change) to shallow (a lower rate of change).

For illustrative purposes, FIG. 33 shows the temperature gradient for a cola soft drink as a drink product, as temperature is decreased within mixing vessel 104 of drink maker 100. The temperature of the drink product initially decreases at a first rate of temperature change along first portion 3302 of the temperature gradient, but then changes to a second rate of temperature change along second portion 3304 of the temperature gradient. Controller 402 may determine that the point at which there is a change in the rate of change of temperature, from a higher rate of change (e.g., steeper slope) to a lower rate of change (e.g., lesser slope), is approximately the phase change temperature value at point 3312. The determined phase change temperature value 3306 corresponds to the temperature at the determined and/or identified freezing point. In this instance, the phase change temperature value for a cola soft drink is about −1.5° C., while the calculated target temperature is about −2.0° C. The drink product may continue to cool over a period of time until a minimum temperature 3308 is reached.

In some non-limiting embodiments or aspects, another approach to determining and/or calculating when a phase change has occurred is for controller 402 to continuously monitor temperature via a sliding window over a period of time where the window of the period of time progresses in time incrementally as each temperature signal is detected. For example, controller 402 may receive temperature signals every 0.5 seconds indicating the temperature of a drink product being processed. Controller 402 may compare the first temperature signal with the last temperature signal over a period of time, e.g., a 30 second period. Controller 402 may compare the temperature at time t=30.0 seconds with the temperature at time t=0.0 seconds to determine the temperature change. Then, controller 402 may compare the temperature at time t=0.5 seconds with the temperature at time t=30.5 seconds to determine the temperature change, and so on, continuously. Controller 402 may determine the change in temperature over the period of time, e.g., 30 seconds, by subtracting the first temperature detected from the last temperature detected to determine and/or calculate the rate of change of temperature over the period of time. In some non-limiting embodiments or aspects, controller 402 may compare the determined rate of change of temperature with a constant rate of change value stored in memory that corresponds to a rate of change of temperature associated with one or more drink product types after a phase change from liquid to slush. For example, certain drink product types may have a constant rate of change of temperature in the slush phase (e.g., of about 0.18 degrees Celsius).

In some non-limiting embodiments or aspects, controller 402 may continuously and/or repeatedly determine the rate of change of temperature of a drink product being processed until it determines and/or calculates a rate of change that is about equal to an expected or constant rate of change of temperature associated with a drink product type that has transitioned from a liquid phase to a slush phase. Once controller 402 detects the expected rate of change of temperature, controller 402 may reference the first temperature detection increment of the time period to determine and/or calculate when the phase change and/or transition occurred. As shown in FIG. 33, the slope and/or rate of change of second portion 3304 of the temperature gradient may correspond to, for example, a constant rate of change of about 0.18 degrees Celsius associated with the drink product type of the drink product being processed. Hence, controller 402 may determine the phase change temperature value by determining when phase change temperature value at point 3312 is reached. The relationship between the expected phase change temperature value and the target temperature value is described further as follows.

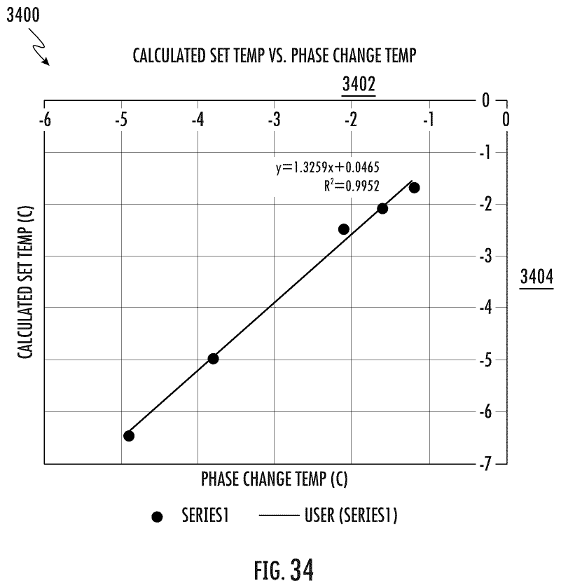

Referring now to FIG. 34, shown is a graph 3400 that illustrates a linear relationship between a phase change temperature value to a target temperature value, according to some non-limiting embodiments or aspects. Setting temperature to get a desired slush thickness for a given drink type may be difficult. Different ingredients of different drink types may require significantly different temperatures for a given slush thickness. While the impact of a minor change of temperature for a given drink type of as low as 0.1° C. or 0.2° C. may be perceptible to a user, a wide range of temperatures may be needed. Therefore, knowing where to start and how to dial in a temperature setting for a particular drink type may be difficult. Hence, controller 402 may be configured to more efficiently and timely determine a target temperature where an optimal and/or desired slush thickness may be achieved. The temperature to achieve a roughly desired slush thickness may correlate with the phase change temperature value of the ingredients of a particular drink type in a linear manner. By programming this correlation into a memory (e.g., memory 404), controller 402 may automatically determine and/or calculate a target temperature based on the identified phase change temperature value for a particular drink type. FIG. 34 illustrates the linear relationship between phase change temperature value 3402 and calculated target temperature or nominal slush thickness value 3404. As shown in FIG. 34, the phase change temperature value of −1.5° C. correlates to a target temperature value of about −2.0° C. Graph 3400 illustrates the linear relationship of various phase change temperature values to target temperature values for multiple drink types. This linear relationship between phase change temperature and target temperature may be similar across all ingredient types such as, without limitation, dairy, soda, alcohol, and/or the like.

Referring now to FIG. 35, shown is a flow diagram of method 3500 for processing a drink product in a drink maker, according to some non-limiting embodiments or aspects. The steps shown in FIG. 35 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. As shown, method 3500 may include steps for automatically controlling a drink maker (e.g., drink maker 100), in response to detecting conditions related to the temperature of a drink product, such as when a phase change occurs.

As shown in FIG. 35, method 3500 may include, at step 3502, adding ingredients of a drink product into mixing vessel 104 and starting a program, which may be based on a drink data object stored in memory 404. For example, the program started may include: running a cooling circuit and/or compressor 214, running drive motor 208 to rotate dasher 204, and continuously monitoring the drink product temperature using at least one sensor 406.

As shown in FIG. 35, method 3500 may include, at step 3504, determining if a phase transition of the drink product has occurred above a target temperature. For example, controller 402 may determine whether a phase transition has occurred in the drink product at a temperature above a target temperature. If the phase transition has occurred above the target temperature, controller 402 may proceed to step 3508. If the phase transition has not yet occurred, controller 402 may proceed to step 3506 after a period of time.

For example, if the drink product is a cola soft drink, the expected phase change temperature value may be about −1.5° C. while the preset target temperature value may be about −2.0° C. If the cola soft drink product was diluted with additional water, causing its sugar concentration to decrease significantly, the cola soft drink product's actual phase change may occur at about −1.0° C., which is above the expected phase change temperature of −1.5° C. and the target temperature of −2.0° C. Water has a phase change temperature of 0° C., so the addition of water would increase the phase change temperature of a drink product. Controller 402 may detect this early phase transition and/or phase change above the target temperature value and take action, as in step 3508. Additionally, or alternatively, controller 402 may perform a portion of method 3200, as shown in FIG. 32. Controller 402 may perform portions of method 3500 and method 3200 separately, concurrently, or integrally depending on the circumstances. In some non-limiting embodiments or aspects, the only action taken by controller 402 based on the determined phase change temperature relative to a threshold and/or target temperature may be to continue processing (e.g., if the detected temperature of a drink product is within an allowable temperature range, such as between maximum and minimum temperature limits associated with the drink product that may be stored in the associated drink data object in memory) or output an error via user interface 112 if outside of range.

As shown in FIG. 35, method 3500 may include, at step 3508, alerting a user. For example, controller 402 may, in response to the phase transition occurring above a target temperature, cause an alert to be output to user (e.g., via user interface 112), indicating that an insufficient amount of sugar, alcohol, and/or other ingredients have been added to the drink product associated with the drink type, or that an incorrect drink type was selected for the ingredients of the drink product being processed.

As shown in FIG. 35, method 3500 may include, at step 3506, determining whether a phase transition has occurred at or about the target temperature. For example, controller 402 may determine whether a phase transition has occurred at or about the target temperature. If a phase transition has occurred at or about the target temperature, controller 402 may proceed to step 3516. If a phase transition has not occurred at or about the target temperature, controller 402 may proceed to step 3510.

As shown in FIG. 35, method 3500 may include, at step 3516, cycling the compressor off and on. For example, controller 402 may cycle the cooling circuit (e.g., compressor 214) off and on to maintain the drink product temperature at or about the target temperature. In some non-limiting embodiments or aspects, controller 402 may apply an offset and/or error adjustment that is equal to a positive or negative 10% of the target temperature value when identifying and/or determining the phase change temperature value of the drink product.

As shown in FIG. 35, method 3500 may include, at step 3510, detecting supercooling. For example, if a phase change is not identified at or about the target temperature and the drink product temperature continues to decrease at about the same rate of change, controller 402 may determine that the drink product is in a state of supercooling (e.g., the drink product is still in its liquid phase and no phase change has occurred yet, while the drink product temperature is below its expected phase change temperature). Once controller 402 determines that supercooling is occurring, controller 402 may optionally proceed to step 3512.

As shown in FIG. 35, method 3500 may include, at step 3512, pulsing the dasher drive motor to cause nucleation. For example, controller 402 may pulse drive motor 208 of dasher 204 so that ice may more easily begin nucleating when the churning is stopped and, thereby, trigger a phase change of the drink product.

As shown in FIG. 35, method 3500 may include, at step 3514, determining if a phase transition has occurred above the shutdown temperature. For example, if the drink product temperature continues to decrease but controller 402 identifies a phase transition above the shutdown temperature, method 3500 may proceed to step 3516, where controller 402 cycles compressor 214 on and off to maintain the drink product temperature at about the target temperature. If controller 402 determines that a phase transition has not yet occurred above the shutdown temperature, controller 402 may proceed to step 3518.

As shown in FIG. 35, method 3500 may include, at step 3518, shutting off the compressor, shutting off the dasher drive motor, and alerting the user. For example, controller 402 may shut off compressor 214 and drive motor 208 and alert a user via user interface 112 about the shutdown. In some non-limiting embodiments or aspects, a maximum shutdown temperature and a minimum shutdown temperature may be configured or predefined in association with a type of drink product. The maximum shutdown temperature and minimum shutdown temperature may be stored in memory associated with the particular type of drink product and/or specific drink product. Controller 402 may shut off compressor 214 and/or drive motor 208 when either the maximum or minimum shutdown temperature thresholds are reached or exceeded.

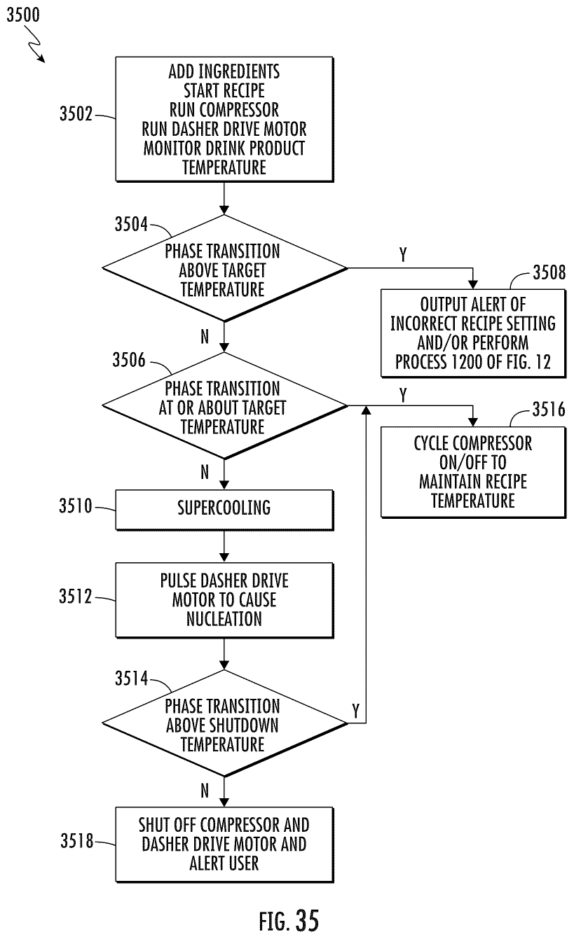

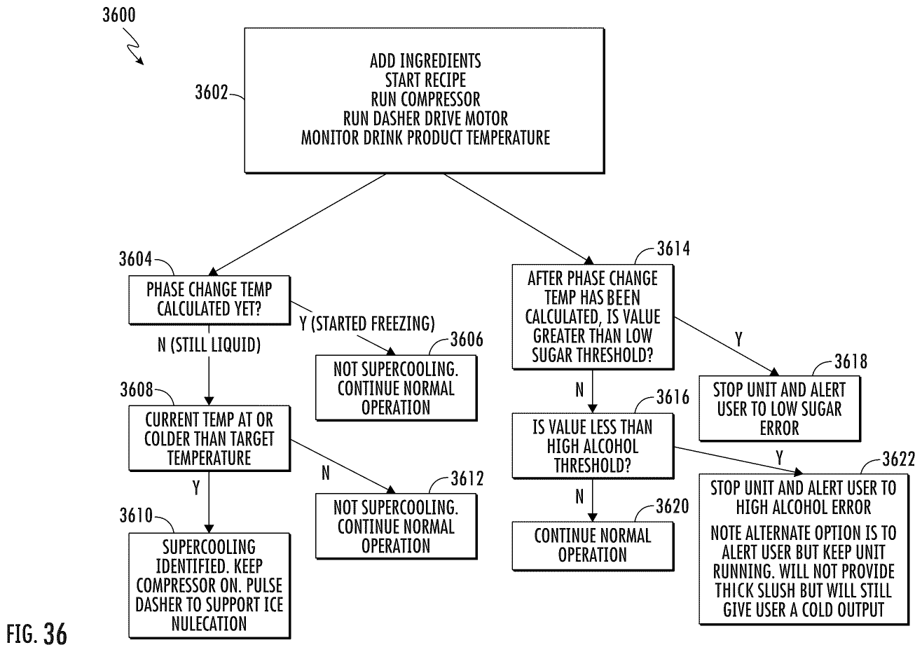

Referring now to FIG. 36, shown is a flow diagram of method 3600 for processing a drink product in a drink maker, according to some non-limiting embodiments or aspects. The steps shown in FIG. 36 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. As shown, method 3600 may include steps for automatically controlling a drink maker in response to detecting conditions related to the temperature of a drink product, such as when a phase change occurs.

As shown in FIG. 36, method 3600 may include, at step 3602, adding ingredients to mixing vessel 104, starting processing based on a programmed drink data object, activating compressor 214, activating drive motor 208, and monitoring drink product temperature. Controller 402 may use a sliding window temperature monitoring technique, as described above in connection with FIG. 33. Controller 402 may monitor the drink product temperature and continuously determine the rate of change of temperature of the drink product to determine if a phase change has occurred.

As shown in FIG. 36, method 3600 may include, at step 3604, determining whether a phase change has occurred yet based on rate of change of temperature. For example, controller 402 may determine whether a phase change in the drink product has occurred based on a rate of change of temperature. If a phase change has occurred, controller 402 may proceed to step 3606. If a phase change has not yet occurred, controller 402 may proceed to step 3608.

As shown in FIG. 36, method 3600 may include, at step 3606, continuing normal operation of the drink maker. For example, in response to determining that the phase change has occurred, controller 402 may determine that supercooling has not occurred, and controller 402 may proceed with normal operation of drink maker 100.

As shown in FIG. 36, method 3600 may include, at step 3608, determining whether the drink product temperature is at or below the target temperature. For example, controller 402 may determine whether the drink product temperature is at or below the target temperature. If the current drink product temperature is not at or below the target temperature, controller 402 may proceed to step 3612. If controller 402 determines that the current drink product temperature is at or below the target temperature, controller 402 may proceed to step 3610.

As shown in FIG. 36, method 3600 may include, at step 3612, continuing normal operation of the drink maker. For example, in response to determining that the drink product temperature is not at or below the target temperature, controller 402 may determine that supercooling has not occurred, and controller 402 may proceed with normal operation of drink maker 100.

As shown in FIG. 36, method 3600 may include, at step 3610, identifying supercooling and performing mitigating action. For example, controller 402 may determine that supercooling is occurring. Controller 402 may keep compressor 214 on and pulse drive motor 208 to pulse rotation of dasher 204 and, thereby, promote ice nucleation.

As shown in FIG. 36, method 3600 may include, at step 3614, determining a phase change temperature and determining if the drink product temperature value is greater than a low sugar threshold temperature. For example, after monitoring the drink product temperature for a period of time, controller 402 may determine and/or calculate the phase change temperature, and controller 402 may determine if the drink product temperature value is greater than a low sugar threshold temperature. If the drink product temperature value is greater than the low sugar threshold temperature, controller 402 may proceed to step 3618. If the drink product temperature is not greater than the low sugar threshold temperature, controller 402 may proceed to step 3616.

As shown in FIG. 36, method 3600 may include, at step 3618, stopping the drive motor and compressor and generating an alert. For example, controller 402 may stop compressor 214 and drive motor 208, and may further issue an alert via user interface 112 indicating a low sugar condition and/or error.

As shown in FIG. 36, method 3600 may include, at step 3616, determining if the drink product temperature value is less than a high alcohol threshold. For example, controller 402 may compare the drink product temperature value to a high alcohol threshold temperature and determine whether the drink product temperature value is less than a high alcohol threshold temperature. If the drink product temperature value is less than the high alcohol threshold temperature, controller 402 may proceed to step 3622. If the drink product temperature value is not less than the high alcohol threshold temperature, controller 402 may proceed to step 3620.

As shown in FIG. 36, method 3600 may include, at step 3620, continuing normal operation of the drink maker. For example, in response to determining that the drink product temperature is not less than the high alcohol threshold temperature, controller 402 may determine that the drink product is being processed as expected, and controller 402 may proceed with normal operation of drink maker 100.

As shown in FIG. 36, method 3600 may include, at step 3622, stopping the drive motor and compressor, and generating an alert to the user. For example, controller 402 may stop compressor 214 and drive motor 208, and may further issue an alert via user interface 112 indicating a high alcohol condition and/or error. Alternatively, controller 402 may issue a high alcohol alert but keep compressor 214 and drive motor 208 running. In such a circumstance, drink maker 100 may not provide a drink product with a thick slush, but the drink product will still be chilled.

In some non-limiting embodiments or aspects, controller 402 may determine a temperature to achieve a roughly desired slush thickness based on the correlation with the phase change temperature value of the ingredients of particular types of drink products. By programming in this correlation, controller 402 may automatically determine a target temperature based on the calculated phase change temperature value as described above (see, e.g., FIG. 14). In certain circumstances, a user may be able to configure and/or program a custom drink product type based on custom ingredients, where controller 402 may determine the phase change temperature value of the custom drink type and may, thereby, automatically determine a target temperature where the customer drink product type has a desired and/or typical slush thickness. In some non-limiting embodiments or aspects, controller 402 may have a “training mode” for new drink types and custom drink types without known target temperature values. In the training mode, controller 402 may determine a phase change temperature value and a target temperature value therefrom. Controller 402 may be able show settings for new and/or custom drink product types via user interface 112.

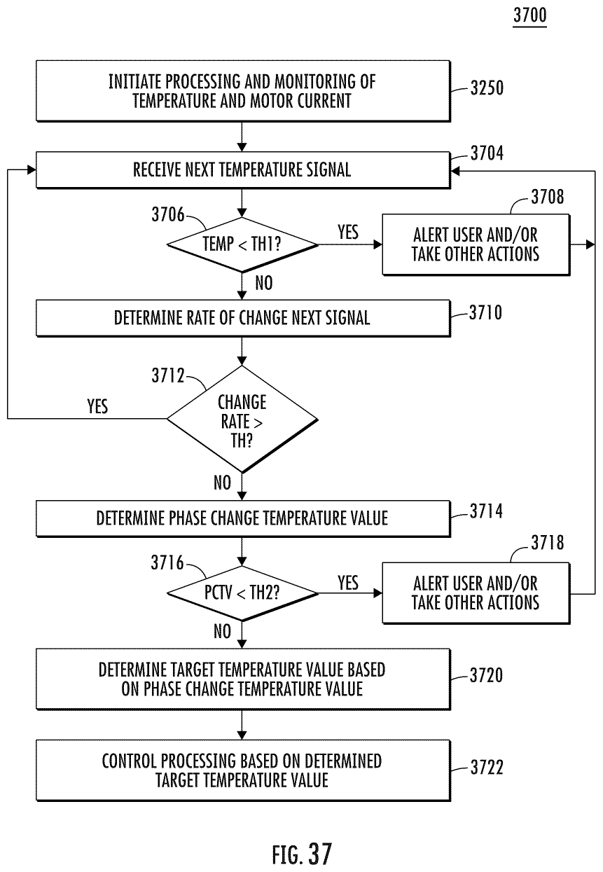

Referring now to FIG. 37, shown is a flow diagram of method 3700 for processing a drink product in a drink maker, according to some non-limiting embodiments or aspects. The steps shown in FIG. 37 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. As shown, method 3700 may include steps for automatically determining a phase change temperature value of a drink product being processed, and controlling a drink maker based on such determination.

As shown in FIG. 37, method 3700 may include, at step 3250, initiating processing and monitoring of temperature of the drink product and motor current (or power, torque, etc.) of the drive motor. For example, controller 402 may initiate processing of the drink product by activating drive motor 208, and controller 402 may further monitor the temperature of the drink product and a motor current (or power, torque, etc.) of drive motor 208.

As shown in FIG. 37, method 3700 may include, at step 3704, receiving a next temperature signal. For example, controller 402 may receive a next temperature signal of a plurality of temperature signals communicated by temperature sensor 406.

As shown in FIG. 37, method 3700 may include, at step 3706, comparing the next temperature signal to a first temperature threshold. For example, controller 402 may compare the next temperature signal received at step 3704 with a first temperature threshold (e.g., comparing the temperature values associated with each). If the next temperature signal is less than the first temperature threshold, controller 402 may proceed to step 3708. If the next temperature signal is not less than the first temperature threshold, controller 402 may proceed to step 3710.

As shown in FIG. 37, method 3700 may include, at step 3708, alerting the user of drink maker 100, and/or taking other actions. For example, controller 402 may, in response to the next temperature signal being less than the first temperature threshold, cause an alert to be generated to the user and/or take one or more remedial actions, including shutting off drive motor 208, shutting off compressor 214, and/or the like.

As shown in FIG. 37, method 3700 may include, at step 3710, determining a rate of change of the next temperature signal. For example, controller 402 may determine a rate of change of temperature of the next temperature signal by comparing the next temperature signal to a prior temperature signal and dividing by the time that elapsed between temperature signals.

As shown in FIG. 37, method 3700 may include, at step 3712, comparing the determined rate of change to a threshold rate of change. For example, controller 402 may compare the rate of change in temperature determined at step 3710 to a threshold rate of change. If the determined rate of change is greater than the threshold rate of change, controller 402 may proceed back to step 3704 and receive the next temperature signal. If the determined rate of change is not greater than the threshold rate of change, controller 402 may proceed to step 3714.

As shown in FIG. 37, method 3700 may include, at step 3714, determining a phase change temperature value. For example, if the rate of change is less than the threshold rate of change, then controller 402 may detect that a phase change is occurring in the drink product. Controller 402 may then determine the temperature of the drink product at the point of phase change.

As shown in FIG. 37, method 3700 may include, at step 3716, comparing the determined phase change temperature value to a second temperature threshold. For example, controller 402 may compare the phase change temperature value determined at step 3714 to a second temperature threshold. If the phase change temperature value is less than the second temperature threshold, controller 402 may proceed to step 3718. If the phase change temperature value is greater than or equal to the second temperature threshold, controller 402 may proceed to step 3720.

As shown in FIG. 37, method 3700 may include, at step 3718, alerting the user of drink maker 100, and/or taking other actions. For example, controller 402 may, in response to the phase change temperature value being less than the second temperature threshold, cause an alert to be generated to the user and/or take one or more remedial actions, including shutting off drive motor 208, shutting off compressor 214, and/or the like.

As shown in FIG. 37, method 3700 may include, at step 3720, determining a target temperature value based on the phase change temperature value. For example, controller 402 may determine a target temperature value based on the phase change temperature value. The determined target temperature value may be proximal to (e.g., an offset lower temperature from) the phase change temperature value.

As shown in FIG. 37, method 3700 may include, at step 3722, controlling processing based on the determined target temperature value. For example, controller 402 may control processing of drink maker 100 based on the determined target temperature value at step 3720. By way of further example, controller 402 may cycle compressor 214 to maintain the drink product at or around the target temperature value.

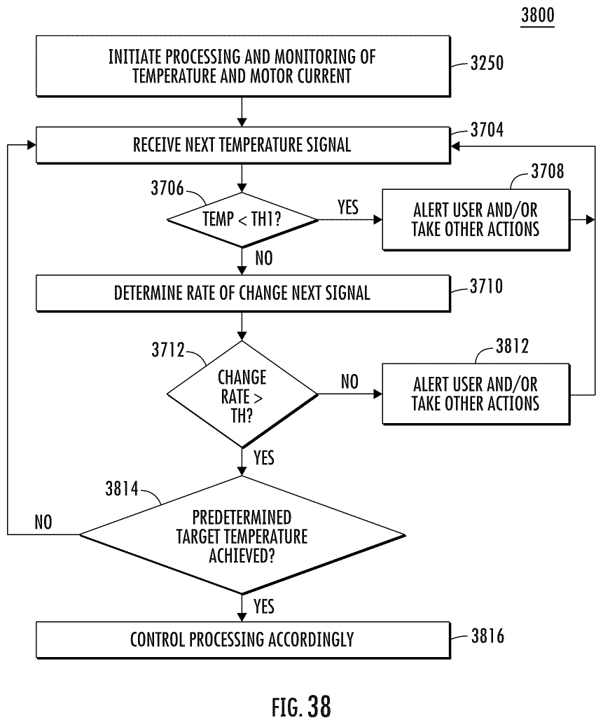

Referring now to FIG. 38, shown is a flow diagram of method 3800 for processing a drink product in a drink maker, according to some non-limiting embodiments or aspects. The steps shown in FIG. 38 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. As shown, method 3800 may include steps for automatically determining when supercooling or certain user error has occurred, and taking action accordingly.

As shown in FIG. 38, method 3800 may include, at step 3250, initiating processing and monitoring of temperature of the drink product and motor current (or power, torque, etc.) of the drive motor. For example, controller 402 may initiate processing of the drink product by activating drive motor 208, and controller 402 may further monitor the temperature of the drink product and a motor current (or power, torque, etc.) of drive motor 208.

As shown in FIG. 38, method 3800 may include, at step 3704, receiving a next temperature signal. For example, controller 402 may receive a next temperature signal of a plurality of temperature signals communicated by temperature sensor 406.

As shown in FIG. 38, method 3800 may include, at step 3706, comparing the next temperature signal to a first temperature threshold. For example, controller 402 may compare the next temperature signal received at step 3704 with a first temperature threshold (e.g., comparing the temperature values associated with each). If the next temperature signal is less than the first temperature threshold, controller 402 may proceed to step 3708. If the next temperature signal is not less than the first temperature threshold, controller 402 may proceed to step 3710.

As shown in FIG. 38, method 3800 may include, at step 3708, alerting the user of drink maker 100, and/or taking other actions. For example, controller 402 may, in response to the next temperature signal being less than the first temperature threshold, cause an alert to be generated to the user and/or take one or more remedial actions, including shutting off drive motor 208, shutting off compressor 214, and/or the like.

As shown in FIG. 38, method 3800 may include, at step 3710, determining a rate of change of the next temperature signal. For example, controller 402 may determine a rate of change of temperature of the next temperature signal by comparing the next temperature signal to a prior temperature signal and dividing by the time that elapsed between temperature signals.

As shown in FIG. 38, method 3800 may include, at step 3712, comparing the determined rate of change to a threshold rate of change. For example, controller 402 may compare the rate of change in temperature determined at step 3710 to a threshold rate of change. If the determined rate of change is greater than the threshold rate of change, controller 402 may proceed to step 3814. If the determined rate of change is not greater than the threshold rate of change, controller 402 may proceed to step 3812.

As shown in FIG. 38, method 3800 may include, at step 3812, alerting the user of drink maker 100, and/or taking other actions. For example, controller 402 may, in response to the next temperature signal being less than the first temperature threshold, cause an alert to be generated to the user and/or take one or more remedial actions, including shutting off drive motor 208, shutting off compressor 214, and/or the like.

As shown in FIG. 38, method 3800 may include, at step 3814, determining if a predetermined target temperature has been achieved in the drink product. For example, controller may determine a current temperature of the drink product from the temperature signal received from temperature sensor 406 and compare the current temperature to a predetermined target temperature. By way of further example, controller 402 may determine that the predetermined target temperature has been achieved if the current temperature is equal to, or within an acceptable range from, the predetermined target temperature. If the predetermined target temperature has been achieved, controller 402 may proceed to step 3816. If the predetermined target temperature has not been achieved, controller 402 may proceed back to step 3704 and receive the next temperature signal from temperature sensor 406.

As shown in FIG. 38, method 3800 may include, at step 3816, controlling processing based on the predetermined target temperature value. For example, controller 402 may control processing of drink maker 100 based on the predetermined target temperature value. By way of further example, controller 402 may cycle compressor 214 to maintain the drink product at or around the predetermined target temperature value.

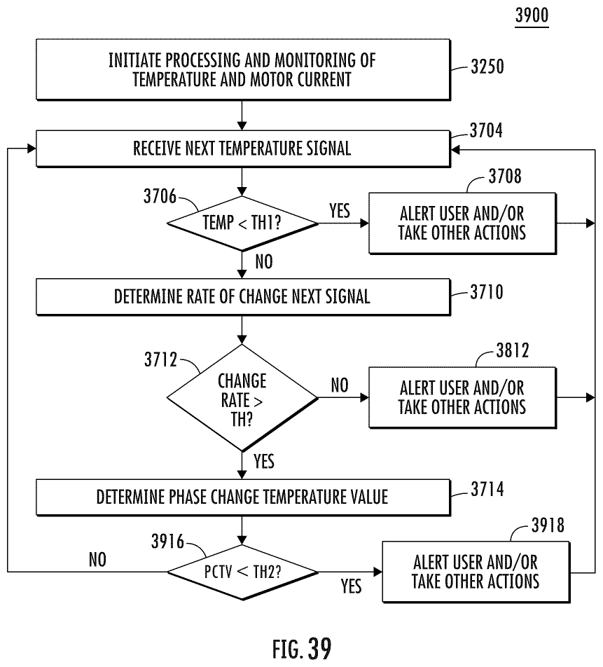

Referring now to FIG. 39, shown is a flow diagram of method 3900 for processing a drink product in a drink maker, according to some non-limiting embodiments or aspects. The steps shown in FIG. 39 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. As shown, method 3900 may include steps for automatically determining when a phase change temperature value is too high, and taking actions accordingly.

As shown in FIG. 39, method 3900 may include, at step 3250, initiating processing and monitoring of temperature of the drink product and motor current (or power, torque, etc.) of the drive motor. For example, controller 402 may initiate processing of the drink product by activating drive motor 208, and controller 402 may further monitor the temperature of the drink product and a motor current (or power, torque, etc.) of drive motor 208.

As shown in FIG. 39, method 3900 may include, at step 3704, receiving a next temperature signal. For example, controller 402 may receive a next temperature signal of a plurality of temperature signals communicated by temperature sensor 406.

As shown in FIG. 39, method 3900 may include, at step 3706, comparing the next temperature signal to a first temperature threshold. For example, controller 402 may compare the next temperature signal received at step 3704 with a first temperature threshold (e.g., comparing the temperature values associated with each). If the next temperature signal is less than the first temperature threshold, controller 402 may proceed to step 3708. If the next temperature signal is not less than the first temperature threshold, controller 402 may proceed to step 3710.

As shown in FIG. 39, method 3900 may include, at step 3708, alerting the user of drink maker 100, and/or taking other actions. For example, controller 402 may, in response to the next temperature signal being less than the first temperature threshold, cause an alert to be generated to the user and/or take one or more remedial actions, including shutting off drive motor 208, shutting off compressor 214, and/or the like.

As shown in FIG. 39, method 3900 may include, at step 3710, determining a rate of change of the next temperature signal. For example, controller 402 may determine a rate of change of temperature of the next temperature signal by comparing the next temperature signal to a prior temperature signal and dividing by the time that elapsed between temperature signals.

As shown in FIG. 39, method 3900 may include, at step 3712, comparing the determined rate of change to a threshold rate of change. For example, controller 402 may compare the rate of change in temperature determined at step 3710 to a threshold rate of change. If the determined rate of change is not greater than the threshold rate of change, controller 402 may proceed to step 3812. If the determined rate of change is greater than the threshold rate of change, controller 402 may proceed to step 3714.

As shown in FIG. 39, method 3900 may include, at step 3812, alerting the user of drink maker 100, and/or taking other actions. For example, controller 402 may, in response to the next temperature signal being less than the first temperature threshold, cause an alert to be generated to the user and/or take one or more remedial actions, including shutting off drive motor 208, shutting off compressor 214, and/or the like.

As shown in FIG. 39, method 3900 may include, at step 3714, determining a phase change temperature value. For example, if the rate of change is less than the threshold rate of change, then controller 402 may detect that a phase change is occurring in the drink product. Controller 402 may then determine the temperature of the drink product at the point of phase change.

As shown in FIG. 39, method 3900 may include, at step 3916, comparing the determined phase change temperature value to a second temperature threshold. For example, controller 402 may compare the phase change temperature value determined at step 3714 to a second temperature threshold. If the phase change temperature value is greater than or equal to the second temperature threshold, controller 402 may proceed back to step 3704 and receive the next temperature signal. If the phase change temperature value is less than the second temperature threshold, controller 402 may proceed to step 3918.

As shown in FIG. 39, method 3900 may include, at step 3918, alerting the user of drink maker 100, and/or taking other actions. For example, controller 402 may, in response to the next temperature signal being less than the first temperature threshold, cause an alert to be generated to the user and/or take one or more remedial actions, including shutting off drive motor 208, shutting off compressor 214, and/or the like.

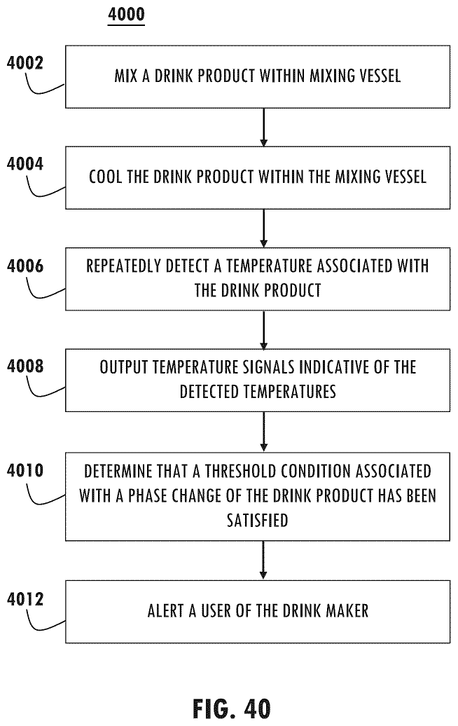

Referring now to FIG. 40, shown is a flow diagram of method 4000 for processing a drink product in a drink maker, according to some non-limiting embodiments or aspects. The steps shown in FIG. 40 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. As shown in FIG. 40, one or more steps of method 4000 may be performed by one or more components of drink maker 100, including control system 400 and/or controller 402. Additionally, or alternatively, one or more steps of method 4000 may be performed by one or more different components of drink maker 100, other than control system 400 and/or controller 402.

As shown in FIG. 40, method 4000 may include, at step 4002, mixing a drink product within a mixing vessel. For example, after a drink product is poured into mixing vessel 104 of drink maker 100, dasher 204, driven by drive motor 208, may mix the drink product within mixing vessel 104.

As shown in FIG. 40, method 4000 may include, at step 4004, cooling the drink product within the mixing vessel. For example, the cooling circuit (e.g., including compressor 214, evaporator 202, condenser 216, condenser fan 218, bypass valve, and conduit) may cool the drink product within mixing vessel 104.

As shown in FIG. 40, method 4000 may include, at step 4006, repeatedly detecting a temperature associated with the drink product. For example, sensor 406 (e.g., controlled by controller 402), may repeatedly detect a temperature associated with the drink product within mixing vessel 104.

In some non-limiting embodiments or aspects, sensor 406 may be configured to, when repeatedly detecting the temperature associated with the drink product, repeatedly detect the temperature associated with the drink product in a periodic interval in a range of about 0.1 seconds to about 5 seconds. A length of each interval of detection may be a same or different length as a prior interval of detection. The temperature signals output from sensor 406 may be indicative of the detected temperature at a respective periodic interval. For example, at t=0 seconds, sensor 406 may detect a temperature of the drink product of 2.37° C. and output a first temperature signal to controller 402 indicative of 2.37° C., at t=5 seconds, sensor 406 may detect a temperature of the drink product of 2.40° C. and output a second temperature signal to controller 402 indicative of 2.40° C., and at t=10 seconds, sensor 406 may detect a temperature of the drink product of 2.43° C. and output a third temperature signal to controller 402 indicative of 2.43° C.

As shown in FIG. 40, method 4000 may include, at step 4008, outputting temperature signals indicative of the detected temperatures. For example, sensor 406 (e.g., controlled by controller 402), may output temperature signals indicative of the detected temperatures of step 4006. Controller 402 may receive the temperature signals output by sensor 406.

As shown in FIG. 40, method 4000 may include, at step 4010, determining that a threshold condition associated with a phase change of the drink product has been satisfied. For example, controller 402 may determine, based on the temperature signals output in step 4008, that a threshold condition associated with a phase change (e.g., a liquid-to-solid phase transition) of the drink product has been satisfied.

In some non-limiting embodiments or aspects, the threshold condition associated with the phase change of the drink product may include a threshold temperature value associated with the phase change of the drink product. For example, the threshold temperature value may be in the range of about −1° C. to about −9° C., and the threshold temperature value may be further dependent on a drink type selected by the user in a user interface of drink maker 100. By way of further example, a drink product that is low in sugar/alcohol may have a threshold temperature value in the range of about −1° C. to about −2.3° C. (e.g., a threshold temperature value of −2° C.). To further illustrate, a drink product that is high in sugar/alcohol may have a threshold temperature value in the range of about −5.8° C. to about −8.8° C. (e.g., a threshold temperature value of −7° C.).

In some non-limiting embodiments or aspects, the threshold condition associated with the phase change of the drink product may include a threshold rate of change. For example, controller 402 may be configured to determine a rate of change of temperature based on the temperature signals received from sensor 406. By way of further example, controller 402 may determine a first temperature at a first time step, determine a second temperature at a second time step that is a time period after a first time step, determine a difference between the first temperature and the second temperature, and divide the difference by the time period.

In some non-limiting embodiments or aspects, the threshold rate of change associated with the phase change of the drink product may have a value in a range of about 0.002 Celsius/second to about 0.006 Celsius/second. Controller 402 may be configured to, when determining that the threshold condition has been satisfied, that the rate of change of temperature is less than or equal to the threshold rate of change. For example, controller 402 may determine a value (e.g., an absolute value) of a rate of change of temperature in the drink product of 0.003 Celsius/second, which may be less than or equal to a predetermined threshold value (e.g., absolute value) of rate of change of 0.004 Celsius/second, and from that comparison, controller 402 may determine that the threshold condition has been satisfied. In response to determining that the rate of change of temperature is less than or equal to the threshold rate of change, controller 402 may determine that the phase change has occurred. Additionally, or alternatively, controller 402 may be configured to, when determining that the threshold condition has been satisfied, determine that the rate of change of temperature is greater than or equal to the threshold rate of change. For example, controller 402 may determine a value (e.g., an absolute value) of a rate of change of temperature in the drink product of 0.010 Celsius/second, which may be less than or equal to a predetermined threshold value (e.g., absolute value) of rate of change of 0.006 Celsius/second, and from that comparison, controller 402 may determine that the threshold condition has been satisfied. This determination may also be coupled with a comparison to an elapsed time, as described below.

In some non-limiting embodiments or aspects, controller 402 may be further configured to determine an elapsed time of a mixing of the drink product. The threshold condition associated with the phase change of the drink product may further include a threshold duration. Controller 402 may be further configured to, when determining that the threshold condition has been satisfied, determine that the elapsed time is greater than or equal to the threshold duration. For example, controller 402 may determine that 35 minutes have elapsed, which is greater than a 30-minute threshold duration, and that the rate of change in temperature may be 0.010 Celsius/second, which is less than or equal to the predetermined threshold value. Based on that comparison, controller 402 may determine the threshold condition to be satisfied and may generate an alert to the user (e.g., indicating that the drink product's sugar/alcohol content is too high, which may lead to the prolonged delay to achieve phase change).

As shown in FIG. 40, method 4000 may include, at step 4012, alerting a user of the drink maker. For example, controller 402 may, in response to determining that the threshold condition has been satisfied, alert a user of drink maker 100.

In some non-limiting embodiments or aspects, the threshold temperature value may include a minimum threshold temperature value. Determining that the threshold condition has been satisfied (at step 4010) may include determining that a temperature value of the phase change of the drink product is lower than or equal to the minimum threshold temperature value. For example, the minimum threshold temperature value may be −9° C., and controller 402 may determine that a temperature value of the phase change is lower (e.g., colder) than, or equal to, −9° C. The alert (at step 4012) may indicate to the user that the drink product must be modified before proper slushing can occur (e.g., adding additional liquid to mixing vessel 104 with a low- or no-sugar/alcohol content to reduce the overall sugar/alcohol content of the drink product).

In some non-limiting embodiments or aspects, the threshold temperature value may include a maximum threshold temperature value. Determining that the threshold condition has been satisfied (at step 4010) may include determining that a temperature value of the phase change of the drink product is higher than or equal to the maximum threshold temperature value. For example, the minimum threshold temperature value may be −1° C., and controller 402 may determine that a temperature value of the phase change is higher (e.g., warmer) than, or equal to, −1° C. The alert (at step 4012) may indicate to the user that the drink product must be modified before proper slushing can occur (e.g., adding additional liquid to mixing vessel 104 with a comparatively higher sugar/alcohol content to raise the overall sugar/alcohol content of the drink product).

In some non-limiting embodiments or aspects, drink maker 100 may include at least one output device, such as a display, a speaker, a light indicator, and/or the like. Controller 402 may be configured to, when alerting the user of the drink maker in step 4012, cause the at least one output device to alert the user of the drink maker. For example, the at least one output device may include one or more displays of drink maker 100, and controller 402 may be configured to cause the one or more displays to produce a visual alert (e.g., an image output, a video output, an illuminated icon/symbol, and/or the like). By way of further example, the at least one output device may include one or more speakers of drink maker 100, and controller 402 may be configured to cause the one or more speakers to produce an aural alert (e.g., a beep, a series of sounds, one or more audio waves, and/or the like). To further illustrate, the at least one output device may include one or more light indicators of drink maker 100, and controller 402 may be configured to cause the one or more light indicators to produce a visual alert (e.g., a fixed illumination, an intermittent illumination, and/or the like). Controller 402 may cause one or more of the at least one output device to activate, thereby alerting the user, in response to determining that the phase change has occurred, such as in step 4010.

In some non-limiting embodiments or aspects, the at least one output device may include at least one speaker, and controller 402 may be configured to cause the at least one speaker, when producing an alert, to emit a series of sounds (e.g., audible notes). For example, the series of sounds may include a plurality of sounds having, when produced in series, at least one of ascending pitch or ascending volume (e.g., a number of audible notes that include, therein, a rise in pitch or volume, such as, but not limited to, a rising trill). By way of another example, the series of sounds may include a plurality of sounds having, when produced in series, at least one of descending pitch or descending volume (e.g., a number of audible notes that include, therein, a fall in pitch or volume, such as, but not limited to, a falling trill).

In some non-limiting embodiments or aspects, the at least one output device may include a plurality of light indicators (e.g., LEDs). For example, the plurality of light indicators may be configured to, when caused by controller 402 to alert the user of the drink maker, illuminate in sequence. By way of further example, drink maker 100 may include user interface 112 with ten LEDs arranged in a line. When alerting the user, the ten LEDs may illuminate sequentially (e.g., forward, upward, downward, or backward along the line of LEDs). To further illustrate, a sequential activation of light indicators may be paired with a plurality of sounds produced by at least one speaker (e.g., an upward sequential illumination paired with an at least partly rising series of notes, a downward sequential illumination paired with an at least partly falling series of notes, and/or the like).

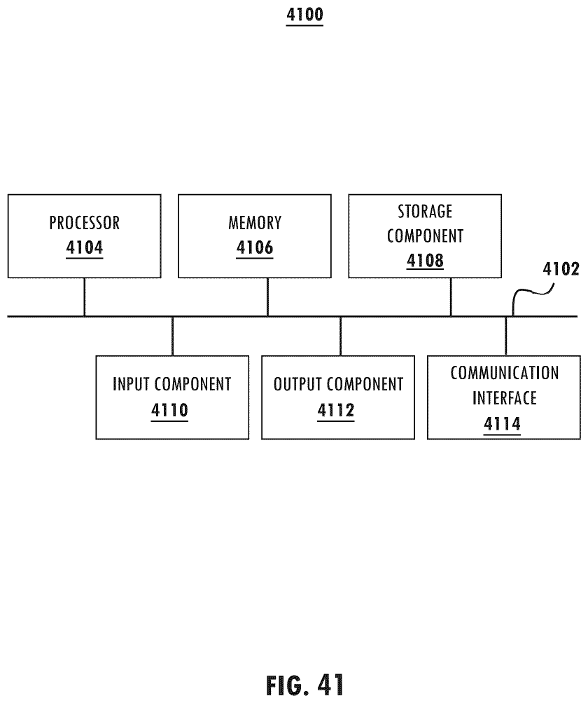

Referring now to FIG. 41, shown is a diagram of example components of device 4100, according to non-limiting embodiments. Device 4100 may correspond to control system 400 and/or controller 402, as an example. In some non-limiting embodiments, such systems or devices may include at least one device 4100 and/or at least one component of device 4100. The number and arrangement of components shown are provided as an example. In some non-limiting embodiments, device 4100 may include additional components, fewer components, different components, or differently arranged components than those shown. Additionally, or alternatively, a set of components (e.g., one or more components) of device 4100 may perform one or more functions described as being performed by another set of components of device 4100.

As shown in FIG. 41, device 4100 may include bus 4102, processor 4104, memory 4106, storage component 4108, input component 4110, output component 4112, and communication interface 4114. Bus 4102 may include a component that permits communication among the components of device 4100. In some non-limiting embodiments, processor 4104 may be implemented in hardware, firmware, or a combination of hardware and software. For example, processor 4104 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that may be programmed to perform a function. Memory 4106 may include random access memory (RAM), read only memory (ROM), and/or another type of dynamic or static storage device (e.g., flash memory, magnetic memory, optical memory, etc.) that stores information and/or instructions for use by processor 4104.

With continued reference to FIG. 41, storage component 4108 may store information and/or software related to the operation and use of device 4100. For example, storage component 4108 may include a hard disk (e.g., a magnetic disk, an optical disk, a magneto-optic disk, a solid-state disk, etc.) and/or another type of computer-readable medium. Input component 4110 may include a component that permits device 4100 to receive information, such as via user input (e.g., a touch screen display, a keyboard, a keypad, a mouse, a button, a switch, a microphone, etc.). Additionally, or alternatively, input component 4110 may include a sensor for sensing information (e.g., a global positioning system (GPS) component, an accelerometer, a gyroscope, an actuator, etc.). Output component 4112 may include a component that provides output information from device 4100 (e.g., a display, a speaker, one or more light-emitting diodes (LEDs), etc.). Communication interface 4114 may include a transceiver-like component (e.g., a transceiver, a separate receiver and transmitter, etc.) that enables device 4100 to communicate with other devices, such as via a wired connection, a wireless connection, or a combination of wired and wireless connections. Communication interface 4114 may permit device 4100 to receive information from another device and/or provide information to another device. For example, communication interface 4114 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 4100 may perform one or more processes described herein. Device 4100 may perform these processes based on processor 4104 executing software instructions stored by a computer-readable medium, such as memory 4106 and/or storage component 4108. A computer-readable medium may include any non-transitory memory device. A memory device includes memory space located inside of a single physical storage device or memory space spread across multiple physical storage devices. Software instructions may be read into memory 4106 and/or storage component 4108 from another computer-readable medium or from another device via communication interface 4114. When executed, software instructions stored in memory 4106 and/or storage component 4108 may cause processor 4104 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

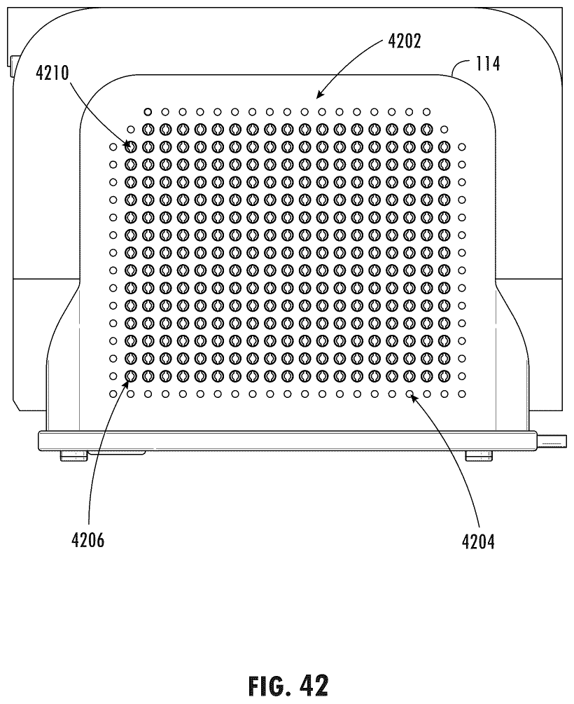

Referring now to FIG. 42, shown is an external, side view of ventilation panel 114 of drink maker 100, according to some non-limiting embodiments or aspects. The view of FIG. 42 is a right-side view of drink maker 100 shown in FIG. 1, however, it will be appreciated that either or both sides of drink maker 100 may be configured with ventilation panel 114, as shown in FIGS. 1 and 2. Ventilation panel 114 may include array 4202 of holes 4204, 4206 configured to permit airflow to ventilate housing 102 of drink maker 100. Ventilation panel 114 may be included in and/or fitted to a sidewall of housing 102. Array 4202 of holes 4204, 4206 may be configured as a one-dimensional array (e.g., a linear and/or curvilinear series of holes), and/or a two-dimensional array (e.g., a symmetrical and/or asymmetrical pattern of holes across a surface area of ventilation panel 114). A hole may include a pass-through in ventilation panel 114, through which air may be permitted to flow from one side of ventilation panel 114 to the other. A hole may have a planar cross-section with a regular shape (e.g., a circle, a square, a triangle, a regular polygon, etc.), an irregularly shape (e.g., a rectangle, an oval, an irregular polygon, etc.), or a combination thereof. An array of holes may include holes of same or different shape. As shown in FIG. 42, two-dimensional array 4202 of circular holes 4204, 4206 are depicted, for illustrative purposes only. In arrangements of housings 102 with two ventilation panels 114, each ventilation panel 114 may have a respective array 4202 of holes 4204, 4206 and a respective set of baffling 4210. Moreover, in arrangements of housings 102 with two ventilation panels 114, each panel 114 may have a same or different pattern of holes 4204, 4206 in array 4202, and one panel 114 may have a smaller number of holes 4204, 4206 to accommodate the placement of mount 302 for holding drip tray 118.

In some non-limiting embodiments or aspects, ventilation panel 114 may further include at least one baffling 4210 that is proximate to an interior surface (e.g., positioned on, positioned adjacent, positioned within a short distance of) of ventilation panel 114. In some non-limiting embodiments or aspects, ventilation panel 114 may include a plurality of baffling 4210. Baffling 4210 is configured to at least partly occlude a set of holes in array 4202 of holes 4204, 4206. Baffling 4210 may at least partly inhibit air and/or liquid from passing through a set of holes 4204, 4206 in array 4202 (e.g., by partly blocking and/or changing the cross-sectional area of a corresponding hole). In this manner, sound waves generated inside housing 102 (e.g., by drive motor 208, compressor 214, fan 218, etc.) may be dampened and/or scattered before exiting housing 102 and reaching user's perception, lessening the overall level of noise of drink maker 100 during operation. Furthermore, incidental liquid contact (e.g., from spilled drink product, rinsing liquid, etc.) on housing 102 may be inhibited from penetrating (or deeply penetrating) housing 102. As shown in FIG. 42, holes 4204, 4206 of array 4202 are at least partly occluded by a plurality of baffling 4210, for illustrative purposes only.

In some non-limiting embodiments or aspects, array 4202 may include holes of different sizes. For example, array 4202 may include a gradient of hole sizes across array 4202 (e.g., from smaller diameter to larger diameter holes, from larger diameter to smaller diameter holes, etc.). Such a gradient effect may be achieved by positioning smaller holes 4204 (e.g., holes with a comparatively smaller diameter over a planar cross-section) on a perimeter of two-dimensional array 4202, and with larger holes 4206 (e.g., holes with a comparatively larger diameter over a planar cross-section) positioned inside the perimeter of smaller holes 4204. A gradient arrangement of holes 4204, 4206 may provide both an improved appearance and reduce the total number of holes in array 4202 that require baffling 4210. In some non-limiting embodiments or aspects, the set of larger holes 4206 of array 4202 may be at least partly occluded by baffling 4210, while the set of smaller holes 4204 may be free of baffling 4210. See FIG. 43 for a closer view of holes 4206 of ventilation panel 114.

In some non-limiting embodiments or aspects, the maximum diameter of each hole 4204, 4206 may be selected to prevent object intrusion and/or penetration through ventilation panel 114 (e.g., by a user's finger, a utensil, etc.), which might injure user and/or damage drink maker 100. In some non-limiting embodiments or aspects, the maximum diameter of each hole 4204, 4206 in array 4202 may be less than or equal to 0.3 inches (e.g., 0.3 inches, 0.25 inches, 0.2 inches, etc.). Furthermore, smaller holes 4204 may be configured with a maximum diameter that is 50% or smaller than the maximum diameter of larger holes 4206 (e.g., 0.15 inches, 0.125 inches, 0.1 inches, etc.). Such diameters are configured to prevent and/or lower the incident rate of an adult or child user from inserting a finger and/or kitchen utensil into housing 102 and touching an active internal component of drink maker 100 (e.g., compressor 214). In some non-limiting embodiments or aspects, baffling 4210 may further prevent object intrusion and/or penetration through ventilation panel 114 (e.g., even if an object or a user's finger is smaller than the diameter of one of the holes 4204, 4206, baffling 4210 may prevent such an object or finger from being inserted), thereby preventing injury to the user and/or damaging of drink maker 100.

In some non-limiting embodiments or aspects, a substantial portion of holes 4204, 4206 of array 4202 may be at least partly occluded by at least one baffling 4210. For example, at least 50% of the number of holes 4204, 4206 in array 4202 may be associated with, and partly occluded by, baffling 4210, inhibiting air/liquid flow-through for at least an equal number of holes 4204, 4206. By way of another example, at least 75% of the number of holes 4204, 4206 may be associated with, and partly occluded by, baffling 4210, inhibiting air/liquid flow-through for a majority number of holes 4204, 4206. In some non-limiting embodiments or aspects, a substantial portion of a cross-sectional area of ventilation panel 114 may be dedicated to holes 4204, 4206. For example, a total cross-sectional area of array 4202 of holes 4204, 4206 (e.g., calculated by summing individual cross-sectional areas of each hole 4204, 4206) may be at least 10% of a total cross-sectional area of ventilation panel 114, where the cross-section is taken along the surface plane of ventilation panel 114. By way of further example, a total cross-sectional area of array 4202 may be at least 20% of a total cross-sectional area of ventilation panel 114. The foregoing exemplary configurations may provide enhanced airflow in and/or out of housing 102, while preventing unintentional penetration through ventilation panel 114.

In some non-limiting embodiments or aspects, the material for baffling 4210 may be selected to maximize the sound-reducing and liquid-resistant effects of baffling 4210. For example, baffling 4210 may be formed of at least one of plastic material (e.g., polypropylene, polycarbonate, polyethylene terephthalate, polystyrene, polyethylene, etc.) or elastomeric material (e.g., silicone rubber, thermoplastic elastomers, ethylene propylene diene monomer, nitrile rubber, and/or the like) configured to reflect and/or absorb sound energy from inside housing 102. By way of further example, baffling 4210 may be formed of a water- and/or oil-resistant material (e.g., stainless steel, polypropylene, silicone, nylon, polycarbonate, polyvinyl chloride, and/or the like) to reduce liquid penetration through ventilation panel 114, and to prevent such liquids from embedding and/or impregnating in ventilation panel 114.

Referring now to FIG. 43, shown is an external, close-up, side view of ventilation panel 114 of drink maker 100, according to some non-limiting embodiments or aspects. As shown in FIG. 43, baffling 4210 may include at least one occluding portion 4212 (e.g., an element with a wider surface area than other elements of baffling 4210, such as a small plate or face) that is configured to at least partly occlude hole 4206. Gap 2216 between an inner edge of hole 4206 and an outer edge of occluding portion 4212 may permit airflow through ventilation panel 114. Each occluding portion 4212 may be connected to another occluding portion 4212 to form a larger superstructure of baffling 4210. For example, each occluding portion 4212 of baffling 4210 may be connected to another occluding portion 4212 by at least one connecting portion 4214 (e.g., an element with a narrower surface area than other elements of baffling 4210, such as an armature or a strut). In this manner, a plurality of occluding portions 4212 may be connected in a network of occluding portions 4212. A set of occluding portions 4212 may be connected in series to form a strip, in parallel to form a tree and/or web, or any combination thereof. In some non-limiting embodiments or aspects, each baffling 4210 may be configured as a linear strip of occluding portions 4212 connected by a series of connecting portions 4214, such that a plurality of linear baffling 4210 strips may be used to at least partly occlude a two-dimensional array 4202 of holes 4204, 4206.

In some non-limiting embodiments or aspects, a diameter (D_{O}) of each occluding portion 4212 may be smaller than a diameter (D_{H}) of a positionally corresponding (e.g., at least partly aligned) hole 4206. In this manner, air may be permitted to flow around occluding portion 4212, through gap 2216, and through a portion of hole 4206, while also allowing baffling 4210 to be positioned against a surface of ventilation panel 114. In some non-limiting embodiments or aspects, the diameter (D_{O}) of each occluding portion 4212 may be selected to provide adequate penetration prevention vis-à-vis the diameter (D_{H}) of hole 4206. For example, diameter D_{O} may be at least 30% of diameter D_{H} of a positionally corresponding hole of the at least one array of holes. By way of another example, diameter D_{O} may be at least 50% of diameter D_{H} of a positionally corresponding hole 4206. As shown, each corresponding pair of holes 4206 and occluding portion 4212 has a substantially circular cross-section and are aligned on a same center point, where diameter D_{O} is half of diameter D_{H}. However, it will be appreciated that occluding portion 4212 and hole 4206 may have different cross-sectional geometries, relative diameters, and center points, both across configurations and within the same configuration.

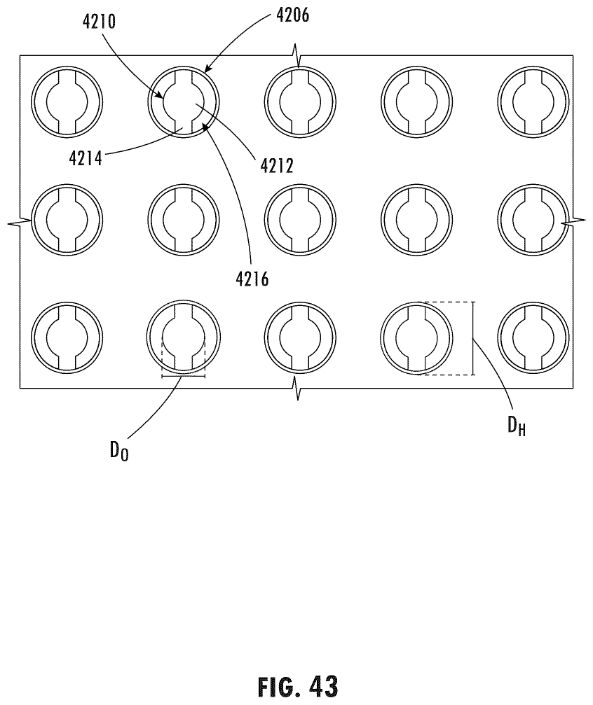

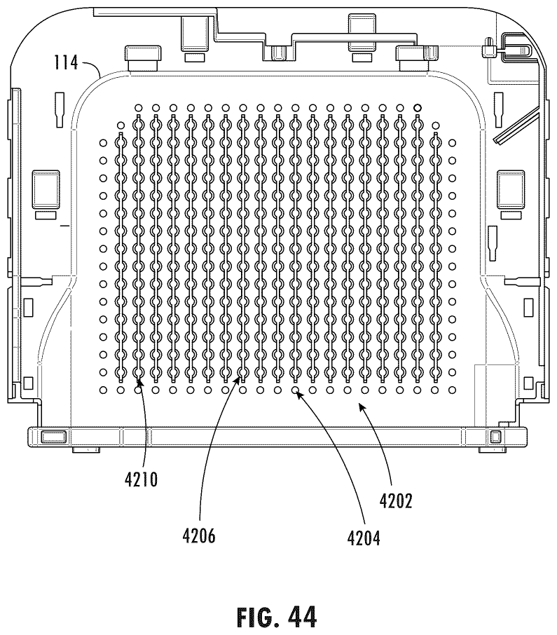

Referring now to FIG. 44, shown is an internal, side view of ventilation panel 114 of drink maker 100, according to some non-limiting embodiments or aspects. FIG. 44 depicts the reverse side of ventilation panel 114, as shown in FIG. 42. As shown in FIG. 44, ventilation panel 114 includes array 4202 of holes 4204, 4206, a subset of which are at least partly occluded by baffling 4210. Each baffling 4210 is arranged as a linear strip mounted on an interior surface of ventilation panel 114. Baffling 4210 may be co-molded with ventilation panel 114, adhered to ventilation panel 114, fastened to ventilation panel 114, and/or the like. While baffling 4210 is depicted as occluding every larger hole 4206, it will be appreciated that baffling 4210 may occlude fewer than the entire set of larger holes 4206, and/or may occlude smaller holes 4204 as well. See FIG. 45 for a close-up view of baffling 4210 and holes 4204, 4206 shown in FIG. 44.

Referring now to FIG. 45, shown is an internal, close-up, side view of ventilation panel 114 of drink maker 100, according to some non-limiting embodiments or aspects. As shown in FIG. 45, a plurality of baffling 4210 strips are arranged with a vertical orientation on an interior surface of ventilation panel 114, which may promote the channeling of liquid, along with the force of gravity and liquid adhesion, downward along baffling 4210 rather than further into housing 102 (e.g., in the manner of a rain chain). However, it will be appreciated that many directional arrangements are possible, including vertical orientation, horizontal orientation, diagonal orientation, or any combination thereof.

In some non-limiting embodiments or aspects, each occluding portion 4212 of a plurality of occluding portions 4212 of each baffling 4210 may positionally correspond (e.g., at least partly align) with hole 4206 of a plurality of holes 4204, 4206 in array 4202 of ventilation panel 114. In some non-limiting embodiments or aspects, each distal end of baffling 4210 (e.g., opposing ends of baffling 4210) may be secured (e.g., co-molded, adhered, fastened, etc.) to an interior surface of ventilation panel 114. Additionally, or alternatively, one or more of the plurality of connecting portions 4214 of baffling 4210 may be secured to an interior surface of ventilation panel 114. In some non-limiting embodiments or aspects, each connecting portion 4214 of baffling 4210 may be secured to an interior surface of ventilation panel 114. The foregoing securing configurations may prevent the dislodging of baffling 4210 and prevent vibration in baffling 4210 due to the physical movement and/or sound waves produced by internal components in or associated with housing 102 (e.g., dasher 204, drive motor 208, compressor 214, fan 218, etc.).

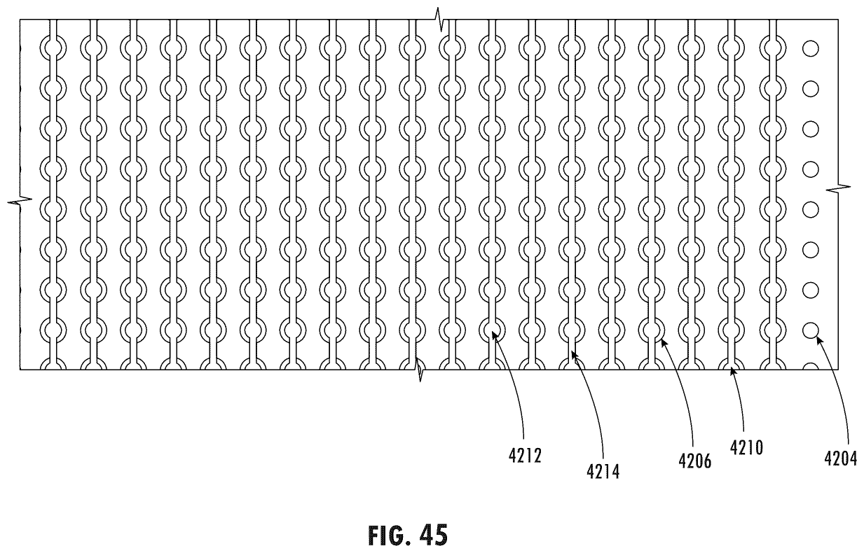

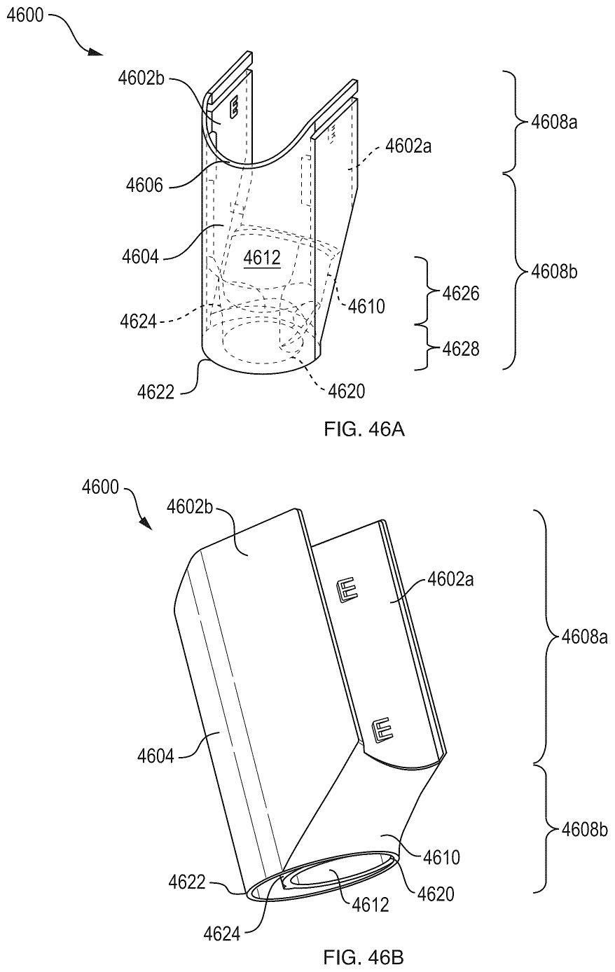

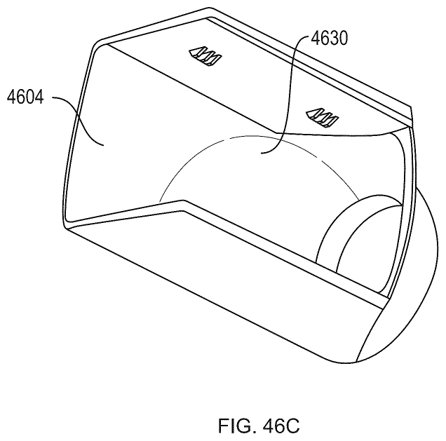

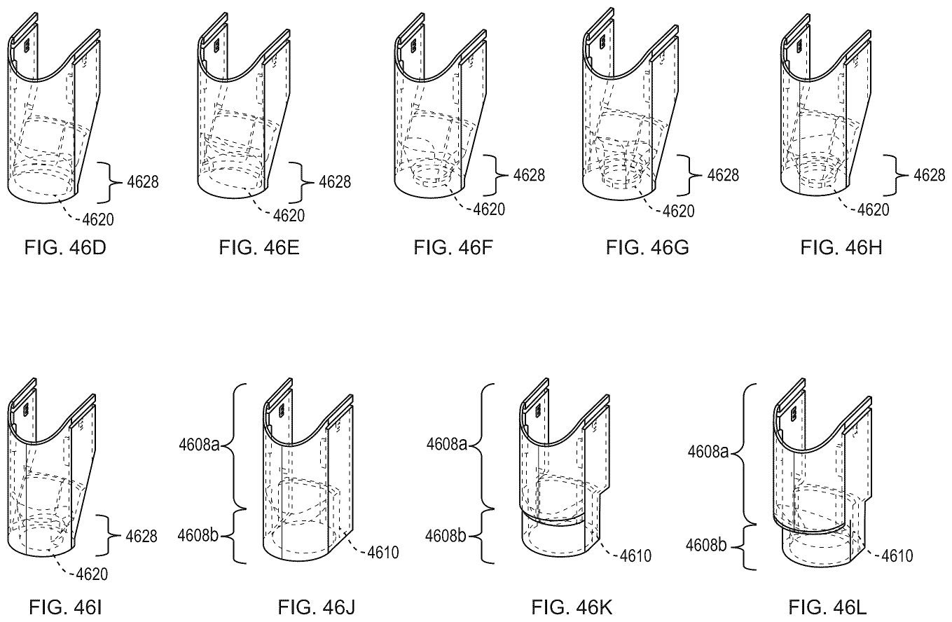

Referring now to FIGS. 46A-46L, shown is dispensing funnel 4600 (e.g., shroud 116) for dispensing a drink product from a frozen drink maker (e.g., drink maker 100), according to some implementations of the present disclosure. Funnel 4600 may be configured to cover a dispenser assembly (e.g., dispenser assembly 2900) to dispense the drink product from drink maker 100 in a clean, predictable, and visually appealing manner. Funnel 4600 may be molded into a unitary piece or may be assembled from multiple pieces. Funnel 4600, or parts thereof, may be made from a transparent or an opaque material.

As shown in FIGS. 46A and 46B, funnel 4600 may include first panel section 4602a and second panel section 4602b extending substantially parallel to first panel section 4602a. Front section 4604 may extend between panel sections 4602a, 4602b. In some non-limiting embodiments or aspects, panel sections 4602a, 4602b may be substantially flat, while front section 4604 may be curved, as shown. However, the disclosure contemplates that front section 4604 may have other configurations, such as flat or triangular. In some non-limiting embodiments or aspects, front section 4604 may include arcuate upper edge 4606 configured such that actuation of handle 120 is not impeded. However, the disclosure contemplates other suitable shapes of upper edge 4606, such as the rectilinear shape shown in FIG. 1. Panel sections 4602a, 4602b may be configured to form a removable snap fit with dispenser housing 2904 of dispenser assembly 2900. A length of front section 4604 may be selected to cover the component parts of dispenser assembly 2900 (other than the handle 120) to improve the aesthetic appearance of drink maker 100. Funnel 4600 may be made of a transparent, food safe, and dishwasher safe material.

In some non-limiting embodiments or aspects, funnel 4600 may have upper portion 4608a that is attachable to dispenser housing 2904 and configured to sit flush with the vertical front panel of drink maker 100. Lower portion 4608b may extend downward from upper portion 4608a. Lower portion 4608b may include inner wall 4610 defining internal channel 4612 that may be configured to be positioned below spout 2902 when funnel 4600 is attached to dispenser assembly 2900. Inner wall 4610 may extend at an angle relative to the vertical front panel of drink maker 100. In some non-limiting embodiments or aspects, inner wall 4610 may extend at an angle of between 15 and 40 degrees (e.g., 30 degrees) relative to vertical front panel. Inner wall 4610 may further at least partially define dispenser opening 4620 at the end of channel 4612 as well as funnel opening 4622 formed with front section 4604. Dispenser opening 4620 may further be at least partially defined by outer wall 4624 extending substantially parallel to the vertical front panel. Thus, channel 4612 may have first region 4626 directing flow of the drink product an angle relative to the vertical front panel and second region 4628 directing flow of the drink product parallel to the vertical front panel. In this way, channel 4612 may be configured to direct a flow of the drink product from spout 2902 (e.g., in a horizontal direction) through dispenser opening 4620 in a substantially vertically downward direction.

As shown in FIG. 46C, channel 4612 may further include chamfer region 4630 extending from front section 4604. When the drink product is dispensed from spout 2902, drink product may initially contact chamfer region 4630. Thus, an angle of chamfer region 4630 relative to front section 4604 may direct splashing of the drink product upward so that the drink product does not splash backward and leak out between funnel 4600 and drink maker 100.

In some non-limiting embodiments or aspects, a shape of dispenser opening 4620 may be circular. However, the disclosure contemplates other shapes of opening 4620, such as oval or eye-shaped. In some non-limiting embodiments or aspects, a diameter of dispenser opening 4620 may be selected to be larger than the diameter of spout 2902 so that the flow rate of the drink product out of dispenser opening 4620 is faster than the flow rate of the drink product into funnel 4600, to avoid build-up of the drink product inside funnel 4600. For example, a diameter of opening 4620 may be selected to be between 5% and 20% larger than a diameter of spout 2902. Thus, an internal diameter of channel 4612 may gradually widen between spout 2902 and dispenser opening 4620. The configuration of channel 4612 may, therefore, allow free flow of the drink product while preventing the drink product from getting clogged near spout 2902. Furthermore, when dispenser opening 4620 is larger relative to spout 2902, the user may more accurately predict where to place a drink cup to catch the dispensed drink product.

One of skill in the art will appreciate that various implementations of funnel 4600 may have different shapes and geometries, while still providing the benefits of a cleaner, more predictable, and more aesthetically pleasing drink product dispensing. For example, as shown in FIGS. 46D-461, dispenser opening 4620 may have various shapes and sizes, and lower region 4628 of channel 4612 may have various configurations. As shown in FIGS. 46J-46L, inner wall 4610 may extend substantially parallel to the front panel, rather than at an angle, and lower portion 4608b of funnel 4600 may have various configurations relative to upper portion 4608a.

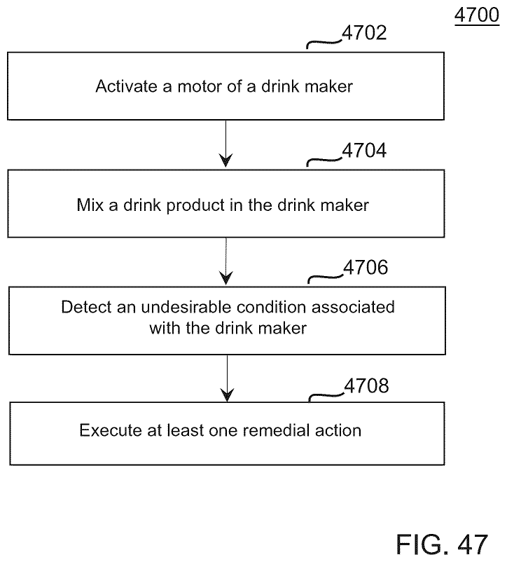

Referring now to FIG. 47, shown is a flow diagram of method 4700 for operating a drink maker with regard to an undesirable condition, according to some non-limiting embodiments or aspects. The steps shown in FIG. 32 are for example purposes only. It will be appreciated that additional, fewer, different, and/or different order of steps may be used in some non-limiting embodiments or aspects. In some non-limiting embodiments or aspects, a step may be automatically performed in response to performance and/or completion of a prior step. In some non-limiting embodiments or aspects, one or more of the steps of method 4700 may be performed (e.g., completely, partially, and/or the like) by control system 400 of drink maker 100 (e.g., controller 402 of control system 400). In some non-limiting embodiments or aspects, one or more of the steps of method 4700 may be performed (e.g., completely, partially, and/or the like) by control system 400 another system, another device, another group of systems, or another group of devices, separate from or including control system 400.

As shown in FIG. 47, at step 4702, method 4700 may include activating a motor of a drink maker. For example, control system 400 may activate a motor (e.g., drive motor 208) of drink maker 100. In some implementations, control system 400 may activate drive motor 208 to drive dasher 204.

As shown in FIG. 47, at step 4704, method 4700 may include mixing a drink product in drink maker 100. For example, control system 400 may mix the drink product within mixing vessel 104 of drink maker 100 using dasher 204.

As shown in FIG. 47, at step 4706, method 4700 may include detecting an undesirable condition associated with the drink maker. In some non-limiting embodiments or aspects, control system 400 may detect an undesirable condition associated with drink maker 100. In some non-limiting embodiments or aspects, control system 400 may detect the undesirable condition associated with drink maker 100 based on data received from one or more sensors 406. In some non-limiting embodiments or aspects, the undesirable condition associated with drink maker 100 may include drink maker 100 being tilted away from a central axis that is perpendicular to a surface on which drink maker 100 is mounted. In some non-limiting embodiments or aspects, the undesirable condition associated with drink maker 100 may include dasher 204 becoming accessible to direct contact by a user during mixing of the drink product by dasher 204.

In some implementations, control system 400 may detect a tilt (e.g., an amount of tilt, a degree of tilt, etc.) of drink maker 100 away from a central axis (e.g., a central axis that is perpendicular to a surface on which drink maker 100 is mounted) based on one or more signals from a sensor, such as a tilt sensor. In some non-limiting embodiments or aspects, a shutoff switch may be configured to be triggered in response to the tilt detected by control system 400 satisfying a threshold value. In some non-limiting embodiments or aspects, the shutoff switch may be configured to be triggered in response to the tilt detected by control system 400 satisfying a threshold value of 30 degrees (e.g., being greater than or equal to 30 degrees).

As shown in FIG. 47, at step 4708, method 4700 may include executing at least one remedial action. In some non-limiting embodiments or aspects, control system 400 may execute at least one remedial action. In some non-limiting embodiments or aspects, control system 400 may execute at least one remedial action in response to detecting an undesirable condition. In some non-limiting embodiments or aspects, the at least one remedial action may include at least one of the following: control system 400 alerting a user of drink maker 100, control system 400 deactivating a component, such as a motor (e.g., drive motor 208), a compressor (e.g., compressor 214), or a combination thereof, of drink maker 100, or any combination thereof. Additionally, or alternatively, the at least one remedial action may include control system 400 deactivating a drive motor of drink maker 100 in response to a switch (e.g., switch 416), such as a shutoff switch, being triggered.

In some non-limiting embodiments or aspects, the at least one remedial action may include control system 400 alerting the user of drink maker 100. In some non-limiting embodiments or aspects, when executing the at least one remedial action, control system 400 may generate (e.g., generate with a speaker) an aural output from a speaker. In some implementations, the at least one remedial action may include deactivating the cooling circuit, and, when executing the at least one remedial action, control system 400 may deactivate compressor 214 to prevent refrigerant from being pumped through the cooling circuit.

It will be appreciated that the various implementations described herein are not limited to making frozen or semi-frozen drinks, but may be applied to produce a cold and/or cooled drink product that is cooler than a received drink product, but not frozen or semi-frozen. For example, in some non-limiting embodiments or aspects, the same or similar mechanisms and/or techniques may be used as part of a cold drink machine and/or cooled drink maker to produce, maintain and dispense cold drinks. One of ordinary skill will recognize that the systems, methods, and devices described herein may apply to other types of food products, such as to the making and/or processing of, without limitation, ice cream, frozen yogurt, other creams, and the like. While the present disclosure describes examples of a drink maker processing various frozen and/or semi-frozen drink products, the systems, devices, and methods described herein are not limited to such drink products and are capable of processing and/or making other types of drink products, such as cooled drink products and/or chilled drink products. The terms “mix,” “mixed” or “mixing” as used herein are not limited to combining multiple ingredients together, but also include mixing a drink product or liquid having a single or no added ingredients. For example, a drink product may consist of only water that is mixed by a dasher during processing, e.g., portions of the water are churned and/or intermingled as the dasher rotates. This may, for example, advantageously enable a more uniform temperature of the water and/or liquid as a whole within the mixing vessel by intermingling portions of the water and/or liquid having different temperatures.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A device for making drinks, comprising:
a housing;
a mixing vessel configured to receive a drink product;
a drive motor positioned in the housing;
a dasher configured to mix the drink product in the mixing vessel, the dasher driven by the drive motor, wherein the mixing vessel has an opening through which the dasher is received in the mixing vessel when the mixing vessel is engaged with the housing in an engaged position;
a cooling circuit at least partly positioned in the housing, the cooling circuit configured to cool the drink product while the drink product is mixed in the mixing vessel; and
a coupling mechanism configured to releasably retain the mixing vessel against the housing in the engaged position, wherein the mixing vessel is configured to engage the housing to seal the opening when in the engaged position.

2. The device of claim 1, wherein the coupling mechanism comprises at least one cam.

3. The device of claim 2, further comprising at least one lever moveable between a first position and a second position, the at least one lever connected to the at least one cam.

4. The device of claim 3, wherein the mixing vessel comprises at least one first protrusion configured to engage with the at least one cam, and wherein when the at least one lever is moved from the first position to the second position, the at least one cam causes the mixing vessel to be engaged with the housing by pulling the at least one first protrusion toward the housing.

5. The device of claim 1, wherein the cooling circuit comprises an evaporator, the evaporator configured to extend through the opening of the housing when the mixing vessel is engaged with the housing in the engaged position.

6. The device of claim 5, further comprising a temperature sensor positioned in or on the evaporator.

7. The device of claim 1, wherein the mixing vessel further comprises at least one first protrusion configured to engage with the coupling mechanism.

8. The device of claim 7, wherein the mixing vessel further comprises at least one second protrusion configured to contact an upper edge of the housing and guide the mixing vessel into alignment with the coupling mechanism.

9. The device of claim 8, wherein the mixing vessel further comprises at least one third protrusion configured to be received within a slot below the upper edge of the housing.

10. The device of claim 1, further comprising a tray positioned below at least a portion of the mixing vessel and configured to receive liquid runoff from an outer surface of the mixing vessel.

11. The device of claim 1, further comprising a channel defined between an outer surface of the mixing vessel and an upper edge of the housing, wherein the channel is configured to allow the liquid runoff to pass through the channel and into the tray.

12. The device of claim 1, further comprising a flexible seal, wherein at least a portion of the flexible seal is positioned between the mixing vessel and the housing when the mixing vessel is engaged with the housing in an engaged position.

13. The device of claim 12, wherein the flexible seal comprises a face seal portion configured to interface between a surface of the mixing vessel and a surface of the housing, and wherein the flexible seal further comprises a radial seal portion configured to extend into and contact a perimeter of the opening.

14. The device of claim 1, wherein the coupling mechanism is configured to engage with the mixing vessel proximate to a rear end of the mixing vessel, and wherein the opening of the mixing vessel is at the rear end of the mixing vessel.

15. The device of claim 1, wherein the mixing vessel comprises at least one internal baffle configured to direct slush flow in the mixing vessel toward the dasher, and wherein the at least one internal baffle comprises at least one of: a side baffle extending parallel to a primary axis of the dasher, a front baffle extending perpendicular to the primary axis of the dasher, a corner baffle angled with respect to the primary axis of the dasher, or any combination thereof.

16. The device of claim 15, wherein the at least one internal baffle comprises at least the front baffle, wherein the front baffle corresponds to an indentation on an exterior of the mixing vessel.

17. The device of claim 16, further comprising a vertical protrusion extending from a front surface of the mixing vessel above a front edge of the indentation.

18. The device of claim 1, further comprising a pour-in opening in a top surface of the mixing vessel, the pour-in opening comprising an aperture configured to allow liquid flow into an interior chamber of the mixing vessel, and the pour-in opening further comprising a surface that inclines with respect to a primary axis of the dasher.

19. The device of claim 18, wherein the aperture is configured as a slot having a width dimensioned to prevent passage of a human finger.

20. The device of claim 18, wherein the aperture of the pour-in opening is positioned proximate to a rear of the mixing vessel.
